(19) United States
(12) Patent Application Publication
(10) Pub. No.: US 2005/0276211 A1
(43) Pub. Date: Dec. 15, 2005

(54) Information recording medium and manufacturing process

(76) Inventors: Akemi Hirotsune, Saitama (JP); Motoyasu Terao, Hinode (JP); Yumiko Anzai, Ome (JP); Masaki Mukoh, Kokubunji (JP); Harukazu Miyamoto, Higashimurayama (JP); Takeshi Maeda, Koganei (JP); Kyoko Kojima, Kunitachi (JP); Tateo Irie, Uenohara (JP); Toshimasa Kamisada, Hiratsuka (JP); Reiji Tamura, Yawara (JP); Hideki Nagano, Tsukuba (JP); Hiroyuki Awano, Noda (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/147,271

(22) Filed: Jun. 8, 2005

(30) Foreign Application Priority Data
Jun. 23, 2004 (JP) 2004-184401
Jun. 9, 2004 (JP) 2004-170654
Feb. 21, 2005 (JP) 2005-043363

(51) Int. Cl. G11B 7/24

(52) U.S. Cl. 369/272.1; 369/275.1

(57) ABSTRACT

An information recording medium and manufacturing method for high-speed and high density recording. An inorganic film is formed by sputtering while applying a bias voltage to shift the substrate voltage potential in the negative direction, or a laminated film is formed by applying energy after coating a substrate with an organic film, and the irregularities maintained even after the laminated film is formed, so that stable, high-capacity and high-speed recording can be attained by forming a multi-information-layer that still retains the irregularities.

### CLAIM OF PRIORITY

The present application claims priority from Japanese applications JP 2005-043363 filed on Feb. 21, 2005, JP 2004-184401 filed on Jun. 23, 2004 and JP 2004-170654 filed on Jun. 9, 2004, the contents of which are hereby incorporated by reference into this application.

### RELATED FOREIGN APPLICATION

A part of the present invention is based on Japanese application JP 2004-009737 filed on Jan. 16, 2004, the contents of which are hereby incorporated by reference into this application.

### FIELD OF THE INVENTION

The present invention relates to an information recording medium, information recording method, manufacturing method, manufacturing apparatus and information record/playback apparatus for recording and reproducing information by using light.

### BACKGROUND OF THE INVENTION

The optical disk possesses important features such as the low price of the recording medium and the fact that the recording medium (disk) can be removed from the record/playback apparatus. Therefore an optical disk apparatus is needed that retains these features yet possesses high-speed and high-density recording.

The optical disk should preferably be a multilayer structure utilizing the features of light transmittance and light conveyance range to improve the effective recording density (effective surface density) of the optical disk. However a tradeoff in each layer occurs between recording sensitivity and the (light) transmittance when three or more layers are used so that either the playback signal quality or the recording sensitivity becomes worse.

Technology to eliminate this tradeoff effect has been developed. The technology disclosed in JP-A No. 346378/2003 for example, applies a voltage to a pair of electrodes sandwiching a recording layer in multiple recording layers made up of electrochromic material, to change the absorbance spectrum of the recording layer itself by applying this voltage, and absorb light to selectively color a recording layer in order to record information.

The technology disclosed in JP-A No. 82360/2002 utilizes a recording material for optical writing comprised of conductive layers sandwiching an electrochromic layer from both sides. However, this literature only relates to the material and does not describe a multi-layer structure.

A variety of principles are known for recording information by irradiating light onto a recording film. Among these, the optical disk that is most often shipped and at a low price, utilizes a recording layer containing a dye that absorbs the wavelengths of the recording light source. In this method, a laser light is irradiated onto the substrate surface in contact with that recording layer of organic material to record by changing the properties of the substrate surface. This type of optical disk includes the CD-R and the DVD-R.

On the other hand, utilizing the change in the arrangement of atoms occurring due to heat such as from phase change in the film material (also called, phase transition, phase function) offers the significant advantage of an information recording medium capable of being rewritten many times. In the case of a phase change optical disk for example, the technology disclosed in JP-A No. 344807/2001 utilizes a basic structure made up of a protective layer on a substrate, a recording film such as GeSbTe, a protective layer and a reflective layer. Among these, a phase change optical disk of multiple layers including up to four layers has been reported as under development that utilizes a recording film of Te oxide with high transmittance, and though it can be written once, like the DVD-R cannot be rewritten.
[Patent document 1] JP-A No. 346378/2003
[Patent document 2] JP-A No. 82360/2002
[Patent document 2] JP-A No. 344807/2001

### SUMMARY OF THE INVENTION

To improve the effective recording density (effective surface density), the optical disk should preferably contain multiple layers utilizing the features of light transmittance and light conveyance range. However when three or more layers are used, a tradeoff effect occurs in each layer between the recording sensitivity and the (light) transmittance so that either the playback (read) signal quality or the recording sensitivity deteriorates. The gap between layers must be 20 micrometers or more so that the light spot will spread sufficiently on the adjacent layers to prevent information from becoming garbled (mixed up) during readout. Optical disks for recording in three dimensions on transparent organic or inorganic material including the thickness direction are known. However on optical disks utilizing the absorbance of two photons, the recording medium is monocrystalline, expensive, shatters easily, has poor recording sensitivity, and diffraction and scattering of the light occurs due to recording. Moreover, since the recording medium was thick, the optical system was different from the optical disk, utilizing a confocal optical system.

An evaluation made by the present inventors revealed that the recording layer first formed on the lower side retained a shape matching the irregularities (concavities/protrusions) on the substrate when laminating the recording layers into multiple layers. However the recording layers later formed on the substrate was unable to retain the shape of the irregularities on the substrate and the irregularities were found to have smoothed out. Whereupon, in the recording medium of the related art utilizing electrochromic material, when tracking was performed, the tracking grooves the same as in a typical optical disk, tracking errors tended to easily occur due to deformations in the groove shape when the multiple laminated layers were formed. The tracking and address could be checked by using multiple laser beams, and aligning one beam with the focal point on the reflective layer directly above the substrate formed with grooves and pits, and then making another beam in which the positional relation of that beam and the direction on the disk is largely fixed, arrive at its focal point position on the layer for record or read. However this countermeasure required a larger optical head. The positional relationship of the multiple beams was also vulnerable to shifts due to temperature fluctuations, etc. Utilizing one beam for record or play in order to avoid this disadvantage required installing a number of layers to transfer the pits and grooves to allow the address to be read at the now shifted focal point position. A size of 10 microns or more was required for these transfer layers (for readout).

In order to achieve a multilayer structure described in patent document 1, the electrodes for selecting a layer require a structure where each layer is exposed. Among these exposed electrodes, if two electrodes sandwiching the recording layer of the desired electrode are selected and a voltage applied to them, then just that layer can be colored to allow recording or reading. Each electrode layer requires a different shape to accomplish this (selection). In the related art, multiple masks of different shapes were prepared, these masks were replaced where necessary and the film manufactured. If the electrochromic material or solid electrolyte material utilized inorganic material, then all of the film could be formed within a vacuum. However, if mask replacement was required then removing the material from the vacuum apparatus was necessary each time replacement was needed.

In order to resolve the above problems with the related art, this invention has the object of efficiently manufacturing a multi-information-layer-medium with good productivity utilizing variable shape masks to achieve stable high-capacity, high-speed recording while maintaining both the compact apparatus size and high degree of compatibility with optical disks of the related art.

The technology to achieve multilayers includes both a method for laminating multiple layers of recording layers of oxides, sulfides or organic material possessing high transmittance and then changing the extinction coefficient and refraction rate with the laser; and a method for making an electrochromic material lay or solid electrolyte material layer enclosed by transparent electrodes either colored or transparent, by applying a voltage, to record or play back (read) just the colored layer. This invention can utilize either method. The specific structure of this invention is described next.

(1) A recording medium is a substrate or an ultraviolet light curing resin layer containing repeating irregularities (concavities and protrusions). These irregularities possess a slope and repeat in sets of approximately trapezoid (However with no base on the long side) and approximately reverse trapezoid (However with no base on the long side) shapes. As the substrate or an ultraviolet light curing resin layer becomes farther away, these become sets of repeating arc shapes, or approximately triangular with no base and reverse triangular shapes with no base. During film forming, etching is performed by applying a strong DC bias voltage to make argon ions strongly impact on section of the film surface and, forming repeating sets of shapes resembling triangles without bases and resembling reverse triangles without bases, and when a weak voltage is applied, the tips of the irregularities are not pointed, and become repeating shapes resembling a section of an arc.

(2) The height of irregularities on a layer made from repeating sets of arcs, approximate triangles with no base and approximate reverse triangles with no base, separated from the substrate or an ultraviolet light curing resin layer, is in a range from 0.5 to 0.9 times the height of irregularities on the substrate or an ultraviolet light curing resin layer. Needless to say, recording marks are formed on these laminated layers when recording information.

(3) When forming a film by sputtering, a bias voltage is applied to shift the voltage potential of the substrate in the negative direction while forming a dummy layer of inorganic film by sputtering. A film in an arc shape can be formed by applying this type of bias voltage.

(4) To form a film by coating, a film is coated onto a substrate containing irregular shapes and an energy beam irradiated onto the film. This film is formed on the irregular shapes so the heat is selectively absorbed on the substrate cavities (concave sections) where the film is thick. The surface tensile strength consequently drops due to the sudden evaporation of solvent and the applied heat, and the film thickness becomes uniform due to back pressure of the gas vapor. The energy beam may be irradiated onto the entire film however the same result can be obtained by selectively irradiating the cavity regions. The arc shapes can be formed in this way. Organic film may be utilized as this film.

The step for forming the recording layer may be performed prior to the step for coating the organic film. Moreover, the step for applying energy to the organic film cavities (concave sections) among the recording layers may be performed after forming the recording layer.

Recording is performed by irradiating just a particular section with high power pulsed laser light without causing coloring even if a coloring voltage is applied, or by causing a change in the recording medium while there is a delay in the coloring state. This method has the advantage that the optical system for optical disks of the related art can be used however in this method a voltage must be applied to the disk to make electrical current flow.

In this invention, colored or coloring is defined as an increase in the absorbance of laser light wavelengths utilized for recording or readout. Therefore a color might appear before coloring is performed.

(5) Manufacturing Method

A mask is set on a substrate, and a first film is formed on a region not covered by the mask. The shape, size, or position setting of the mask within the vacuum apparatus are then changed and a second film is formed on a region not covered by the mask. The mask is a disk shape or an approximate disk shape with a recess (or cavity) formed at an optional position. The average diameter or the recess position of the aperture of the first and second films are different. The size (average diameter) and shape are changeable in the mask structure so that for example, after changing the position of the recess on the same circular periphery and forming the first and second films, the average diameter of the mask is changed to the larger direction and a third film formed. Preferably two or more recessions are formed on each film. Here, the average diameter is defined as the average of the distance from the disk center to the edge of the masked region (excluding the recess section) measured along one degree of an angle of a circle per its diameter (double the radius).

In this description, the “shape” indicates the contour of the figure and does not include the size.

(6) Manufacturing Apparatus

The apparatus for manufacturing the multilayer disk contains a stand for mounting the substrate, a target comprised of material for forming film on the substrate, a means for sputtering the target and forming a film on the substrate, a mask installed between the stand and the target, and a means for changing the shape of the mask. The mask for example is made up of a center shaft and, multiple blades, and a clamp spring. Protrusions are formed on each blade, and a ring-shaped clamp ring makes contact with the outer side of each protrusion to prevent the multiple blades from separating. A cavity is formed on the tip of the cylindrical surface of the center shaft and multiple irregularities (concavities, protrusions) are formed on the rear end. The sharp angles sections of the multiple blades are inserted and clamped in the cavities on the tip of the center shaft. The multiple blades are in this way formed in an umbrella shape rather than a flat shape. Flat springs in a thin disk shape and formed with multiple notches are installed in the center section of the stand for installation of the substrate. The irregularities on the rear end of the mask center shaft are a structure that inserts into the center section of the flat spring. Pressing the mask center towards the mount, inserts the center section of the flat spring into the next irregularity so that the mask height can be positioned. Changing the mask height changes the blade angle, in a structure changing the mask towards the larger average diameter.

When the mask is clamped at an optional time by at least two blade protrusions while rotating the entire structure, just the mask is made to slip in a structure allowing the setting position to be changed by shifting the mask and substrate positions toward the circumference of the disk by an optional distance. When changing the shape or when changing the setting position, these can be used in certain combinations. A blade with a slot-shaped hole on the inner circumference can be utilized as a method for changing the mask diameter. The clamping structure is a machine screw 222 penetrating through two blades in a section where adjoining blades overlap at both ends of their outer contour. The blades revolve centering on the machine screw since this is not glued. Among the blades, two blades respectively at the topmost and bottom-most positions are secured at only one point. The blade has a ring-shaped clamp spring for making contact between the inner sides of one protrusion and another protrusion. The force of the clamp spring is constantly acting to make the clamp spring expand outwards. An arm bar functions to suppress the expansion of the clamp spring. If the arm bar is pressed to the innermost circumferential side then the average outer diameter of the mask is at a minimum. When the arm bar moves to the outer circumferential side, the clamp spring widens along the arm bar, to change the blade by pushing open the protrusions integrated with the blade.

The slotted hole on the inner circumference of the blade at this time allows the blade to move without separating from the center shaft. The blades are made up of multiple blades of the same shape and there are preferably from about two to thirty blades. Though dependent on the blade thickness and material, when there are too many blades the overall structure becomes thick, and this thickness and weight exert effects. If the amount of change in the mask shape is small then even a structure with just one blade is possible. When the average diameter of the mask is small, then the overlap at one point of the blade end becomes a large amount. When the average diameter is large, then the overlap becomes a small amount. Another soft material may be applied to the surface making contact with the base plate of the blade, and preferably is subjected to Tuffram processing, fluoro-coating processing, or emboss processing or a combination of these processes to make the movement smooth.

Changes can therefore be made in the film forming range of one mask as described above. When in particular continuously forming the film by vapor deposition or by sputtering, and changing the film fabrication range, a multi-information-layer medium can be efficiently fabricated and the shape can be easily changed even within one vacuum apparatus.

(7) Medium

The multilayer disk fabricated using a mask, includes an aperture with no film in a section where the substrate seals to the mask. The shape of this aperture is changed for each recording film. As one example, on the disk, a first recording film is formed with an aperture including multiple protrusions; and a second recording film is formed with an aperture with protrusions formed at positions different from the protrusions of the first aperture, and these layers are formed in sequence from the substrate side.

Both the size and shape of the aperture may be set to be different on each recording film. For example, a disk may be formed with a first recording film including a first aperture with multiple protrusions, a second recording film including a second aperture with protrusions at positions different from the protrusions on the first aperture, a third recording film with a third aperture with multiple protrusions larger than the first aperture, and a fourth recording film with a fourth aperture formed with protrusions at positions different from the protrusions on the third aperture.

On a disk sequentially laminated with a first recording film including a first aperture, a second recording film including a second aperture, and a third recording film including a third aperture, the average diameters of the aperture differs in steps on the first, the second, and the third films, and the differential between the average diameters may be made as large as the disk center side.

The first, the second, and the third films are recording films where the transmittance or the reflectivity are changed by applying a voltage. Moreover, an electrode layer is formed for applying a voltage to the recording film. A means is provided for supplying electrical current from first and the second apertures.

(8) In order to achieve the above objects, this invention includes a method for making electrochromic material laminated into multiple layers colored or transparent by applying a voltage, and recording or reading only the colored layer. Recording is performed by applying a coloring voltage only on the section irradiated by a high-powered pulse laser to change (the medium) to a non-colored state. An advantage of the optical system is that the optical system for the optical disk of the related art can be used, however a voltage must be newly applied to the disk to make an electrical current flow, so the problem is how to apply a voltage to the rotating disk to perform high speed recording. To resolve this problem, the present invention comprises a disk loading section clamped to a recording medium rotating shaft for holding the recording medium of the drive apparatus, or a disk clamping section for depressing and clamping the disk or a recording medium, and a drive apparatus capable of applying a voltage to multiple electrodes on the recording medium in the vicinity of that clamping section.

The information recording apparatus of this invention comprises a rotating shaft, a disk loading section clamped to the rotating shaft and, a disk clamping section for depressing and clamping the disk recording medium loaded in the disk loading section and to rotate as one piece along with that disk recording medium and, multiple pin or belt shaped contact electrodes for directly contacting or making contact by way of other conductive materials with electrodes sandwiching the recording layer of the disk recording medium loaded in the disk loading section and exposed on the disk contact surface of that disk loading section, and a power supply, and a conductive circuit for supplying electricity to the multiple pin electrodes connected to the power supply.

The information recording apparatus of this invention comprises a rotating shaft, a disk loading section clamped to the rotating shaft and, a disk clamping section for depressing and clamping the disk recording medium loaded in the disk loading section and to rotate as one piece along with that disk recording medium and, multiple pin or belt shaped contact electrodes for directly contacting or making contact by way of other conductive materials with electrodes sandwiching the recording layer of the disk recording medium loaded in the disk loading section and exposed on the disk contact surface of that disk loading section, and a power supply, and a conductive circuit for supplying electricity to the multiple contact electrodes connected to the power supply.

The multiple pin electrodes preferably protrude from the disk contact surface. The conductive circuit may be installed in the rotating shaft, or may even be installed in the disk clamping section. The conductive circuit may conduct from one of these (rotating shaft—disk clamping section) to the other. A narrow conductive element capable of longitudinal movement at the contact position with the rotating shaft is also included, and that conductive element may comprise a portion of the conductive circuit.

The information recording method of this invention comprises: a step for loading a disk recording medium including multiple recording layers colored by applying a voltage to a pair of electrodes sandwiching each layer, onto a disk loading section clamped to a rotating shaft and; a step for depressing and clamping a disk recording medium loaded in the disk loading section by a disk clamping section rotating as one piece along with that disk recording medium and; a step for applying a voltage from multiple pin or belt shaped contact electrodes formed on the disk contact surface of the disk clamping section or the disk contact surface of that disk loading section, to a pair of electrodes sandwiching one recording layer among multiple recording layers to color that recording layer; and a step for selectively recording information on a recording layer enclosed by a pair of electrode applied with a voltage. The recording layer colored by application of a voltage contains electrochromic material. A voltage may be applied to the pair of electrodes sandwiching a recording layer other than the recording layer for selectively recording information, in order to increase the transmittance of the recording layer enclosed between those two electrodes. In this invention, colored or coloring is defined as an increase in the absorbance of laser wavelengths utilized for recording or readout. Therefore a color might appear before coloring is performed.

(9) An information recording medium for recording information by irradiation of energy, is made up of a combination comprising a substrate and, an electrode layer, an electrochromic layer and an electrolytic layer formed on that substrate, and including multiple information surfaces and, the relation of a reflectivity (rate) Rc for coloring one layer on the information surface, a reflectivity (rate) Re for decoloring the information surface, and a reflectivity (rate) RM for a section recorded on the information surface; satisfies the formulas (1) (2) (3).
(Re−Rm)/(Rc−Rm)<0.03 (1)
Re<Rc (2)
Rm<Rc (3)

The information recording medium of this invention is capable of multi-layering to a much greater extent than the relate art. Moreover, positioning deviations are reduced and reliable electrical connection from the drive apparatus to the recording medium can be achieved; the recording density can be effectively raised, high speed recording achieved, and the recording capacity of one disk of the recording medium can be drastically increased. The recording and readout apparatus of this invention is therefore capable is capable of high speed recording and read-out with a large (information) capacity and a long service life.

Moreover, this invention does not require replacing the mask in the manufacturing process for the multi-information-layer-medium applied with a voltage, and the time is considerably reduced compared to the related art.

### BRIEF DESCRIPTION OF THE DRAWINGS

FIG. 1 is a cross sectional view of the information recording medium of the first embodiment of this invention;

FIG. 2 is a drawing showing the cross sectional structure of the plane along the center line of the rotating shaft in the vicinity of the section for installing the disk of the multilayer disk record/read apparatus of the first embodiment of this invention;

FIG. 3 is a drawing showing the cross sectional structure in a direction at a right angle to a section of the recording track on the multilayer disk recording medium of the first embodiment of this invention;

FIG. 4 is a drawing showing the cross sectional structure in a direction at a right angle to a section of the recording track on the multilayer disk recording medium for vacuum film forming in the first embodiment of this invention;

FIG. 5 is a drawing showing the placement of the spring insert pin electrodes on the disk receiving section of the multilayer disk record/read apparatus of this invention;.

FIG. 6 is a cross sectional view of the information recording medium for comparison with this embodiment;

FIG. 7 is a drawing showing the structure of the record/read apparatus and multilayer disk recording medium possessing a radiating inner circumferential drawn out electrode in the first embodiment of this invention;

FIG. 8 is a drawing showing the principle of coloring and decoloring on the multilayer disk record/read apparatus of the first embodiment of this invention;

FIG. 9 is a drawing showing the pulse voltages applied for layer writing from the coloring-decoloring switching circuit of the multilayer disk record/read apparatus of the first embodiment of this invention;

FIG. 10 is a drawing showing the recording status and the groove wobbling, and the spiral groove of the multilayer disk record/read apparatus of the first embodiment of this invention;

FIG. 11 is a drawing showing the cross sectional structure of the multilayer disk recording medium utilizing the high transmittance Te low-oxidizing phase-change recording film of the first embodiment of this invention;

FIG. 12 is a drawing showing the segmented inner circumferential concentric electrode on multilayer disk recording medium of the first embodiment of this invention;

FIG. 13 is a drawing showing the vicinity of the disk installation section in the multilayer disk record/read apparatus of the first embodiment of this invention;

FIG. 14 is a drawing of a cross section of the information recording medium of the first embodiment of this invention;

FIG. 15 is a drawing showing a mask structure (a) of the first embodiment of this invention;

FIG. 16 is a cross sectional view showing the mask installation section of the first embodiment of this invention;

FIG. 17 is a drawing showing the electrode of the information recording medium utilizing the mask structure (a) of the first embodiment of this invention;

FIG. 18 is a drawing showing a mask structure (b) of the first embodiment of this invention;

FIG. 19 is a drawing showing the electrode of the information recording medium utilizing the mask structure (b) of the first embodiment of this invention;

FIG. 20 is a drawing showing the electrode of the information recording medium utilizing the mask structure (b) of the first embodiment of this invention;

FIG. 21 is a drawing showing the mask shape for the first embodiment of this invention;

FIG. 22 is a cross sectional drawing showing the information recording medium of the first embodiment of this invention;

FIG. 23 is a drawing showing the mask central shaft for the first embodiment of this invention;

FIG. 24 is a cross sectional drawing showing the mask installation section of the first embodiment of this invention;

FIG. 25 is a drawing showing the mask installation section of the first embodiment of this invention;

FIG. 26 is a drawing showing the mask shape for the first embodiment of this invention;

FIG. 27 is a drawing showing the record/read apparatus of the first embodiment of this invention;

FIG. 28 is a concept view of the information recording medium fabrication apparatus of this invention:

FIG. 29 is a cross sectional drawing showing the information recording medium of the first embodiment of this invention;

FIG. 30 is a drawing showing the cross sectional structure of the multilayer disk of the first embodiment of this invention;

FIG. 31 is a drawing showing the cross sectional structure taken along the plane along the center line of the rotating shaft in the vicinity of the disk installation section of the multilayer disk record/read apparatus of the first embodiment of this invention;

FIG. 32 is a drawing showing the cross sectional structure taken along the plane along the center line of the rotating shaft in the vicinity of the disk installation section of the multilayer disk record/read apparatus of the first embodiment of this invention;

FIG. 33 is a drawing showing the method for sequentially applying an intermittent voltage from a single power supply to the each layer on the multilayer disk of this invention;

FIG. 34 is a drawing showing the cross sectional structure taken along the plane along the center line of the rotating shaft in the vicinity of the disk installation section of the multilayer disk record/read apparatus of the first embodiment of this invention;

FIG. 35 is a drawing showing the structure for moving the contact surface of the brushes of the multilayer disk record/read apparatus of the first embodiment of this invention;

FIG. 36 is a drawing showing the placement of the spring insert pin for the disk receiving section of the multilayer disk record/read apparatus of the first embodiment of this invention;

FIG. 37 is a drawing showing high speed recording and read with the multi-laser beam on the multilayer disk of this invention;

FIG. 38 is a drawing is a cross sectional drawing showing the information recording medium of the first embodiment of this invention;

FIG. 39 is a drawing showing the cross sectional structure taken along the plane along the center line of the rotating shaft in the vicinity of the disk installation section of the multilayer disk record/read apparatus of the first embodiment of this invention;

FIG. 40 is a side view showing the voltage conveyor ring group containing the mechanism for moving the contact position of the multilayer disk record/read apparatus of the first embodiment of this invention;

FIG. 41 is a drawing showing the structure of the switching circuit for applying a voltage to each layer of the multilayer disk record/read apparatus of the first embodiment of this invention;

FIG. 42 is a drawing showing the recording status and the groove wobbling, and the spiral groove of the multilayer disk record/read apparatus of the first embodiment of this invention;

FIG. 43 is a drawing showing the position deviation correction circuit mechanism for shifting the contact position of the brush group and ring group for the multilayer disk record/read apparatus of the first embodiment of this invention;

FIG. 44 is a drawing showing the principle for reading out information in bit arrays and the cross sectional structure along the recording tracks of the ROM disk or pit sections on the multilayer disk recording medium of the first embodiment of this invention;

FIG. 45 is a drawing showing the cross sectional structure taken along the plane along the center line of the rotating shaft in the vicinity of the disk installation section of the multilayer disk record/read apparatus of the first embodiment of this invention;

FIG. 46 is a drawing showing the cross sectional structure taken along the plane along the center line of the rotating shaft in the vicinity of the disk installation section of the multilayer disk record/read apparatus of the first embodiment of this invention;

FIG. 47 is a drawing showing one example of placement of the transparent electrode drawn out section on the inner circumferential section of the multilayer disk recording medium of the first embodiment of this invention;

FIG. 48 is a graph showing the relation of interlayer crosstalk with the reflection rate (or reflectivity) in the embodiment of this invention;

FIG. 49 is a graph showing the reflection rate range capable of reducing the interlayer crosstalk in the embodiment of this invention;

FIG. 50 is timing charts showing the relation between application of a voltage to changes in reflectivity in the embodiment of this invention;

FIG. 51 is timing charts showing the relation between application of a voltage and changes in reflectivity in the embodiment of this invention;

FIG. 52 is a drawing showing the recording waveform in the embodiment of this invention;

FIG. 53 is a graph showing the relation between reflectivity and recording power in the embodiment of this invention;

FIG. 54 is a graph showing the relation between temperatures on adjacent recording films and distance between recording layers in the embodiment of this invention;

FIG. 55 is a drawing showing a cross section of the film edge in the embodiment of this invention;

FIG. 56 is a drawing showing a cross section of the film edge in the embodiment of this invention;

FIG. 57 is a drawing showing a cross section of the film edge in the embodiment of this invention;

FIG. 58 is a drawing showing the substitutable type variable shape mask during manufacture in the embodiment of this invention;

FIG. 59 is drawings showing the method for driving the drop lid type variable shape mask during manufacture in the embodiment of this invention;

FIG. 60 is a drawing showing the relation between film thickness and the substrate step in the embodiment of this invention;

FIG. 61 is a drawing showing the relation between non-uniformities in the reflectivity and the distance from the drawn out electrode of the embodiment of this invention;

FIG. 62 is a drawing showing the method for applying a voltage via the clamp in the embodiment of this invention;

FIG. 63 is a drawing showing laminated structure of the medium in the embodiment of this invention.

### DETAILED DESCRIPTION OF THE INVENTION

The embodiments of this invention are described next while referring to the drawings.

### First Embodiment

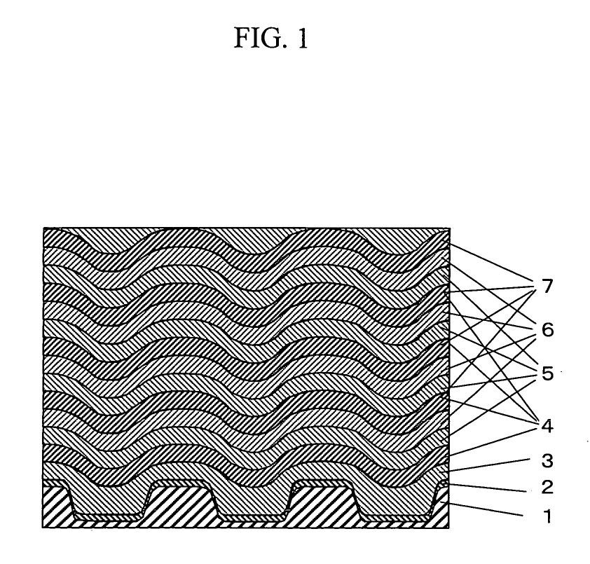

The specific structure of the recording medium of this invention is described as follows. As shown in FIG. 1, a metallic reflective layer 2 is first of all formed on the substrate 1 including a tracking groove. A dummy layer 3 is next formed, and then the first transparent electrode 4, electrochromic material layer 5, solid electrolyte layer 6, and second transparent electrode 7 films formed in sequence, (from 4 to 7) are repeatedly laminated optically or thermally in two sets or more enclosed by spacers between the transparent electrodes if necessary. Laminating in the sequence of electrochromic material layer 5 and solid electrolyte layer 6 allows a lower drive voltage, however a reverse layer order may also be used. The dummy layer may be a layer of inorganic material formed by bias sputtering described in the second embodiment or even laminated film. The figure shows the case where there is no spacer layer so as can be seen from the figure, an upper section transparent electrode that is one layer downwards may be used along with a lower section transparent electrode that is one layer upwards. The recording or the readout laser light absorption rate or the reflectivity (rate) preferably increases when a voltage is applied across the electrodes sandwiching the recording layer. The desired layer can in this way absorb light, while the other layers absorb almost no light. Others layers do not cause interference so that the film thickness of each layer can be thinned to approximately 1/100 th the film thickness of the related art. Multiple layers can also be positioned within the focal point depth of the focusing lens, so that the disk can possess more layers (multi-layers) and a high capacity compared to the multiple layer disks of the related art. Recording and readout can of course also be performed by shifting the position of the focal point so that no more than one or two layers will be within the focal point depth. The metallic reflective layer may be omitted if the electrochromic material layer possesses high reflectivity.

When forming multiple layers by the conventional coating method (The reflectivity layer and transparent electrode however are formed by sputtering) by laminating an Ag—Pd—Cu semi-transparent reflective layer 12, a under layer 3 of acrylic resin a transparent electrode 14, an electrochromic material layer 15, a solid electrolyte layer 16, and a transparent electrode layer 17 on the substrate 11 as shown in FIG. 6, the grooves and pits gradually become shallow and finally become almost flat (level). When forming layers just by sputtering or vacuum vapor deposition, the grooves become narrow due to film adhering to the side walls of the grooves and pits so that in either case, tracking or reading out the address becomes impossible at the stage where multiple layers of record layers are formed. To avoid this problem, this invention employs separate countermeasures as described next for the case when forming layers by coating (mainly organic material layers) and forming layers by sputtering (mainly inorganic material layers) to allow forming multiple layers that retain the irregularities of the grooves.

When recording or erasing or reading out (information) by applying a voltage across numerous electrode pairs on a recording medium containing multiple recording layers, that voltage applied across the electrodes on both sides of the layer where recording, erasing, or readout is being performed, should be different from the voltages applied across other electrodes. This different voltage may include a voltage of reverse polarity. The voltage for coloring and the voltage for decoloring may be voltages of different values with opposite signs. Utilizing different voltages in this way allows selectively coloring a recording layer, and recording or reading out information by irradiating light onto a colored layer.

In this invention, the electrochromic material layer is defined as a layer of material that is directly colored (change in the absorption or reflection spectrum) by the application of a voltage (flow of electrical current). Material not currently referred to as electrochromic material may also be utilized. However, in order to maintain the (light) transmittance when forming a 50 nm thick layer, the light absorption is preferably 10 percent or less and more preferably 5 percent or less at the light wavelength for either recording or readout and if possible both wavelengths when a specified voltage is applied. Also, the layer may contain a region where light is emitted and a region where light is input and coloring or decoloring performed due to application of a voltage (flow of electrical current). Examples of electrochromic material include oxidized tungsten, and polymers of organic molecules of theophene, (polytheophene and its derivatives).

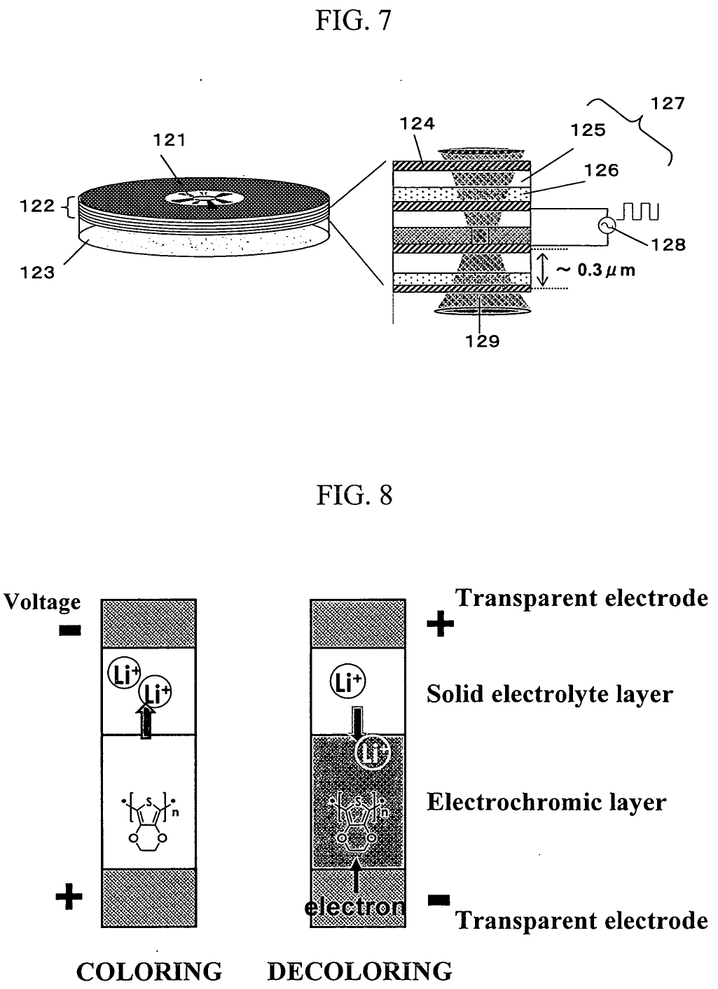

The transparent electrode on the inner circumference of the disk, or the edge of the electrodes extending from the transparent electrode may be formed in a radiating shape 121 as shown in FIG. 7. In the case of a radiating shape, in order to reduce voltage non-uniformities due to surface resistance on the transparent electrodes, two or more radiating shape electrodes are preferably formed on one transparent electrode layer. Here, the reference numerals 123 denote the substrate, 122 denotes the multi-information (recording) layer, 121 is the radiating electrode, 24 is the transparent electrode, 125 is the solid electrolyte layer, 126 is the electrochromic material layer made from conductive organic material, 127 is the recording layer, 128 is the voltage application means, and 129 is the light (laser) beam.

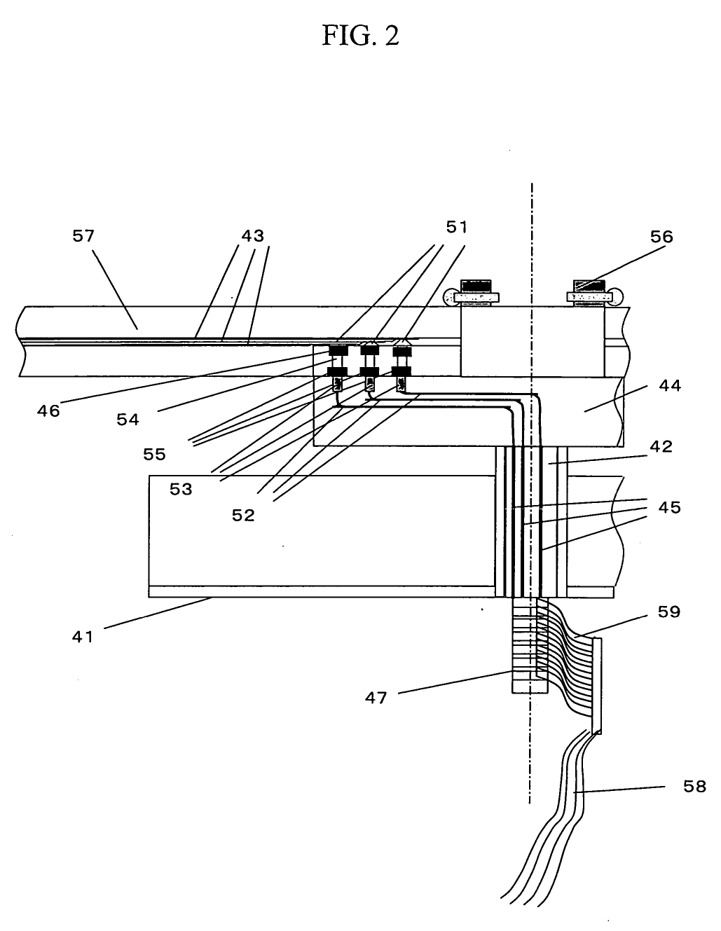

FIG. 2 is a structural view showing one example of the multi information layer disk record/readout apparatus utilized in this invention. The multi information layer disk record/readout apparatus is comprised of an electrical wires 58 below the disk and running from the stationary section of the record/readout apparatus to the rotating shaft 42 of the motor 41, conductive wires 45 from the slip ring voltage conveyor mechanisms 47, 59 towards the tip of the rotating shaft of the motor, a disk bearing (disk loading section) 44, the spring internal pin electrodes 53, and conductive wires 52 running from the internal section of the disk bearing towards the spring internal pin electrode. The spring is depressed by the disk depressor 56 so that the concentric electrode 55 on the disk internal circumference makes contact with the pin electrode 53 of the disk bearing. The pin electrode need not be a pin shape (narrow column or tube) and may for example be a belt shaped electrode formed in an arc. The electrical current is supplied to the transparent electrode 43 on the substrate 57 via the electrodes 55, 54, 46. Drawing numerous electrodes in the vicinity of the disk bearing shown in FIG. 2 might prove difficult to understand so only three electrodes are drawn in the figure. The multiple electrodes on the apparatus side are each long and have a narrow width, and are designed to change when the electrodes rotating as one entire long belt make frictional contact with a contact section. The disk structure is the same as in FIG. 2. Each of the sub-divided multiple electrode of the concentric shaped electrode may be driven in as wedge-shaped metallic pieces.

The concentric electrode or the concentric drawn-out section of the transparent electrode need not be continuous, and as shown in FIG. 12 may be multiple electrodes arrayed on respective circles. The two electrodes at matching angles extend from the transparent electrode layer towards the disk center and render the effect of reducing variations in coloring speed due to the surface resistance of the transparent electrode. The edge of the transparent electrodes (concentric shape and section with concentric shape segmented into section towards the circumference, from 171 to 176 in FIG. 12) may be coated with a material made from metal or carbon particles in order to boost conductivity or augment strength. In FIG. 12, the reference numeral 177 is the center hole.

The recording medium for recording information by applying energy such as light to the recording medium is two laminations or more between two electrodes for making the electrochromic material layer transparent or semitransparent. The recording medium is static and may be an information recording apparatus where the power supply and the electrode on the record medium side are connected by a connector containing multiple metal contact points internally within the insulated cover. The medium of this application is described in further detail next.

(Material and Film Manufacturing Method)

Applying a voltage to the electrodes above and below the electrodes, colors the electrochromic material layer. Here, polytheophene material was utilized when using a 660 nm laser for the light source, and polyanyline material (inductive element) was used when utilizing a blue laser at a wavelength in the vicinity of 405 nm. The layer of polytheophene specifically contains approximately 80 percent by volume of the product name Baytron P by the H. C. Starck Company, the main chemical in the remaining section was t-butyl alcohol, and other elements include a small quantity of boundary-activated NS210, polyvinyl alcohol, 3-GPTM″ (3-glycidoxypropyltrimethylsilane) liquids that were coated on in a layer, heated and dried. In the Baytron P, the micromolecular weight polymer (oligomer) of polyethylene 3, 4 dioxytheophene was attached in some places to macromolecular aggregates of PSS (polystyrene sulfonate). The solid electrolyte material was formed in a layer above this (polytheophene layer). The main ingredients of the solid electrolyte material were PMMA (polymethylmetacrylate) and lithium trifluorosulfate) and this electrolyte material also contained prophylene carbonate, ethylene carbonate, acetonitrile, cyclohexanon and the ultraviolet light curing resin H-9 made by Hitachi Kasei in small quantities. These were applied as a coating, subjected to UV irradiation, heated and dried. The solid electrolyte layer was formed by coating and so the film thickness was thin on the land sections of the substrate, and thick on the group sections.

In order to achieve a uniform film thickness, the recording medium (disk) of this invention was rotated while being irradiated (the same as during initial crystallization) by a high-power semiconductor laser (output 2 watts) at a wavelength of 670 nm by an initial crystallization apparatus (Hitachi Computer Products) per the optical phase-change disk before drying, and 10 minutes after applying the coating (in other words, within 10 minutes after applying the coating, and more preferably within one minute)

Though only a fraction, the laser light is absorbed by the dummy layer or the electrochromic material layer, the thicker the film section the greater the light absorption and the more heat that is emitted so the temperature was high. The surface tensility dropped, and the film thickness exhibited a strong tendency to decrease due to back pressure from the water vapor accompanying the vapor emitted from the organic solvent or moisture. The irradiation was performed at a line speed of 5 meters per second and the differential in film thickness between the land section and the group section was improved to within 10 percent showing a huge improvement. This mechanism for reducing film thickness and absorbing the light from this type of laser irradiation is described in detail in the section on optical recording and recordable optical memory media in Section 3 of “Basics of Optical Memory” published by the Corona Company. Repeating this method for each layer coating does not necessarily mean the shape of the irregularity will be the same as the shape of the groove, and as shown in FIG. 1, the shape may change to resemble a roof shape (Possessing nearly a flat sloped surface on both sides of a line peak with a fixed height, and that shape repeats parallel to the line peak) and stabilize however there will be no change rate of the convex and concave (or protrusions and cavities) sections, so the tracking and address can be read out. In this embodiment an energy beam was irradiated over the entire film, however the energy beam may also be selectively irradiated onto a region of the organic film corresponding to the cavities on the substrate. In this case, the light is irradiated for example via a mask, or a pulse beam is utilized and the pulses are irradiated onto a region of the organic film corresponding to the cavity.

Applying a coating of organic film was described above, however among other coatings for example, a coating of tungsten hydrogen peroxide will prove effective for forming a non-crystalline WO₃ layer. This is an inorganic and not an organic film however irradiating with a laser after applying the coating will prove effective regardless of whether organic film or inorganic film was utilized.

When actually forming a solid electrolyte layer by applying a coating, there is little absorption of laser light so that not much effect is obtained in reducing the film thickness within the groove. Therefore, irradiation is performed at a high line speed with a high power laser on an electrochromic layer so that the film thickness within the groove will be thinner than the film thickness between grooves. When the one recording layer formed by unifying the solid electrolyte layer and electrochromic layer into one layer was examined, there was no change in shape due to the multiple layer laminations and stable irradiation was performed.

As can be seen from viewing FIG. 1, the shape of the irregularities up to the initial 300 nm changes and the height (depth) of the irregularities also changes so that the groove depth on the substrate surface is deeper than the ideal height of the irregularities. A dummy layer 3 made from transparent organic layer in a range from an initial 200 nm to 500 nm was formed, and after its shape has stabilized, an actual multi-information layer is preferably utilized. The dummy layer need not be a structure comprised of a transparent electrode, electrochromic material layer solid electrolyte layer, and may be formed from laminated film or a completely different transparent material such as acrylic resin.

If the substrate surface groove depth is in a range from 1.1 to 2 times the optimum groove depth, then stable tracking can be performed on layer sections where the irregularity height is stable. The groove depth is more preferably within a range from 1.3 to 1.8 times that of the optimum groove depth.

Besides the theophene polymer (abbreviated to polytheophene), also usable are metallic phtalocyanine such as Lu-diphtalocyanine, heptylviologent, tungsten oxalic acid complex, styryl compounds of 3,3 dimethyl-2-(P-dimethylamino styryl) Indorino[2,1-b]oxazorin (IRPDM) (light source wavelength 5145 nm) or 3,3 dimethyl-2-(P-dimethylaminocinnamylidinevinyl) Indorino[2,1-b]oxazorin; and laminated film of polyaniline and poli(2-acrylamidemethane-2-propansulfonic acid) (abbreviated to PANPS) for blue laser recording/readout (described in the lecture paper by D. DeLongchamp and P. T. Hammond in Advanced Materials Vol. 3, No. 19, 1455(2001)). Moreover, a layer of TCNQ (7,7,8,8-Tetracyanoquinodimethane) may be formed for a photoconduction effect.

A monomer, or a micromolecular quantity of just a dozen linked molecules may be subjected to high-speed vacuum vapor deposition, and oligomers and polymers formed on the substrate. The molecules are set to an excited state by irradiating them with an electron beam, ions, blue or near-infrared light to form oligomers and polymers on the substrate. The groove embedding effect is weak when using vacuum vapor deposition, so the laser irradiation after film forming may also be set to a weak level.

Where there is a mix of organic and inorganic materials, for example when the electrochromic material layer is organic material and the solid electrolyte layer and transparent electrode layer are inorganic material, then the laser irradiation method may be applied to the organic material layer after film forming, and the bias sputter method described in the second embodiment may be applied to the inorganic material layer.

Stabilizing the group shape into a roof shape by applying the above methods delivers advantages. The light reflected from the right slope surface and the left slope surface on the roof shape leaves in nearly a flat wave in different directions creating the advantage that crosstalk is not prone to occur even if recording marks are formed on both the right slope surface and left slope surface. Recording may of course be performed on either or both the peak or pit of the roof shape. The roof shape is a repeating shape resembling a section of an arc as seen from a cross section cut on a surface at a right angle to the group, and repeating sets resembling arc shapes, or approximately triangular shapes with no base and reverse triangular shapes with no base.

The amplitude of repeating sets of shapes resembling trapezoids with no base and sets resembling reverse trapezoids with no base (longer side) on a cross sectional cut on a plane at a right angle to the group on the above substrate or ultraviolet light curing resin layer, on in other words if the shape of irregularities separated from the substrate or ultraviolet light curing resin layer are a roof shape, or namely if the slope surfaces are nearly flat on both sides of a line peak of nearly a fixed height, then when the height of the irregularities of those sections repeating in a direction parallel to the line peak is within a range from 0.5 to 0.9 times, then the roof shape will have good reproducibility, and stable tracking can be obtained with a tracking offset within the tolerance range in any layer.

The distribution of light reflecting from the disk also varies between section near irregularities on the substrate surface (in other words, the cross sectional shape of the group is a shape resembling combinations of trapezoids without bases and reverse trapezoids without bases) and, regions where the shapes are stable and there is little change even if the number of layers is increased and these are slightly separate from the substrate. Recording may therefore be performed on all the recording layers. Preferably however, the recording and readout are performed only on recording layers in regions slightly separated from the substrate where the number of layers and the shapes are stable even if the number of layers is increased, because there will be few variations in tracking and recording/readout characteristics. Layers where recording/read out are not performed may be made dummy layers. These dummy layers are preferably formed from a low cost material different from the recording layers. In the recording medium of FIG. 1, the laser is irradiated onto a dummy layer. This laser irradiation largely stabilizes the layer shapes from the next layer.

(Method for Forming the Medium)

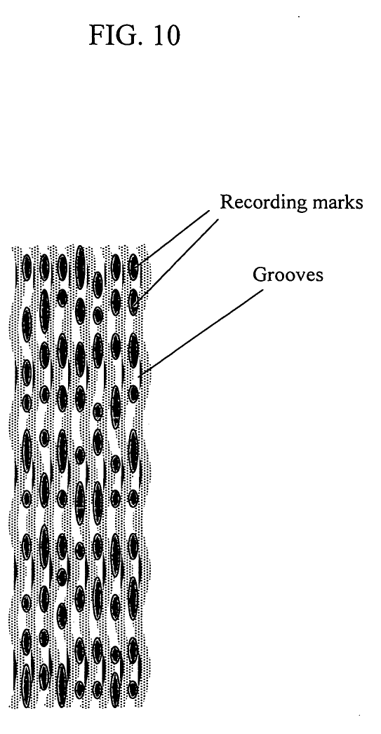

The medium is fabricated as shown next. A polycarbonate substrate with a diameter of 12 cm and thickness of 0.6 mm was first of all formed with tracking grooves (width 0.615 μm) of a depth of approximately 70 nm for land-group recording at a pitch of 0.615 μm on the surface. One track revolution is subdivided into multiple sectors and the beginning of each sector holds a header section expressing the address and synchronization signal in a pit string, as well as a clock expressing the groove wobble. The substrate is largely the same as the DVD-RAM substrate. Utilizing this substrate will not always prove ideal and a substrate for in-groove recording with no pits, and where the address is also expressed by wobbling such as a DVD+RW substrate or a HD-DVD substrate is more preferable in view of the fact that there is no effect on the address pit from coating onto the substrate. A substrate not vulnerable to effects even when interlayer crosstalk occurs is even more preferable. One example of such a substrate is the sample servo format substrate. An overall flat view of the groove is shown in FIG. 10.

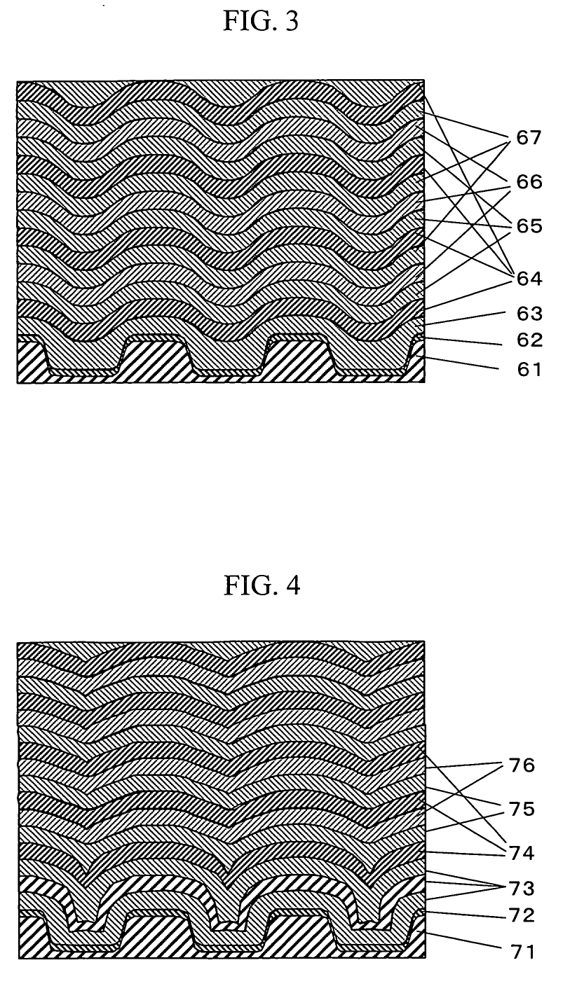

As shown in FIG. 3, an Ag94Pd4Cu2 semitransparent reflective layer 62 with a film thickness of 20 nm was applied to the polycarbonate substrate 61, followed by a dummy layer 63 of acrylic resin mixed with cyanine for absorbing long light wavelengths applied by spin coating, and then an ITO transparent electrode 64 of 100 nm, an electrochromic material layer 65 of 100 nm, a solid electrolyte layer 66 of 100 nm, a WO₃ protective layer (spacer layer) 67 of 50 nm, and an ITO transparent electrode 67 of 100 nm; followed repeatedly in the same way in the sequence of an electrochromic material layer, solid electrolyte layer, WO₃ protective layer, ITO transparent electrode; electrochromic material layer, solid electrolyte layer, WO₃ protective layer, ITO transparent electrode; electrochromic material layer, solid electrolyte layer, WO₃ protective layer, ITO transparent electrode; in five recording layers enclosed on both sides by ITO transparent electrodes. Moreover, a 0.6 mm thick polycarbonate substrate with an outer diameter of 120 mm and inner diameter of approximately 41 mm on the outer circumferential surface; and with electrodes connecting from front to rear, and an outer diameter of 41 mm and an inner diameter of 15 mm on the inner circumferential surface, was laid over these layers. Light entered from the protective substrate side of the aligned substrates. This inner circumferential section of one substrate and the outer circumferential surface of a substrate may be integrated into one polycarbonate substrate. The entire piece was irradiated by a laser after forming the layer coating in order to restore the irregularities (concavities, protrusions).

The ITO transparent electrode was formed by reactive sputtering and the WO₃ protective layer by vacuum deposition. The vacuum deposition protects the lower layer from ion impacts during sputtering if the lower layer is made of organic material and, prevents oxygen from leaching away from the organic film to produce a (unwanted) high resistance layer. The deterioration in characteristics (properties) speeds up when ion impacts are sustained. A WO₃ layer with a thin film (about 30 nm) is preferable for light transmittance. The ITO transparent electrode can be formed by electron beam vapor deposition, laser vapor deposition (method for vapor depositing and film forming by irradiating a high power laser on the target and also called the PLD method). In this case the forming of a WO₃ layer thinner than 50 nm as a protective layer can be omitted. However, the ITO film formed by vacuum deposition becomes slightly lower than the sputtered ITO film in terms of transmittance and conduction. The purpose of this protection is to allow use of a transparent conductive inorganic film that can be formed by vacuum deposition or coating, instead of using WO₃.

The composition of the recording layer of this embodiment is two layers of electrochromic layers of electron-activating conductive polymer coloring material made up of a mixed material comprised of Li trifluorate (formal name of Li trifluorometanesulfonate: CF₃SO₃Li) in acrylic type curing resin, with a solid electrolyte layer of material mixed with a plasticizer; and a layer of PEDT/PSS or in other words poly(3,4 etylenedioxythiophene) and poly(stylene sulfonate).

Other examples of layers enclosed by transparent electrodes include a material described as a coloring control window material in the paper; Electrochromic Window-based on conducting Poly (3,4-ethylenedioxythiophene)-Poly(styrene sulfonate) by Helmut W. Heuer et. al. in Advanced Function Materials vol. 12, No. 2, pp. 89-94 (February 2002); and a layer structure of three layers electron-activating conductive polymer coloring materials comprised of a mixed material of an ion storage/dark current block layer made of (CeO₂)₆₇ (TiO₂)₃₃, an electrolyte layer of Li trifluorate (formal name of Li trifluorometanesulfonate: CF₃SO₃Li), and a layer of PEDT/PSS or in other words poly(3,4 etylenedioxythiophene) and poly(stylene sulfonate). More preferable is adding any of a cyano-base (—Nc), thiol-base (—SH), S-acetyl base (—SAc) prior to forming the theophene type polymer layer. The theophene polymer should be arrayed as much as possible longitudinally towards the direction of the film thickness to make the electrical current flow more easily in the direction of film thickness. Polyethylene oxide—potassium rhodanide is also preferable as the organic electrolyte layer.

When a polymer theophene type polymer material comprised of Star-branched poly (3,4-ethylenedioxychiophene-didodecyloxybenzene) (abbreviated to SPEB) as described in the paper; Electrochromic Linear and Star-Branched Poly (3,4-ethylenedioxychiophene-didodecyloxybenzene) Polymers by Fei Wang et. al. in Micromolecules vol. 33, pp. 2083-2091 (2000), is utilized instead of the PEDT/PSS layer, fast coloring and decoloring, and favorable characteristics can be obtained. The above described electrolyte material is utilized as the electrolyte material.

When an inductive or a semi-conductive layer formed from transparent oxides is installed between a solid electrolyte material and electrochromic material layer, it fulfills the role of Li ions as a barrier layer and, the Li ions are captured by the electrochromic layer and cannot return to the solid electrolyte layer side so that a cause of repeating coloring/decoloring deterioration can be suppressed. A layer for example of chromium oxide in a thickness of about 10 to 50 nm is preferable.

The advantage of utilizing the organic material layers described up to now is that they are conductive, and that their electrical conduction becomes higher as the temperature rises. Also, these layers impart conductivity so the photocarriers are accelerated by the electrical field, and the coloring is hastened by the rise in temperature and the recording sensitivity improved, with the temperature that recording itself occurs being low. As shown in FIG. 8, electrons in the molecules are taken in per the coloring to extinguish the polaron due to the positive charges, and the energy differential versus the excited state becomes equivalent to the visible light energy. Ions such as Li ions, and hydrogen ions (protons) shift to assist this electron movement.

The WO₃ protective layer may be utilized not only as a protective layer but also as a light reflective layer for autofocus and/or tracking and/or readout rather than a protective layer. When utilized as a light reflective layer, it need not be added to all recording layers and may be formed every other layer or every two layers etc., or each of a multiple number of layers. Reflective layers of WO₃ or Ag alloy or aluminum alloy are preferably added to layers where irregularities such as of groups are transferred.

The interval from transparent electrode to transparent electrode was approximately 0.4 μm. This interval is required on surfaces in order to protect from changes in the recording state due to heat dispersing to adjacent layers within a range of 0.1 μm or more. The range must be within 15 μm in order to prevent optical problems such as aberrations or impact interference onto the lens substrate from occurring. A range of 0.2 μm or more and 2 μm or less is even more preferable.

In small recording media where a large sheet resistance is not a significant problem, the transparent electrode may be formed from a conductive polymer such as polyacetylene or polytheophene. In that case, the refraction rate differential with the electrochromic layer is small compared to the inorganic transparent electrode, and is preferable from the point of view of avoiding adverse effects such as from light reflecting from boundaries. A thin layer of copper-based elements (Cu, Ag, Au) averaging 0.5 to 3 nm or a hydrophobic surface processing agent or silane coupling solvent may be formed as the under layer.

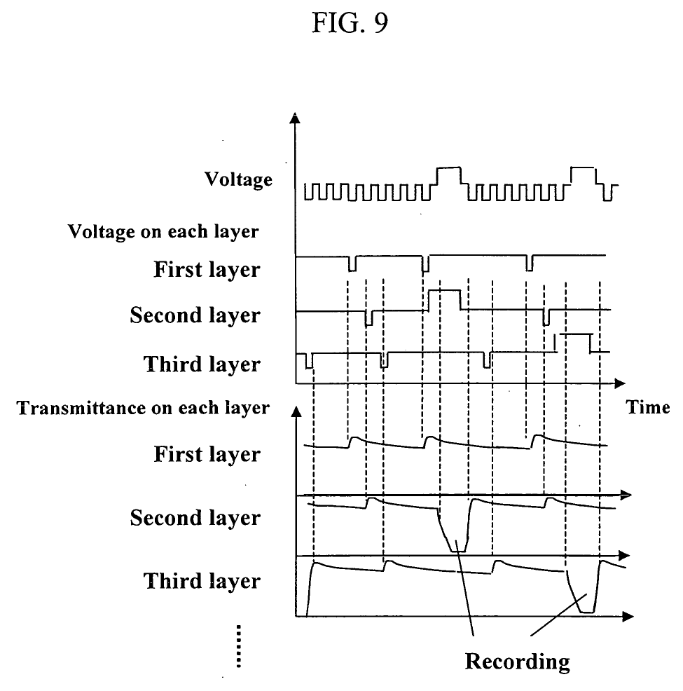

Voltage was also applied to each layer from separate power supplies however performing as follows, allows reducing the number of power supplies and also lowering the electrical power consumption. In other words, the voltage can also be applied by means of a pulsed negative voltage (solid electrolyte material side is the minus side) at intervals to each layer from a single power supply. When selecting the record/read layer, apply a voltage just as in this sequence, or even if the sequence is disturbed, apply the positive voltage over just the necessary time width for record/read and, then return in sequence to applying a negative voltage at intervals from the next layer after record or read is finished, or from the next layer that is supposed to be applied with a negative voltage. The natural color speed is slow when the voltage is removed so an average high transmittance rate can be maintained even by applying a negative voltage at intervals. The positive voltage was five volts and the negative voltage was three volts. FIG. 9 is a timing diagram showing another method for applying a voltage at intervals to each layer from a single power supply per the multilayer disk of this invention. If a layer structure or a material for rapid decoloring within five seconds is utilized, and the voltage on the recording layer was removed, then no application of a periodic negative voltage is necessary. Always set so that one layer is colored or control so as to return the focus position to the reflective layer of the substrate surface, so that a layer capable of focus or tracking is available.

If the electrochromic material is a material whose absorbance or light reflection spectrum is altered by a voltage then it need not be a material referred to currently as electrochromic material. A small disk or recording medium can be fabricated even if a monocrystalline material. However, in a state with little reflectance, the light absorption used is 10 percent or less and more preferably five percent or less. A reflectivity rate differential in a coloring and decoloring state of 5 or more percent and 80 percent or less is preferable for obtaining satisfactory focus—tracking servo and an ample S/N ratio for the read signal. Even more preferable is a range of 8 percent or more and 30 percent or less. A colored state with a high reflectivity is preferable so that the transmittance rate of most transparent layers will be high.

A mixed material comprised of electroluminescent (EL) material and photochromic material may also be utilized instead of electrochromic material.

Fulgide or diarylethane may be utilized for example as the photochromic material. In the case of fulgide, absorption occurs in the vicinity of a 500 nm wavelength due to irradiation by blue light so recording can be performed with a 514.5 nm wavelength Kr laser can be performed.

An overcoat layer was formed of ultraviolet light curing resin on top of the laminated film and, attached onto another same single disk. A reverse voltage was applied when decoloring. Recording was performed by using laser light, and/or applying an electrical current to make the film lose its electrochromic function, so no coloring occurs even if a voltage is applied, or by possessing an absorbance spectrum different from prior to recording. Conversely, recording may be performed by making the coloring stronger. However when the voltage was set to zero or a reverse voltage was applied, then it becomes optically the same as the non-recorded section so the recording must be rendered invisible to the eye.

Rewriting may possibly be achieved when recording so as to cause a phase change in the electrochromic layer or the solid electrolyte layer, between the crystallized—amorphous state, or the crystallized—crystallized state. If the coloring or decoloring speed due to the phase change can be varied by one digit figure or more, then read out can be achieved, if set to read out per just the colored region of whichever phase after applying the voltage. If an inorganic material such as WO₃ is utilized, the amorphous state will prove better since the positive ions will be easier to move, and the speed will be fast.

In another method, recording is performed by causing a physical change (phase change, etc.) by heat or electrical current, or a chemical change (for example, a reaction with Li ions) to cause a change in at least one of either the refraction or the extinction coefficient of an organic or an inorganic film laminated with other layers, so that recording may be performed due to the layer change. For example, a conductive organic film layer may be utilized when there is a rise in heat due to the electrical current or from preheating by the laser beam causes a change in absorption (in the film layer).

In yet another method, recording may be performed by placing a magnetic material whose magnetic orientation is changed by heat or electrical current and a magnetic field, as the recording layer in contact with adjacent electrochromic material or solid electrolyte material. A transparent opto-magnetic material such as garnet may for example be utilized, and designed so a magnetic field reverses when the temperature rises. Preferably, the optical film thickness from a transparent electrode to a transparent electrode is set for one wavelength or an integer multiple of the read out light wavelength, since the optical value will then be equivalent on any recording layer.

(Example of Another Transparent Electrode)

Already known transparent electrode material for example with a composition of (In₂O₃)×(SnO₂)₁₋ₓ, in material where x is in a range from 5 percent to 99 percent, or in more preferably view of the resistance value, material where x is in a range from 90 percent to 98 percent, and SiO₂ is added at mol % within 50 percent to this material, or oxides such as Sb₂O₃ are added at mol % from 2 to 5 percent to SnO₂ may be utilized.

Moreover, the transparent electrode between recording layers may be separated into two layers and a heat blocking layer formed between those two layers. A heat blocking layer of organic material is optically preferably for the same reasons as above. The heat blocking layer may be photoconductive but this is not preferable. Many materials can be used such as acrylic type polymers, oligomers, metal phtalocyanine as vacuum vapor deposition films. Inorganic material such as ZnS—SiO2 may also be used.

(Other Examples of Substrates)

The present embodiment utilizes a polycarbonate substrate including a tracking groove formed directly on the surface. However, a substrate possessing a tracking groove, is a substrate possessing a groove with a depth of λ/15n (n is the refraction rate of the substrate material) or more, when λ is the record-read wavelength on a section or the entire surface of the substrate. The groove may be formed consecutively on the circumference or may be subdivided along the circumference. One can see that in view of the tracking and noise balance, the groove depth is preferably set to approximately λ/12n. That groove depth may also be changed according to the location. Even on substrates using a format that records-reads on both the grooves and the lands, a sample servo format substrate formed at intervals with tracking servo marks may be utilized even for substrates formatted for recording on both or either the lands or grooves. On the type that records only on grooves, and on which the track pitch possesses an NA for the wavelength/focusing lens in the vicinity of 0.7 times, then the groove width is preferably set in the vicinity of one-half of that groove width. Even when the address is expressed by the wobbling of the groove, this may be expressed by the pit row of the groove or land, then expressing it by wobbling is preferable since the laminated layers are not prone to the effects of deformation.

The multi-information-layers may be enclosed by 20 to 40 μm thick spacers, at every certain number of layers (for example, every 10 layers). Irregularity patterns containing at least one of either the tracking grooves or pits may be transferred to the spacer layer from a nickel stamper, and may be utilized in detecting tracking signals and addresses, clock and synchronization signals, etc. In this case, when using two or more spacer layers, a apparatus may be formed for compensating for spherical aberrations in the optical system.

When record-read light in irradiated from side where the substrate was attached, that attached substrate may be thinned to approximately 0.1 mm, and the focusing lens enlarged to an NA of 0.85. These dimensions will allow reducing the track pitch to approximately three-fourths its original size.

When in a concentric shape, the inner diameter of each transparent electrode becomes slightly larger the farther it is from the substrate, and for example when the transparent electrode nearest the substrate is exposed in a ring shape on the inner side, and the voltage can be applied from that section. The transparent electrode above that section is exposed in a ring shape with a slightly larger diameter than that section. Each transparent electrode layer is made by forming the inner circumferential mask slightly larger so that each electrode is exposed in a concentric shape on the inner circumferential section. A ring shaped metal section is formed with a width slightly narrower (for example 90%) than the radius of that exposed section and improving the conductivity and mechanical strength will increase the manufacturing costs somewhat but is preferable particularly in terms of performance.

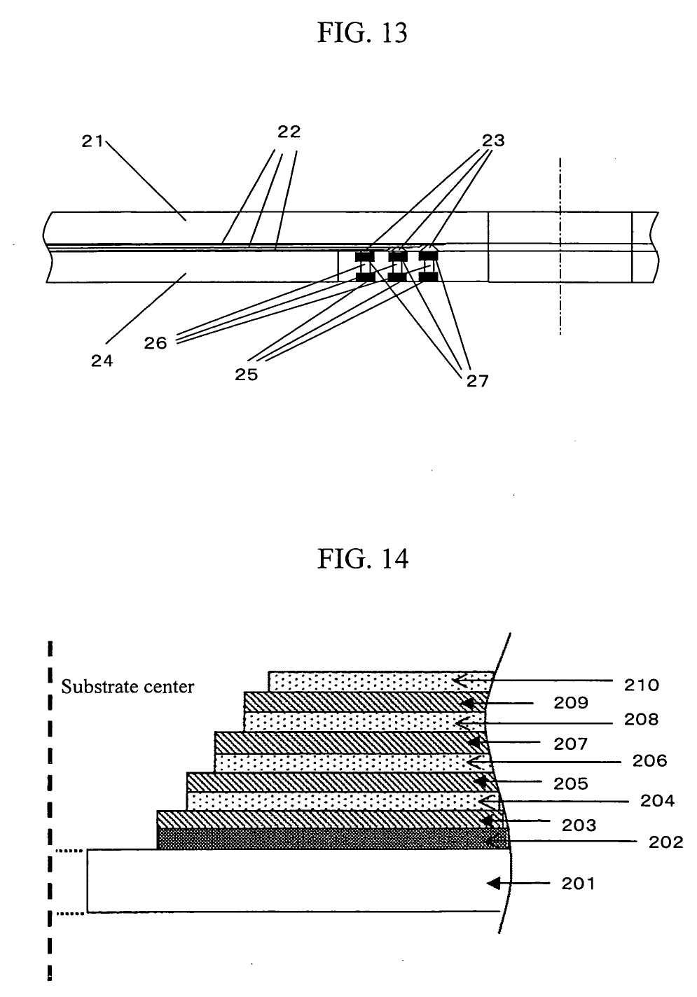

As shown in FIG. 13, metal pins (narrow metal cylinder, or metallic lines) 27 are formed through the inner circumferential surface of the attached substrate 21 as with a printed circuit board, and concentric metal layers 23 corresponding to the number of transparent electrodes 22 are formed on both surfaces. The metal pins 27 are connected to the corresponding electrodes 26, 25 on the front and rear side. A normal printed circuit board has plating (foil) for the metal wiring pattern, on the side attached to the substrate possessing a recording layer. However in this case, a conductive adhesive tape layer, a conductive ultraviolet light curing resin layer, or low melting point metal such as In, or a layer formed from an alloy is formed on the concentrically shaped metal wiring layer, and the conductive adhesive tape is a mixture of conductive material such as at least one from among metallic particles, carbon particles, or metal mesh with an adhesive solution. The In or low melting point alloy is soft and has a low melting point since it is used for compressing the faceplate of the imaging tube, and when pressed against a substrate containing a recording layer, it deforms and adheres to the transparent electrode. If compressed and the temperature is in the vicinity of 100 degrees, this alloy becomes softer and easily compresses. A conductive adhesive solvent may also be used. This method for applying conductive adhesive or glue from the concentric electrode, and then connecting to the concentric electrodes formed on the side of the attached substrate via the concentric electrodes on the glued side of the attached (protective) substrate, and the electrodes with through holes conducting to the attached substrate, and then connecting to the electrodes on the drive apparatus; is preferable since no positioning is required.

However, even in the case of radiating transparent electrodes, if the electrodes are made a concentric shape for the position of the radiating electrode, and for the positioning and attachment of the substrate through hole conducting electrode of the attached substrate, and surface side of the attached substrate (side facing outer boundary after attachment), then there is no need for positioning when the disk is set in the drive apparatus. This type of substrate structure may also be formed on substrates on the side formed with multiple layers. However in that case, the film is formed on the disk internal circumference for transparent electrodes to the upper layer. The conductive adhesive or the glue may be omitted.

This type of disk structure allows making the electrical connections securely and with high reproducibility, reliability and uniformity. The concentric sections of the transparent electrodes drawn out from the disk inner circumference and the circumferential electrodes on the surface of the attached substrate need not always be in a circular (ring) shape, and may be subdivided into multiple electrodes towards the circumference. In this case, two electrodes corresponding to the pair of electrodes sandwiching the recording layer should be installed in positions along the inner/outer directions as shown in FIG. 12, so that a specified voltage will always be applied regardless of how the disk is installed onto the rotating shaft.

This disk is loaded into a disk drive the same as optical disk drives of the related art such as for a DVD-RAM, etc. However, a mechanism for conveying voltage to the disk however has been added. In the present embodiment, the mechanism for conveying the voltage was a ballbearing or a slip ring. A slip ring is a combination of short pieces of metal called a brush for the stationary side and a metal ring for the rotating shaft side. A conducting grease is used to convey electricity to the ballbearing. The voltage conveyor mechanism is installed on the side opposite the disk of the disk rotating motor, or outer side of the disk rotation motor (circumference), or the opposite side of the disk of the disk rotation motor.

A summary of the important points of the recording medium is given as follows. The recording medium is a medium that records information by being irradiated by light. A layer (single or multiple layers) of material whose light absorption or reflection spectrum changes due to application of at least a voltage is a single unit structure enclosed by transparent or semi-transparent electrodes laminated in two or more layers on the substrate. The transparent electrode, or the edge of the electrode extending from this transparent electrode is formed to be exposed in a concentric or a radiating shape, and is further characterized in that another substrate is attached above this substrate. A section of at least one of the substrates is formed with multiple metallic pins for connecting through the substrate or turning around in the vicinity of the center hole of the substrate to reach the surface on the opposite side, and concentric electrodes may be formed on the surface side of the applicable substrate. These concentric electrodes need not each be continuously connected and, multiple electrodes may be arrayed on the respective circles. These multiple electrodes need not be the same electrical potential and may be made to correspond to transparent electrodes for respectively different recording regions. Even more desirable is that the electrode material contain metal or carbon particles that may be coated or attached to the section in contact with electrodes on the drive apparatus side or electrodes for the mating (attached) substrate.

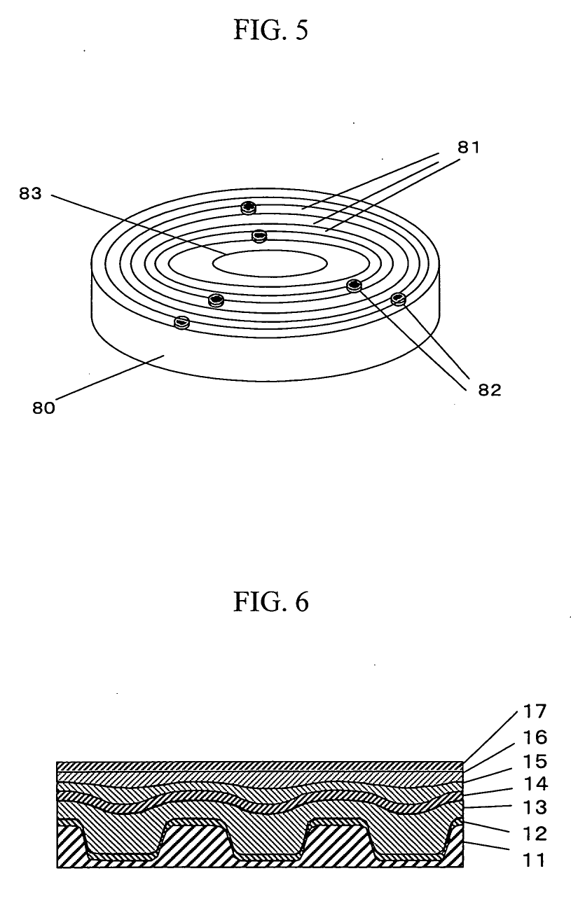

As shown in FIG. 5, in an example of a structure of a disk bearing section containing; one or multiple pin electrodes 82 holding springs positioned on concentric circle 81 formed on the disk bearing 80, and conductive wires extending from each pin electrode of the disk bearing to the rotating shaft tip 83. One electrode is used as the one pin electrode on one concentric circle in the figure.

In the case where the electrode positions for the concentric circle as shown in FIG. 12, are further subdivided into an arc shape, which electrode of a disk loader section or a disk clamp section is installed to correspond to an electrode in what layer on the disk, is preferably detected on the drive apparatus side by means of the differential in focus error signal, and static capacity, and resistance value by way of the drawn out length of the transparent electrode.

Besides the above method for electrical connections for making electrical contact with the rotating section from the stationary section on the drive apparatus a combination of light-emitting diodes or lasers and light sensors, or a combination of coils, or a combination of a magnetic and coil may be used. When using the combination of magnet and coil, the electrode can be selected by changing the distance. However, if the supply of electrical current is insufficient, then multiple sets must be installed, thus occupying a fixed portion of the volumetric space within the drive apparatus. An alternating current voltage occurs when using a coil so this voltage should be rectified.

In this invention, the concave sections on the substrate that are groove sections are referred to as grooves. The sections between grooves are called lands. When irradiating light onto film via the substrate, the grooves appears to be protrusions when viewed from the light input side. Therefore even in methods that irradiate light from the side opposite the substrate, the side with the protrusions as viewed in the same way from the light input side are also sometimes referred to as grooves. This section with protrusions when focusing only on the substrate, is a land section between one groove and another groove so this name is opposite the definition for this invention. When recording on either just lands or grooves, in the case of so-called in-groove recording, recording on protrusions as seen from the light input side is most cases provides good recording characteristics even when irradiating light from the substrate side or also from the side opposite the substrate side. However there is no significant difference so recording on concave sections as viewed from the light input side is also satisfactory.

Irradiating the record-read light from the attached substrate side is a standard feature. The metallic reflective layer need not be installed on the substrate surface, rather a metallic reflective substrate may be formed on the uppermost section if necessary and the laser light may be irradiated from the substrate side.

All the examples of the embodiments utilized disks however a stationary recording medium that does not rotate may be used. In that case, the position of the laser light is changed. The electrode exposure at the concentric stage state, becomes exposure at the linear stage state.

(Recording-Erasure-Read)

Recording and reading of information was performed on the above described embodiment. The operation for recording and reading this information is described next. The motor control method for record/read is described utilizing the ZCLV (Zoned Constant Linear Velocity) method for changing the rotation speed (rpm) of the disk in a zone for carrying out recording. In this recording, the original digital signal is subjected to 8-16 modulation, and recording performed on a multipulse record waveform made up of pulses that become more numerous the longer the length of one recording mark.

Utilizing the recording medium of this invention allows both tracking and autofocus on any layer. Therefore, multi layer recording and read is possible on optical heads using one laser. Recording/read is performed where only the target layer is in a sufficiently colored state. The recording is performed by loss of the color function by heat only at the position irradiated by the laser, or by delaying the coloring.

The coloring mechanism is described next. Each recording layer is basically made up of two layers or three layers. As shown in FIG. 8, the solid electrolyte layer and the electrochromic material layer fulfill the main functions. The solid electrolyte layer is solidified from the initial electrolytic fluid and its operation is easy to understand when one considers the liquefied electrolyte.

Polyethylenedioxytheophene molecules within the electrochromic layer of the polytheophene material are in a state attached to macromolecular aggregates of PSS (polystyrene sulfonate) in some locations. Though the Li within the electrolyte fluid are ionized to a positive charge, the polystyrene sulfonate molecules rob the polyethylenedioxytheophene molecules of their electrons and become negatively charged. A positive charge then occurs in the polyethylenedioxytheophene that forms polaron and biopolaron. The molecules formed by the polaron and biopolaron are almost completely lost through visible light absorption. When a voltage is applied that makes the electrode on the electrolyte fluid side positive, and the electrode on the electrochromic layer negative, the Li ions within the electrolyte fluid move to the electrchromic layer side and gather on the surface layer. A portion of the Li ions are supplied into the electrochromic layer. Electrons are injected from the electrode on the electrochromic layer side so that the electron concentration becomes high within the electrochromic layer, and the electrons bond with the positively charged polyethylenedioxytheophene molecules. Coloring is in this way made to occur. A portion of the electrons captured in the PSS are attracted to the Li ions and head toward the electrolyte liquid.

In this coloring process, light is irradiated and photocarriers generated. Moreover, the conductivity rate for hopping conduction increases when the temperature in the electrochromic layer rises. The electron injection then speeds up drastically, and electrons are also generated as photocarriers so that the coloring is greatly accelerated. Pre-irradiation by means of an advance beam utilizes this phenomenon. If material possesses hopping conductivity, or semiconducting type conduction, or photoconduction characteristics then the same effects can be obtained with materials other than used in this embodiment. Most inorganic electrochromic materials are the semiconducting type and are also photoconductive.

The recording medium of this embodiment yielded a contrast rate for light reflectivity of approximately 2-to-1 for the recording mark versus other sections. When the contrast rate falls below this figure, the flutter exceeds the upper limit of 9 percent due to noise in the read signal, and deviates from the usable read signal quality range.

When recording by crystallizing the electrochromic material layer or the chalcogenide material layer, the erasing is performed by raising the applied voltage and decrystallizing by irradiating with the laser light.

Read out of the recorded information is also performed by utilizing the optical head. The layer for readout is colored by pre-heating the same as during recording. The laser beam is irradiated onto a recorded mark and, the read signal is obtained by detecting the reflected light from the mark and a section other than the mark.

The amplitude of the read signal is increased by a preamplifier circuit and converted to 8 bit information at every 16 bits in the 8-16 demodulator. The above operation completes the readout of the recorded mark. When performing mark edge recording under the above conditions, the mark length of the 3T mark which is the shortest mark is approximately 0.4 μm. The record signal contains the start edge of the information signal, and repeating dummy data for a 4T mark and a 4T space in the end edge (of the signal). The start edge also includes a VFO. Of course, signal modulation methods other than 8-16 modulation may be used.

### Second Embodiment

(Composition, Fabrication Method)

In the example in the second embodiment, a negative substrate bias voltage is applied and sputtering of inorganic film performed.

As shown in FIG. 4, an Ag₉₄Pd₄Cu₂ semitransparent reflective layer 72 with a film thickness of 20 nm was applied to the polycarbonate substrate 71, followed by a dummy layer 73 as a total of three layers of SiO₂, GeO₂, SiO₂ at 400 nm, and then an ITO transparent electrode 74 of 100 nm, an electrochromic material layer 75 of 100 nm, a solid electrolyte layer 76 of 100 nm, an ITO transparent electrode 74 of 100 nm; and followed repeatedly in the same way in the sequence of an electrochromic material layer, ITO transparent electrode, electrochromic material layer, solid electrolyte layer, ITO transparent electrode, electrochromic material layer, solid electrolyte layer, and ITO transparent electrode in five recording layers enclosed on both sides by ITO transparent electrodes. FIG. 4 shows the on-going process. The reflectance of the record/read light increases when a voltage is applied across the electrodes sandwiching the recording layer. Others layers do not cause interference so that the film thickness of each layer can be thinned to approximately 1/100th the film thickness of the related art. Multiple layers can also be positioned within the focal point depth of the focusing lens, so that the disk can possess more layers (multi-layers) and a high capacity compared to the multiple layer disks of the related art. Recording and readout can of course also be performed by shifting the position of the focal point so that no more than one or two layers will be within the focal point depth. The metallic reflective layer may be omitted if the electrochromic material layer possesses high reflectivity.

The disk structure is the same as in FIG. 2, and above this structure was attached a 0.6 mm thick polycarbonate substrate with an outer diameter of 120 mm and inner diameter of approximately 41 mm on the outer circumferential surface; and a glass epoxy substrate with an inner diameter of 15 mm and outer diameter of 41 mm and printed concentric electrodes on both sides connected electrically to concentric electrodes of the same diameter from front to rear. (In other words, this top substrate was polycarbonate on the outer circumference and glass epoxy on the inner circumference.) Light was irradiated from the attached substrate side. The substrates on the internal circumferential section and the external circumferential section may be integrated into one polycarbonate substrate.

The DC bias applied externally during sputtering was set to a negative 100 volts. The substrate is in this way sputtered by argon ion when the AC voltage component has become negative on the substrate side. When there are few layers, the bias sputtering is performed only on the dummy layer and normal sputtering may be performed on layers such as the electrochromic material layer and transparent electrode.

The recording layers may be formed in a three layer structure comprised of one more layer added on top of the electrochromic material layer and solid electrolyte layer. In the case of a three layer structure, a 150 nm layer of IrOx or NiOx (x is a positive integer less than 1) serving as an oxidant colorant first coloring layer, a 300 nm layer of Ta₂O₅ as the solid electrolyte layer, and a 200 nm layer of WO₃ as the deoxidizer colorant type second coloring layer may for example be utilized as the three layers. In the case of a two layer structure, a two layer structure comprised for example of 100 nm layer of WO₃ as the coloring layer and a 100 nm layer of Ta₂O₅ or a similar composition may be used as the solid electrolyte layer, or a 200 nm OH ion storage layer made comprised of Cr₂O₃ (solid electrolyte layer), and a 200 nm coloring material layer comprised of IrOx may be utilized. A metallic electrode such as W-Ti may be utilized instead of the transparent electrode farthest from the light input side. The electrolyte layer is a layer for stable holding of positive ions such as hydrogen, lithium, sodium and magnesium internally and is a shifted layer. When forming film by electron beam vapor deposition, the solid electrolyte layer of Ta₂O₅ yields favorable characteristics from reactive sputtered film in terms of operating voltage, etc. The WO₃ layer and IrOx layer are formed by reactive sputtering using Ar—O₂ gas. An Ir metallic target was utilized in the case of IrOx. After forming the Ir film, a method using the IrOx film as a positive oxidizing electrode is preferably for obtaining satisfactory coloring characteristics.

In the case of laminated layers of inorganic material, film is also attached in the stepped sections of grooves by material atoms or molecules input to the substrate from a diagonal direction so that the groove width sequentially becomes narrower, and the width of the lands between grooves becomes gradually wider when using the normal method for laminating the multiple layers, and therefore read out such of the tracking and address signals and clock signals becomes difficult. This invention therefore applies a method that utilizes photonic crystal formation to form layers. This method was disclosed in 1998 in the 59th Japanese Society of Applied Physics Society 3rd Digest on page 1025 15p-T-11. In this method, sputtering is performed by applying a DC bias voltage to make sputtering a film with argon ions easier than when forming a film on a substrate by conventional sputtering. In this method, the film is deposited while sputtering in localized sections, and the film distribution is different than in the conventional method.

The photonic crystallizing of the above digest is for two dimensional periodic irregularities. This embodiment utilizes periodic irregularities in one-dimensional groove shapes. However even if there is somewhat of a difference in the DC bias conditions, the multilayer film laminations can be formed with nearly the same cross sections. By sputtering under these type of conditions, the roof shape deforms as shown in FIG. 3 as the lamination of the grooves progresses, yet no change occurs in the rate of protrusions and concavities so that reading out the tracking and address is no longer a problem. The bias voltage is preferably set here to −50 volts or more to −500 volts or less.

As can be observed in the figure, the shape of the irregularities changes in layers laminated up to the first 300 nm, and the height (depth) of the irregularities also changes so that the substrate groove depth is made deeper than the optimum irregularity height. A dummy layer comprised of a transparent layer is formed in a range from the first 200 nm of the lamination to 500 nm, and is preferably utilized in the actual multi-information-layer after the shape stabilizes. Rather than a dummy layer structure comprised of a transparent electrode, electrochromic material layer, and solid electrolyte layer, a completely different layer of transparent material such as an SiO₂ layer, or a laminated film of SiO₂ and GeO₂ may be formed.

If the groove depth on the substrate surface was made from 1.1 to 2 times (larger) than the optimum groove depth, then the stable tracking could be achieved on layer sections where the height of the irregularities was stabilized. Still more preferable is a range from 1.3 to 1.8 times (the optimum depth).

Other materials capable of being used instead of WO₃ as the inorganic electrochromic material include (metal) Prussian blue (KₓFe^{II}yFe^{III}z (CN)₆, as a cyanidated compound, MoO₃, Nb₂O₅, V₂O₅, TiO₂, NiOOH, CoOOH, Rh₂O₃, IrOx (x is a positive integer less than 1), ZrNCl, InN, SnNₓ (x is a positive integer less than 21), MnOx (x is a positive integer less than 2), and WO₃—MoO₃ composite (mixed) thin films may be used as the electrochromic material. The WO₃—MoO₃ has the advantage that light absorption can be increased in the vicinity of the 400 nm wavelength.

When inorganic materials are used in the electrochromic material, then both the organic materials already described in the solid electrolytic material, and the inorganic materials described next can be used. However using inorganic material provides the advantage that all processes can be performed by the dry method (vacuum) process such as sputtering, vacuum deposition and electron beam deposition for forming film for all layers. Any of the following laminated films for example can be utilized in a structure enclosed by transparent or semitransparent electrodes. These are WO₃—Ta₂O₅—IrOx, WO₃—Cr₂O₃, WO₃—MgF₂, WO₃—RbAg₄I₅, WO₃—SiO, WO₃—ZrO₂, WO₃—LiClO₄, WO₃—LiF, WO₃—Na₃Zr₂Si₂PO₁₂ (NASICON) WO₃—NaYSi₄O₁₂, etc. Among these, material containing Ta₂O₅ was used by was reported in “Electrochromic Displays” 1991 published by the SangyoTosho Corporation and by Noriyoshi Baba, et. al. on pages 168 through 186. A portion or all of these WO₃ may be substituted in the above described inorganic materials with MO₃, etc.

Recording was performed by utilizing the effect of a laser light, and/or applying an electrical current to make the film lose its electrochromic function, so no coloring occurs even if a voltage is applied, or by making it possess an absorbance spectrum different from that prior to recording. Conversely, recording may be performed by making the coloring stronger. However, when the voltage was set to zero or a reverse voltage was applied, then it becomes optically the same state as the non-recorded section so the recording must be rendered invisible to the eye.

Rewriting may be possible to achieve when recording so as to cause a phase change in the electrochromic layer or the solid electrolyte layer, between the crystallized—amorphous state, or the crystallized—crystallized state. If the coloring or decoloring speed due to the phase can be varied by one digit figure or more, then read out can be achieved, if set to read out just the colored region of whichever phase after applying the voltage. If an inorganic material such as WO₃ is utilized, the amorphous state will prove better for making the positive ions easier to move, and the speed will be faster.

In another method, recording is performed by causing a physical change (phase change, etc.) by heat or electrical current, or a chemical change (for example, a reaction with Li ions) to cause a change in at least one of either the refraction or the extinction coefficient of an organic or an inorganic film laminated with other layers, so that recording may be performed due to the layer change. For example, a conductive organic film layer may be utilized when there is a rise in heat due to the electrical current or from preheating by the laser beam causes a change in absorption (in the film layer).

In yet another method, recording may be performed by placing a magnetic material whose magnetic orientation is changed by heat or electrical current and a magnetic field, as the recording layer in contact with adjacent electrochromic material or solid electrolyte material. A transparent opto-magnetic material such as garnet may for example be utilized, and designed so that the magnetic field reverses when the temperature rises. Other than the laminated film, the cross sectional structure of the disk, the apparatus structure, the voltage application method, and the recording method-read method were the same as in the first embodiment. Besides the voltage conveyance path structure of this invention, the use of laminated film made from inorganic material is also effective in multilayer optical disk apparatus that use a voltage to select the layer.

### Third Embodiment

The examples in the third embodiment use material other than electrochromic substances, or in other words use multiple laminated layers as the recording layer such as oxidized or sulfurized substances possessing high transmittance.

(Composition, Fabrication method)

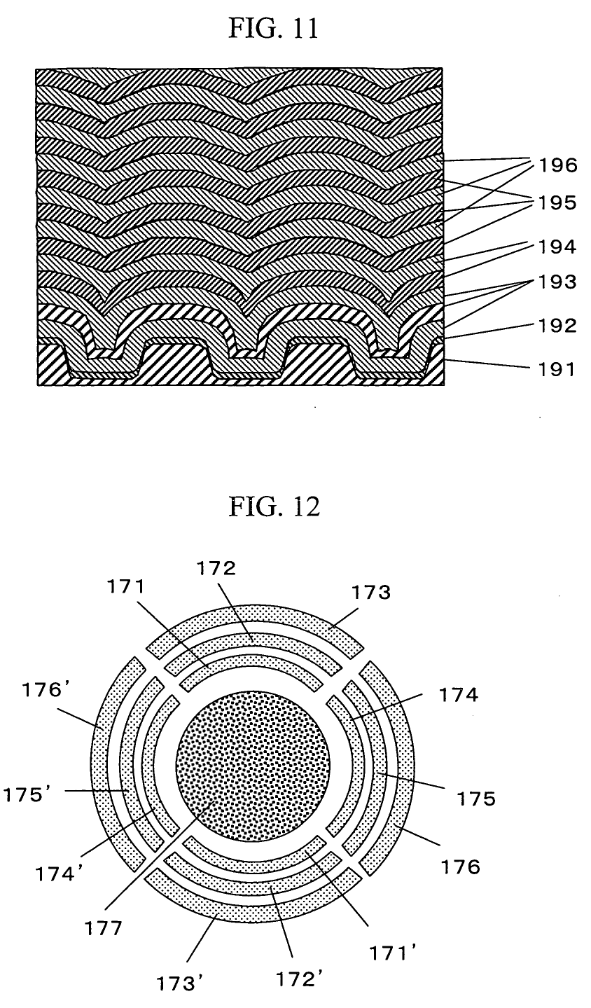

As shown in FIG. 11, an Ag₉₄Pd₄Cu₂ semitransparent reflective layer 192 with a film thickness of 20 nm was applied to the polycarbonate substrate 191, followed by a dummy layer 193 as a total of three layers of SiO₂, GeO₂, SiO₂ in a thickness of 400 nm, and then a Te—O—Pd layer of 100 nm thickness as a dummy layer 194, and above this a (ZnS)₈₀(SiO₂)₂₀ protective layer 194 of 100 nm thickness, a Te—O—Pd recording layer 195 of 10 nm thickness, a (ZnS)₈₀(SiO₂)₂₀ protective layer 196 of 100 nm; and followed repeatedly in the same way by five laminations of recording layers and protective layers. An 0.6 thick mm polycarbonate substrate with an outer diameter of 120 mm thick and an inner diameter of approximately 15 mm was attached. Light was then input from the attached substrate side. Recording may also be performed on that Te—O—Pd layer rather than the dummy layer 194.

When laminated layers of inorganic material, the film is also attached in the stepped sections of grooves by material atoms or molecules input to the substrate from a diagonal direction so that the groove width sequentially becomes narrower, and the width of the lands between grooves becomes gradually wider when using the normal method for laminating the multiple layers, and therefore read out such of the tracking and address signals and clock signals becomes difficult. This invention therefore applies a method that utilizes photonic crystal formation to form layers. This method was disclosed in 1998 in the 59th Japanese Society of Applied Physics Society 3rd Digest on page 1025 15p-T-11. In this method, sputtering is performed by applying a DC bias voltage to make sputtering a film with argon ions easier than when forming a film on a substrate by conventional sputtering. The photonic crystallizing of the above digest is for two dimensional periodic irregularities. This embodiment utilizes periodic irregularities in one-dimensional groove shapes. However even if there is somewhat of a difference in the DC bias conditions, the multilayer film laminations can be formed with nearly the same cross sections. By sputtering under these type of conditions, the roof shape deforms as shown in FIG. 3 as the lamination of the grooves progresses, yet no change occurs in the rate of protrusions and concavities so that reading out the tracking and address is no longer a problem.

As can be observed in the figure, the shape of the irregularities changes in layers laminated up to the first 300 nm, and the height (depth) of the irregularities also changes so that the substrate groove depth is made deeper than the optimum irregularity height. A dummy layer comprised of a transparent layer is formed in a range from the first 200 nm of the lamination to 500 nm, and is preferably utilized in the actual multi-information-layer after the shape stabilizes. The dummy layer structure is preferably formed of a completely different layer of transparent material such as an SiO₂ layer, or a laminated film of SiO₂ and GeO₂.

If the groove depth on the substrate surface was made from 1.1 to 2 times (larger) than the optimum groove depth, then the stable tracking could be achieved on layer sections where the height of the irregularities was stabilized.

The disk structure for other than laminate films, and the method for recording and reading of one disk is the same as for typical optical disks such as DVD+RW, etc. Recording was performed by crystallizing a section of the Te—O—Pd film by irradiation by laser and then coagulating it in localized sections.

The distribution of light reflecting from the disk also varies between sections near the irregularities on the substrate surface (in other words, the cross sectional shape of the group is a shape resembling combinations of trapezoids without bases and reverse trapezoids without bases) and, regions where the shapes are stable and there is little change even if the number of layers is increased and these are slightly separated from the substrate. Recording may therefore be performed on all the recording layers. However recording and readout are preferably performed only on recording layers in regions with few changes and where the shapes are stable even if the number of layers slightly away from the substrate is increased. Recording on those type of recording layers is preferable because there will be few variations in tracking and recording/readout characteristics.

### Fourth Embodiment

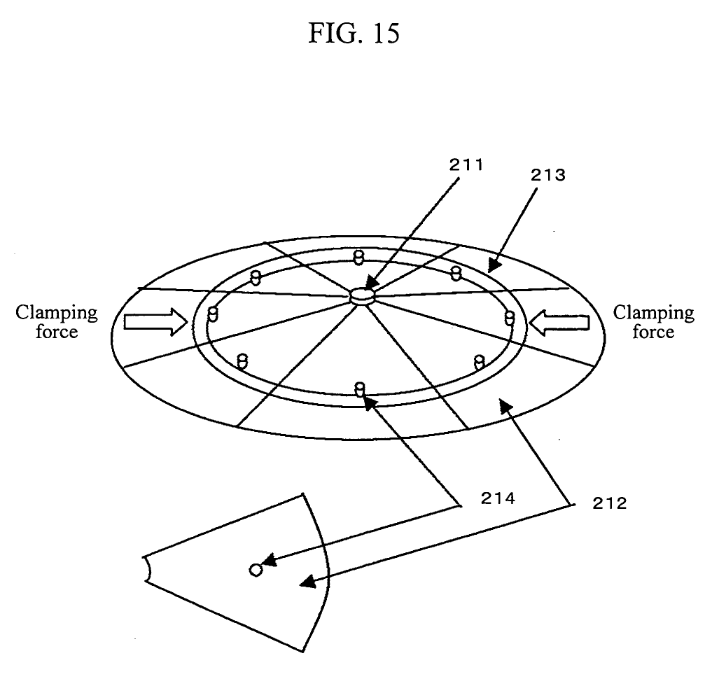

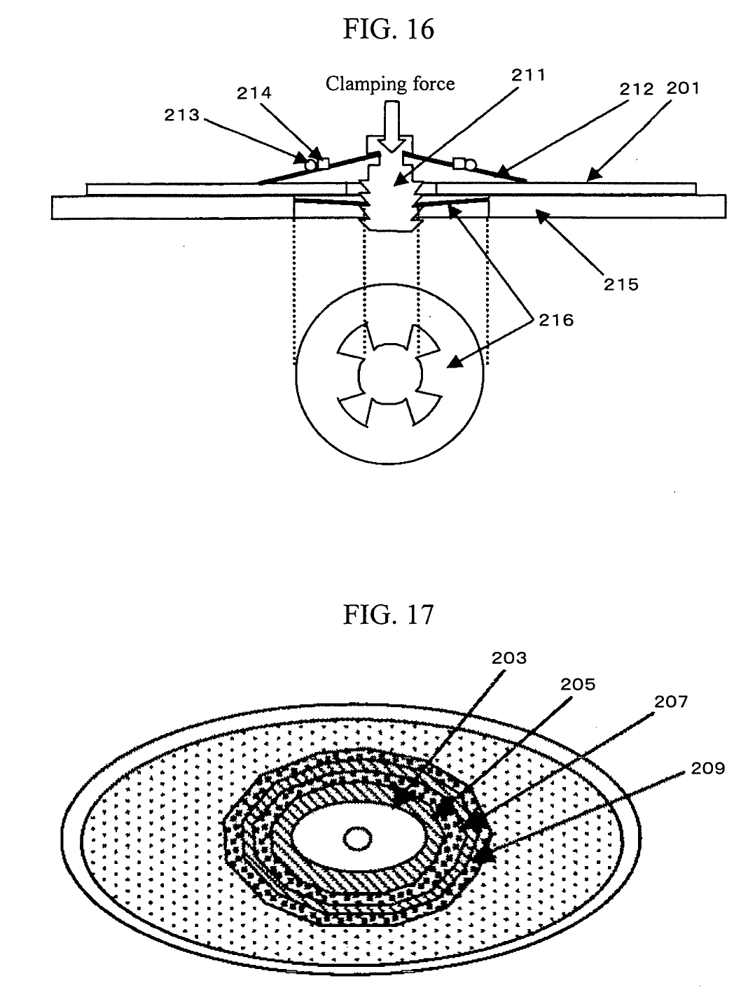

The structure of the multilayer medium of this invention is described next. As shown in FIG. 14, a metal reflective layer 202 is first of all formed on the substrate 201, and then the film is fabricated in the sequence of a first transparent electrode 203, a first recording layer 204, a second transparent electrode 205, a second recording layer 206, a third transparent electrode 207, a third recording layer 208, a fourth transparent electrode 209, and a fourth recording layer 210. If necessary due to optical reasons or due to heat, then two or more sets of spacer layers repeatedly formed between the transparent electrode and recording layers may be laminated. The mask actually used for forming the film is made up of a center shaft 211 and multiple blades 212 and a clamping spring 213 as shown in FIG. 15. Separate projections 214 are formed on the blades, for contact on the outer side of each projection. The ring-shape clamp spring prevents the multiple blades from separating. A pressing force is constantly acting on the center of the clamp spring (force causing compression). As shown in FIG. 16, a cavity (concave section or recess) is formed on the tip of the cylindrical surface of center shaft 211 and multiple irregularities are formed on the rear end. Multiple blades are inserted at a sharp angle into the cavities on the tip of the center shaft.

The multiple blades in this way therefore form an umbrella shape rather than a flat shape. A flat spring 216 formed with multiple notches in the center of a thin circular plate shape is installed in the center of the mount 215 for installing the substrate 201. The section with irregularities on the rear end of the mask center shaft forms a structure for insertion of the center section of the flat spring. Pressing the center of the mask to the mount 215 side, fits the center section of the flat spring into the next irregularity section, and allows positioning the mask height. The angle of the blades changes when the mask height is changed, and the mask average diameter shifts towards the larger side. The film fabrication range in this case changes as shown in FIG. 17. This is the same structure as in FIG. 14. When at least two or more of the projections on the blade are pressed for an optional amount of time while rotating the entire structure, only the mask slips, in a structure allowing the position setting to be changed by shifting the substrate and mask positions circumferentially within the plane for an optional distance. A separate soft material may be applied to the surface making contact with the base plate of the blade, and Tuffram processing, fluoro-coat processing, or emboss processing or a combination of these processes is preferably performed to make the movement smooth.

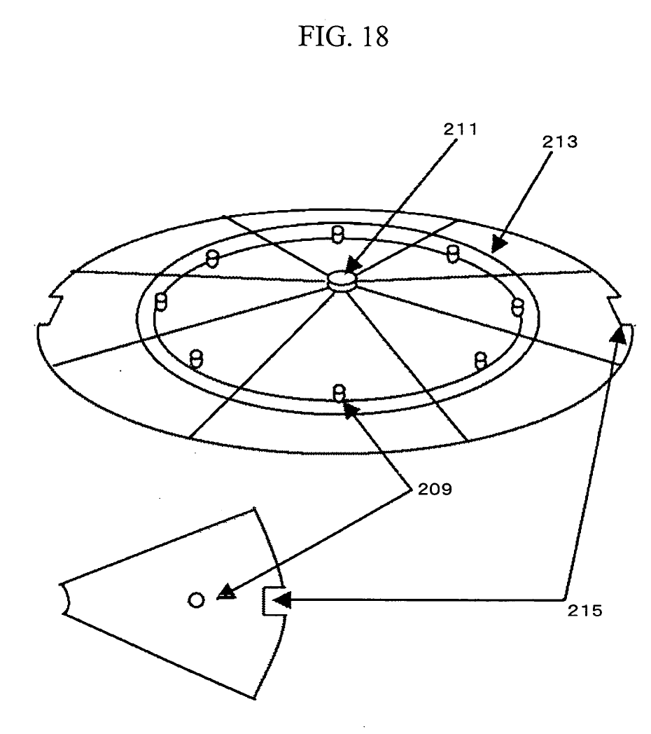

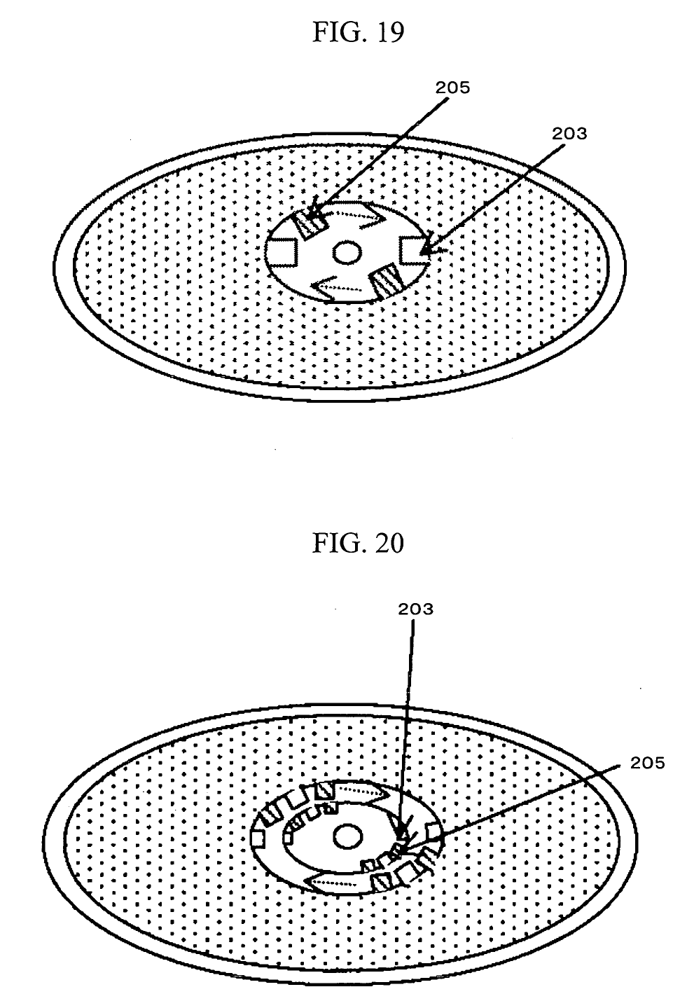

A mask for laminating layer of recording film with different size openings (apertures) was described above, however a mask possessing a recess may be used instead. An example utilizing a mask with recess is therefore described next. An example of the mask with recess is shown in FIG. 18. The mask in FIG. 18 is comprised of a center shaft 211 and a clamp spring 213. A feature of this mask is that a recess section 215 has been formed. Using this mask allows moving the mask towards the circumference to change the film forming (fabrication) range as shown in FIG. 19. In other words, film forming is performed in the mask recess section so that a first set of recording film 203 becomes a projection as shown in FIG. 19; and the second set of recording film 205 becomes a projection as shown in FIG. 19. In other words, the average diameter of the openings (apertures) on the first set of recording film 203 and the second set of recording film 205 are approximately equal except for the protrusion sections. This mask can be used in combination for changing both the setting position and changing the mask shape. In this case, the mask film forming range is changed as shown in FIG. 20. An example of film manufacture is shown in FIG. 20, where after changing the mask setting position and forming a shape as shown in FIG. 19, the mask diameter is widened and the film forming range narrowed, changing the position setting of the now widened mask.

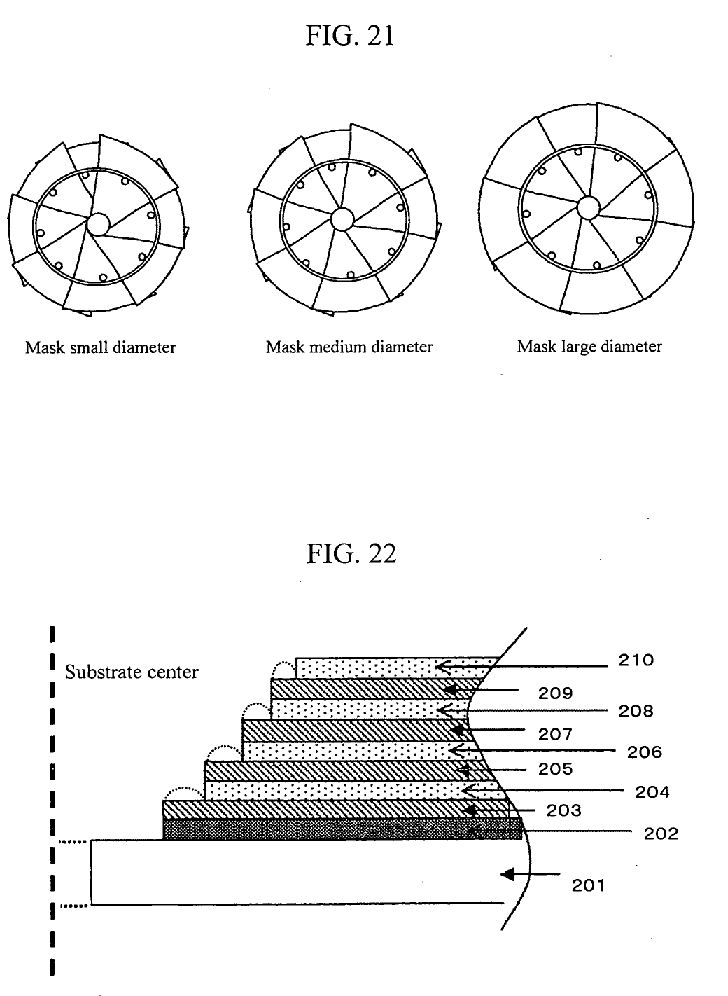

The mask is comprised of multiple blades and preferably includes from two to thirty blades. Though dependent on the blade thickness and material, the thickness and weight render effects when there are too many (thick) blades. A structure with just one blade is possible if there is little change in the blade shape. If the average diameter of the mask is small, then the overlap from edge to edge at one location becomes larger. When the average diameter becomes larger then the amount of overlap changes to a smaller amount. Whether using just one blade or multiple blades, the mask shape changes from the amount of mask overlap. As shown in FIG. 21, the smaller the mask value, the wider the surface area overlap on the mask end section so that rather than being circular the shape protrudes out in some locations. As the average diameter of the mask becomes larger, the overlapping surface area on the mask ends becomes narrower, and the protruding sections become smaller.

Therefore, when changing the average diameter of the mask, the inner circumferential exposed portion of the electrode disappears and when the disk is loaded in the disk receiving section of the drive apparatus, the relative position of the disk and disk receiving section has a degree of margin (optional movement) in the direction of disk rotation so that the electrodes might sometimes not make contact with the electrode. To avoid this problem, the amount of pitch change in the average diameter must be increased per the inner circumference (disk center side). A cross sectional view of the change in the average diameter is shown in FIG. 22. The average diameter of the open section differs in steps on the first, second, third, and fourth films as shown in FIG. 22, and the farther to the disk side, the more the differential in that average diameter becomes larger. Since the average diameter of the mask changes by moving the height of the mask center shaft in steps, the pitch irregularities on the rear end of the center shaft may be changed as shown in FIG. 23.

The film forming range of one mask can therefore be changed as described above. In particular, when continuously forming a film by vapor deposition or by sputtering, the mask shape can be changed even within the vacuum apparatus, and a multi-information-layer medium (or multilayer record medium) can be efficiently fabricated.

### Fifth Embodiment

A specific manufacturing method of the embodiment is described next. As shown in FIG. 16, a substrate 201 is placed on the mount 215, and the masks 211, 212 are inserted. The reference numeral 211 is a mask center and 212 is a part of a mask. The substrate is 12 cm in diameter and 0.6 mm thick. The surface of the substrate contains tracking grooves (width of 0.615 μm) for recording on lands—grooves at a depth of approximately 70 nm and a track pitch of 0.615 μm. One circumference of the track is segmented into multiple sectors, and the beginning of each sector contains a header for expressing addresses and synchronization signals by way of a row of pit, and a polycarbonate substrate is utilized for a clock represented by the groove wobble. This is a substrate largely the same as the DVD-RAM substrate. Utilizing this substrate is not necessarily always the optimum selection and preferably a substrate is utilized that is not susceptible to effects such as from cross talk occurring between layers. One such example is a sample servo format substrate with scattered header sections.

A flat spring 216 is inserted into the first irregularity on the rear end of the center shaft of a mask possessing eight blades. The average outer diameter corresponds to the first opening of the first set made up of recording film and electrode that are minimal at this time. The mask is inserted into the sputter apparatus and an Ag₉₄Pd₄Cu₂ semitransparent reflective layer 202 was formed to a film thickness of 20 nm. Next, a first ITO transparent electrode 203 was formed to 100 nm. The shape of the mask was then changed. An arm between the target and substrate was made to approach towards the center shaft, and the center shaft pressed towards the mount. Each blade was made to slide radially along the substrate to increase the average diameter, by moving the flat spring to the second irregularity at the rear end of the center shaft. This corresponds to the second opening of the second set. The pressing force of the arm determines the flat spring characteristics. The distance matching the irregularity pitch on the center shaft can also be adjusted by moving the arm. Since the flat spring is made of thin plate, material such as carbon steel or copper alloy (phosphor bronze) or stainless steel may be utilized. The irregularity pitch on the tip of the center shaft is determined by the relation between the blade angle and the desired movement distance.

Next, an electrochromic material layer WO₃ formed to 100 nm, and a solid electrolyte layer Cr₂O₃ was formed to 100 nm as the first recording film 204, and a second ITO transparent electrode 205 was formed to 100 nm in that order. The mask shape was then further changed in the same way, and four layers of recording film enclosed on both sides by ITO electrodes in the order of a second recording film, third ITO electrode 207, third recording film 208, fourth ITO transparent electrode 209, and fourth recording layer 210 were successively formed. This structure is shown in FIG. 14. After forming the transparent electrodes in this way, the mask shape was changed so that other films will not adhere to a section on a portion of the electrode that was left exposed for applying a voltage. Above this structure was attached a 0.6 mm thick polycarbonate substrate with an outer diameter of 120 mm and inner diameter of approximately 41 mm on the outer circumferential surface; and with electrodes connecting from front to rear, and an outer diameter of 41 mm and an inner diameter of 15 mm on the inner circumferential surface, was laid over these layers. Light was irradiated from the attached substrate side. The inner circumferential section of the substrate and outer circumferential section of the substrate may be integrated into one polycarbonate substrate.

Other materials capable of being used instead of WO₃ as the inorganic electrochromic material include (metal) Prussian blue (KₓFe^{II}yFe^{III}z (CN)₆, as a cyanidated compound, MoO₃, Nb₂O₅, V₂O₅, TiO₂, NiOOH, CoOOH, Rh₂O₃, IrOₓ (x is a positive integer less than 1), ZrNCl, InN, SnN, (x is a positive integer less than 3), MnOx (x is a positive integer less than 2), and WO₃—MoO₃ composite thin films. These materials may also be used as the protective layer.

A two layer structure comprised of an electrochromic layer and an electrolyte layer may be used as the recording film. Any of the following laminated films for example can be utilized in a structure enclosed between transparent or semitransparent electrodes. These are WO₃—Ta₂O₅—IrOx, WO₃—Cr₂O₃, WO₃—MgF₂, WO₃—RbAg₄I₅, WO₃—SiO, WO₃—ZrO₂, WO₃—LiClO₄, WO₃—LiF, WO₃—Na₃Zr₂Si₂PO₁₂ (NASICON) WO₃—NaYSi₄O₁₂, etc. A portion or all of these films using WO₃ may be substituted in the above described inorganic materials with MO₃, etc.

If the absorbance or the reflectance spectrum of the material changes when a voltage is applied then material not currently referred to as electrochromic material may also be utilized. A light absorption within 10 percent is preferable in a state where there is little absorption and more preferably is 5 percent or less.

Already known transparent electrode material for example with a composition of (In₂O₃)ₓ(SnO₂)₁₋ₓ, in material where x is in a range from 5 percent to 99 percent, or in more preferably view of the resistance value, material where x is in a range from 90 percent to 98 percent, and SiOx is added at mol % within 50 percent to this material, or oxides such as Sb₂O₃ are added at mol % from 2 to 5 percent to SnO₂ may be utilized.

A combination of organic materials and inorganic materials can also be used with this mask for multi-information-layer-mediums combining transparent electrode layers, recording layers and protective layer. For example, when spin coating a recording film comprised of either or both an electrochromic layer and a solid electrolyte layer, it can prevent the coating or attachment of airborne particles onto the exposed portion of the electrode (for applying a voltage). The mask also establishes the range of the coating. Preferably, organic material such as oligomers or polymers of theophene type organic compounds are utilized as the organic electrochromic material. Electrically conductive organic material is particularly preferable. Li trifluorate (formal name of Li trifluorometanesulfonate: CF₃SO₃Li), and polyethylene oxide theocyanate potassium are also preferable as the organic electrolyte layer. Processing to add any of a cyano-base (—Nc), thiol-base (—SH), S-acetyl base (—SAc) is preferably performed prior to forming the theophene type polymer layer.

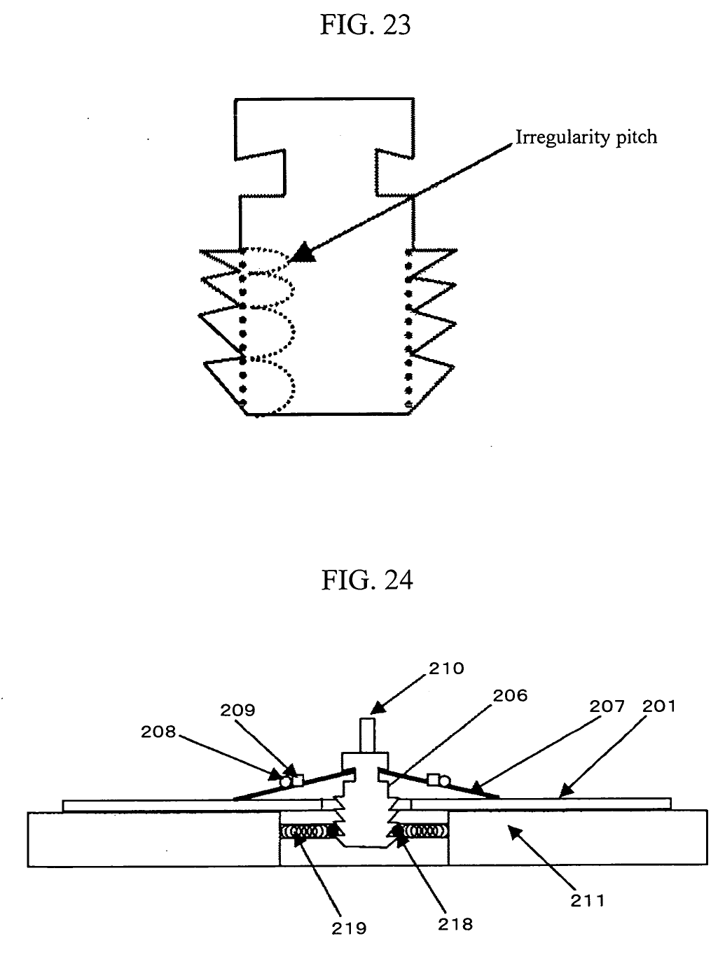

Besides the mount structure for changing the mask shape by installing a flat spring, a structure using a ballbearing may be employed. As shown in FIG. 24, the mount contains a ball 218 and a spring 219 on its inner circumference. Balls are inserted into the irregularities on the rear end of the center shaft of the center mask, and when the mask is pressed from above, the ball presses on the spring, and the spring shortens. The mask height position can be established by the ball sliding so as to fit into the next irregularity. The angle of the blade changes when the mask height is changed, in a structure that changes towards the larger average diameter of the mask.

### Sixth Embodiment

The method for forming on the multilayer substrate is described using FIG. 20. A substrate 201 is placed on the mount 211, and the mask is inserted. As shown in FIG. 18, a recess 217 is formed in at least two of the eight blade of the mask. The average outer diameter is a minimum at this time, and the flat spring 216 is inserted into the first of the irregularities in the tip of the mask center shaft. The mount is inserted into the sputter apparatus and an Ag₉₄Pd₄Cu₂ semitransparent reflective layer 202 was formed to a film thickness of 20 nm. Next, a first ITO transparent electrode 203 was formed to 100 nm. The shape of the mask was then changed. Blades formed with projections are made to approach the arm between the target and substrate, and pressed to abut against at least two or more projection. The arm may be identical to the arm of the first embodiment or a different arm may be utilized. The substrate is clamped to the mount so it continues to rotate but since it is pressed by the projections, just the mask slips so that an offset occurs versus the substrate.

The position of the mask recess is in this way changed versus the substrate. The distance (amount) of the offset is determined by the rotation speed and the clamped time. An electrochromic material layer was formed to 100 nm, and a solid electrolyte layer Cr₂O₃ was formed to 100 nm as the first recording film, and a second ITO transparent electrode was formed to 100 nm in that order. Next, the recess position clamping the mask protrusion was changed in the same way, and four layers of recording film enclosed on both sides by ITO electrodes were formed in the order of a recording film, an ITO transparent electrode, a recording film, an ITO transparent electrode, and a recording film. Here there is a first opening, formed with a protrusion of the transparent electrode at two locations in each layer for a total of ten locations in five layers. In order to avoid voltage non-uniformities due to surface resistance on the transparent electrodes, two or more protrusion electrodes are preferably formed on one transparent electrode layer.

The mask diameter is further widened the same as in the fourth embodiment, and after forming the second opening, the eight recording layer laminations were repetitively formed the same as previously described. A 0.6 mm thick polycarbonate substrate with an outer diameter of 120 mm and inner diameter of approximately 41 mm on the outer circumferential surface; and with electrodes connecting from front to rear, and an outer diameter of 41 mm and an inner diameter of 15 mm on the inner circumferential surface may be laid over these layers. Light was irradiated from the attached substrate side. The inner circumferential section of the substrate and outer circumferential section of the substrate may be integrated into one polycarbonate substrate. The electrochromic material layer, solid electrolyte layer, and transparent electrode layers are the same as in the fourth embodiment.

Even greater multilayer high density capacity can be attained in this way by a combination of changes in the recess position and changes in the mask diameter.

### Seventh Embodiment

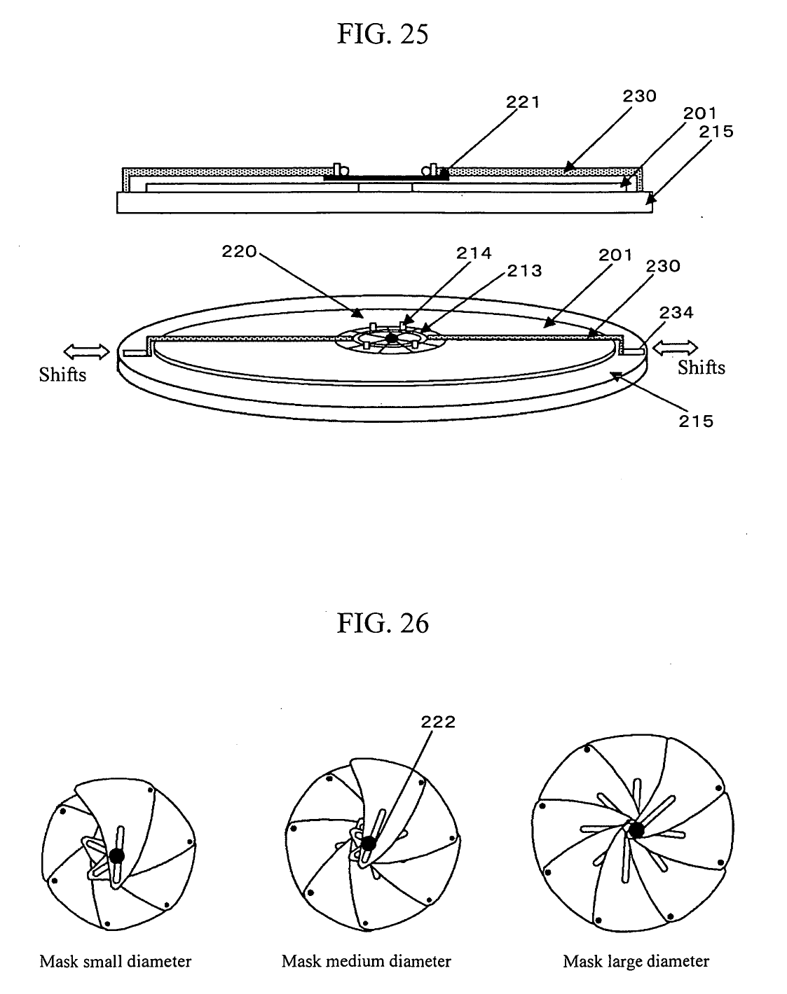

A description is given using FIG. 25. A substrate 201 and a mask 220 are set on the mount 215. This mask is not set on the disk, rather it is clamped in two locations by an arm bar 230, and set on the mount side for installing the substrate 1. A groove 234 for the arm bar 230 movement is formed on the arm bar. The arm bar is clamped by the clamp piece 221. The arm bar is not a significant hindrance when forming film by rotating the substrate. The mask shape is changed by moving the arm bar. The mask structure is made up of multiple blades the same as in the second and fourth embodiments, however as shown in FIG. 26, a slotted holes is formed on the inner circumference for movement without the blade deviating from the center shaft.

Adjacent blades and overlapping sections are secured by two machine screws 222 penetrating through two blades on both ends of the blade outer contour. These blades are not secured by adhesive, so the blades can rotate centering on the machine screw. The two blades at the top and the bottom of all the blades are secured at only one location. The projections 214 are formed on each blade. A ring shaped clamp spring 213 is provided for making contact on the inner side of each projection. A force is constantly acting to widen the clamp spring to the outer side. The arm bar suppresses the widening of the clamp spring. The amount of movement of the arm bar determines the average diameter of the mask. The arm bar is at this time pressed to the most inner circumferential side. The mask average diameter is a minimum at the first opening. The components set as described are now inserted into the sputter apparatus where first of all an Ag₉₄Pd₄Cu₂ semitransparent reflective layer 202 was formed to a film thickness of 20 nm. Next, a first ITO transparent electrode 203 was formed to 100 nm.

The shape of the mask was then changed. The clamp spring widens along the arm bar to move the arm bar towards the outer circumferential side. The projections are pressed to widen outwards as one piece with the blades and the blades overall also change. The slotted holes on the blade inner circumference are for movement of the blades at this time without deviating from the center shaft. This is a second opening. Next, an electrochromic material layer WO₃ formed to 100 nm, and a solid electrolyte layer Cr₂O₃ was formed to 100 nm as the first recording film 204, and a second ITO transparent electrode 205 was formed to 100 nm in that order. The mask shape was then further changed in the same way, and four layers of recording film enclosed on both sides by ITO electrodes in the order of a second recording film, third ITO transparent electrode 207, third recording film 208, fourth ITO transparent electrode 209, and fourth recording layer 210 were successively formed. This structure is shown in FIG. 14.

After forming the transparent electrodes in this way, the mask shape was changed so that other film sections would not adhere to sections on the electrode left exposed in order to apply a voltage. A 0.6 mm thick polycarbonate substrate with an outer diameter of 120 mm and inner diameter of approximately 41 mm on the outer circumferential surface; and with electrodes connecting from front to rear, and an outer diameter of 41 mm and an inner diameter of 15 mm on the inner circumferential surface was then laid over these layers. Light was irradiated from the attached substrate side. The inner circumferential section of the substrate and outer circumferential section of the substrate may be integrated into one polycarbonate substrate.

The electrochromic material layer, solid electrolyte layer, and transparent electrode layers were the same as in the fourth embodiment. The arm bar and the mask may also be clamped on the sputter apparatus side. In this case, the only the substrate is inserted and moved. Also in this case, the substrate is rotating during film forming so there is no effect on the film thickness distribution.

Spacers layers with a thickness from 1 to 40 μm may enclose a certain number of layers within the multilayer information (recording) layers (For example, these spacer layers that match the number of beams, or number of beams minus the number of spare irradiation beams, at every five layers are particularly preferable.). Irregularity patterns containing at least one of either the tracking grooves or pits may be transferred to the spacer layer from a nickel stamper, and may be utilized in detecting tracking signals and addresses, clock and synchronization signals, etc.

When record-read light is to be irradiated from the side where the substrate was attached, then that attached substrate may be thinned to approximately 0.1 mm, and the focusing lens enlarged to an NA of 0.85. These dimensions will allow reducing the track pitch to approximately three-fourths its original size.

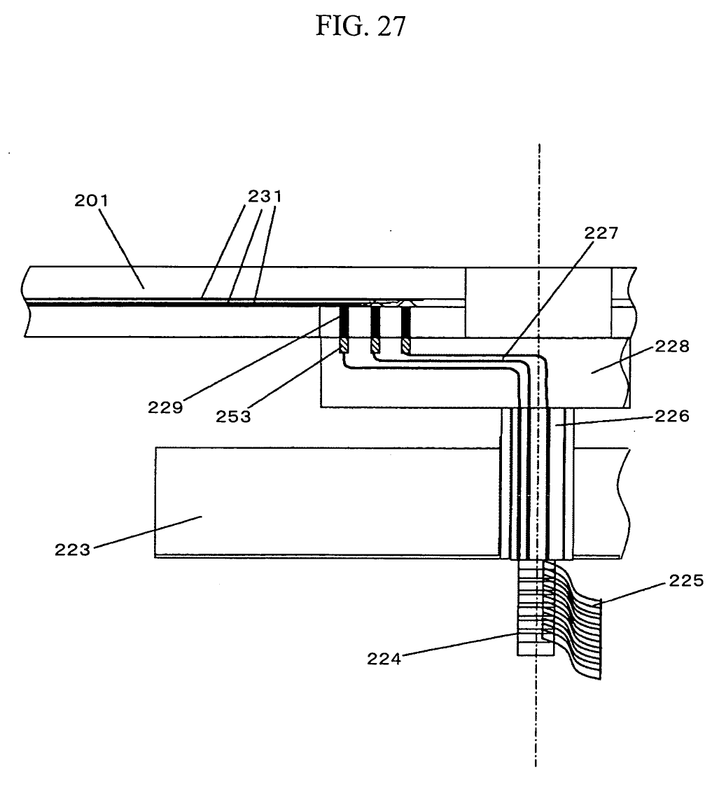

FIG. 27 is a structural drawing showing one example of the record/read apparatus of the information recording medium utilized in this invention. The record/read apparatus below the disk, is from the stationary comprised of a slip ring voltage conveyor apparatus 224 on the lower section of a motor 223, electrical wires 225, a conducting wire 227 extending towards the tip of the rotating shaft 226, a disk receiver (disk loader section) 228, an electrode 253, and an internal spring pin electrode 229. Drawing a large number of electrodes in the vicinity of the disk might prove difficult to understand so only three electrodes are drawn here. Multilayers of information recording layers enclosed by the transparent electrodes 231 are formed on the substrate 201 on the disk cross section. These transparent electrodes 231 are electrically connected to the metal pins 229 connecting through the substrate.

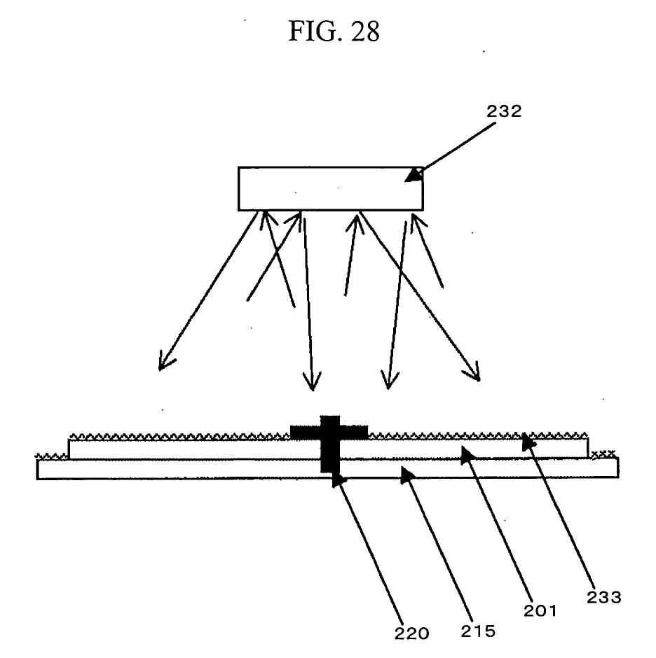

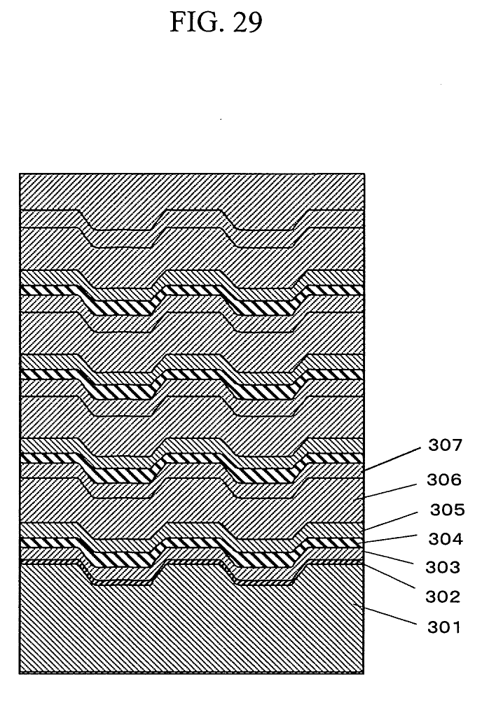

FIG. 28 is a concept drawing of the sputter apparatus forming the information recording medium of this invention. A substrate 1 is set on the mount 215 and the inner circumference of the mask 220 inserted. The ions accelerated in the discharged argon gas impact on the target and atoms from the target 232 that was struck by the ions adhere to the substrate (233), forming the film. The film forming range is sections other than those covered by the mask.

The recording medium of this embodiment yielded a contrast rate for light reflectivity of approximately 2-to-1 for the recording mark versus other sections. When the contrast rate falls below this figure, the flutter exceeds the upper limit of nine percent due to noise in the read signal, and deviates from the usable read signal quality range. When the content of the transparent electrode is made to contain SiO₂ for example, (SiO₂)₄₀(In₂O₃)₅₅(SnO₂)₅, the refraction rate drop, superior optical results obtained, and a contrast rate of 2.5: was obtained.

The specific structure of the recording medium of this invention is described as follows. As shown in FIG. 29, a metallic reflective layer 302 is first of all formed on the substrate 301. Then a first transparent electrode 303, electrochromic material layer 304, solid electrolyte layer 305, and second transparent electrode 307 films formed in sequence, are repeatedly laminated optically or thermally in two sets or more enclosed by spacer layers 306. The recording or the readout laser light absorption rate or the reflectivity (rate) is preferably made to increase when a voltage is applied across the electrodes sandwiching the recording layer. The desired layer can in this way absorb light, while the other layers absorb almost no light. Others layers do not cause interference so that the film thickness of each layer can be thinned to approximately 1/100th the film thickness of the related art. Multiple layers can also be positioned within the focal point depth of the focusing lens, so that the disk can possess more layers (multi-layers) and a high capacity compared to the multiple layer disks of the related art. Recording and readout can of course also be performed by shifting the position of the focal point so that no more than one or two layers will be within the focal point depth. In this case, the pits and grooves expressing the address information sometimes deformed when using multilayer (laminations) so in some cases multiple laser beams may be used, and one beam aligned with its focal point on the reflective layer directly above the substrate (formed with grooves and pits), and after fixing the positional relation of this beam and the direction on the disk surface, then making another beam arrive at its focal point position on the layer for record or play (read). When using a multilayer medium, multiple layers must be reformed to transfer the pits and grooves to allow the address to be read at the now shifted focal point position. The metallic reflective layer may be omitted if the electrochromic material layer possesses high reflectivity. Finally, the substrate is attached to one more of the same type substrate.

Electrochromic materials that have been reported include for example, oxidized tungsten, and polymers of organic molecules of theophene, (polytheophene and its derivatives). Other types of electrochromic materials were described in “Electrochromic Displays” (first version published Jun. 28, 1995 by SangyoTosho Co., Ltd. and currently many electrochromic materials have been reported in academic papers. A high recording sensitivity allows achieving a high transfer speed without problems due to insufficient power even when using surface emission lasers or array lasers as the light irradiation means simultaneously at multiple locations on the recording media (including multiple layers), and during high line speed recording. A sequential voltage or pulses may be alternately supplied simultaneously to at least two pairs of electrodes on a recording medium possessing multiple electrode pairs. A low maintenance voltage or an intermittent maintenance voltage must be applied: when utilizing material where the color changes or, when recording or reading multiple layers simultaneously after positioning the focus point of each beam of an array laser on each layer or, when utilizing a portion of the beam as a reference for focus alignment or tracking.

When recording or erasing or reading out (information) by applying a voltage across numerous electrode pairs on a recording medium containing multiple recording layers, that voltage applied across the electrodes on both sides of the layer where recording, erasing, or readout is being performed, should be different from the voltages applied across other electrodes. This different voltage may include a voltage of reverse polarity.

Electrochromic material layer in this invention is defined as a layer of material that is directly colored (the absorption or reflection spectrum changes) by the application of a voltage (flow of electrical current). Material not currently referred to as electrochromic material may also be utilized. However, in order to maintain the (light) transmittance when forming a 50 nm thick layer, the light absorption is preferably made 10 percent or less and more preferably 5 percent or less at the light wavelength for either recording or readout and if possible both wavelengths when a specified voltage is applied. Also, the layer may contain a region where light is emitted and a region where light is input and coloring or decoloring performed due to application of a voltage (flow of electrical current).

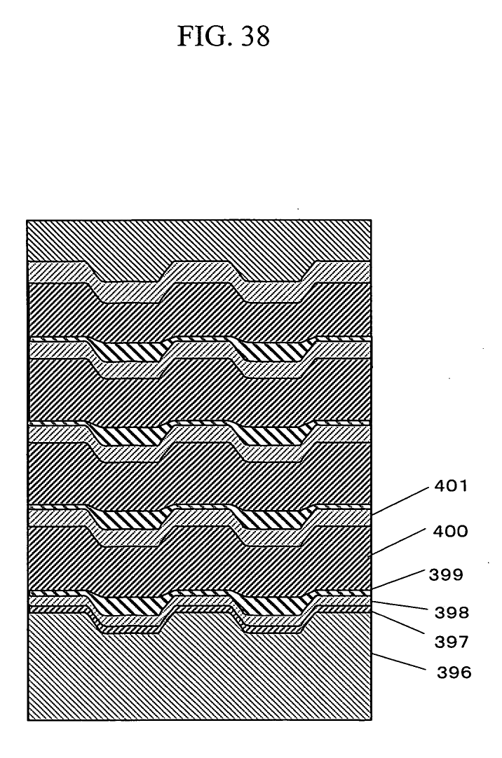

An example of a structure of another recording medium of this invention is shown in FIG. 38. This recording medium is layer laminations of two sets or more other than the reflective layer in which film is formed on a substrate 396 in the order of reflective layer 397, transparent electrode 398, conductive organic material layer 399, solid electrolyte layer 400, and transparent electrode 401.

The transparent electrodes on each layer on the disk inner circumference, or the edge of the electrodes extending from the transparent electrode may be formed in a concentric shape. These electrodes may also have a radiating shape as shown in FIG. 7. In the case of a radiating shape, in order to reduce voltage non-uniformities due to surface resistance on the transparent electrodes, two or more radiating shape electrodes are preferably formed on one transparent electrode layer.

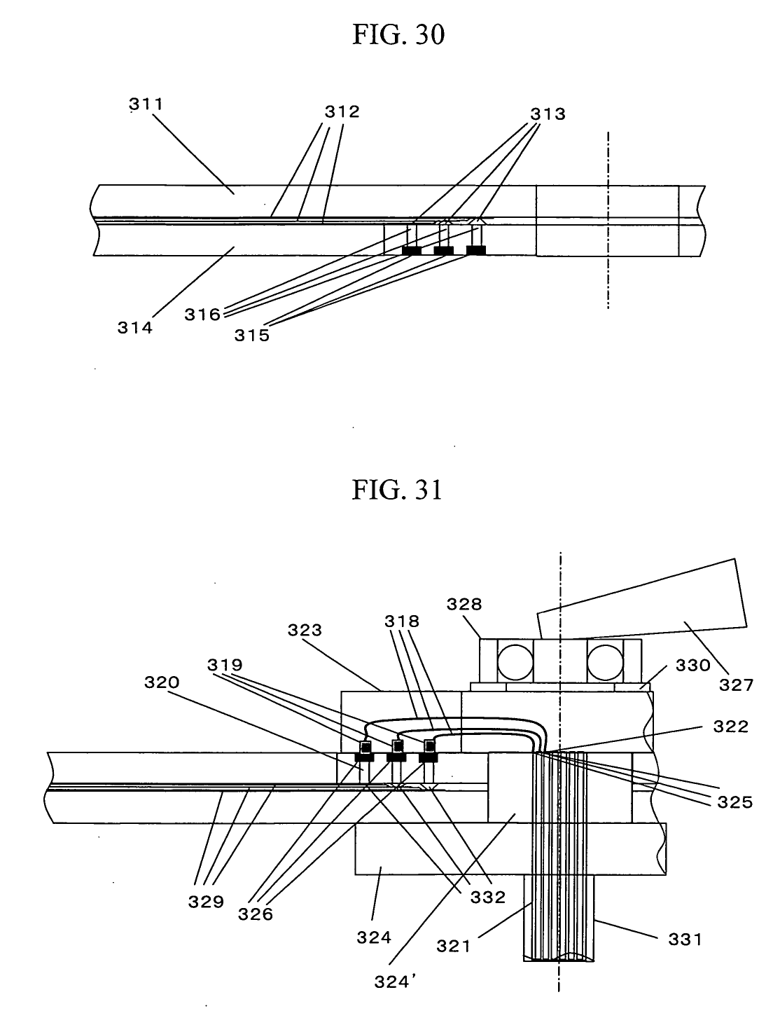

As shown in FIG. 30, multiple metal pins 316 may be formed on a section of at least one of the substrates 314 to connect through the substrate. The metal pins connect to the concentric electrode 315. The opposite end of the metal pins 311 are connected by way of the conductive material 313 to the multiple transparent electrodes 312 on the substrate (for film forming) 311. The metal pins need not be a pin shape and may for example be a belt shaped electrode formed in an arc or ring shape with the center corresponding to the center of the disk. The pins also need not pass through the substrate, and may return back in the vicinity of the disk center.

The concentric electrode or the concentric drawn-out section of the transparent electrode need not be continuous, and multiple electrodes may be arrayed on respective circles. The edge of the transparent electrodes (section with concentric shape) may be coated with a material made from metal or carbon particles in order to boost conductivity or augment strength.

FIG. 31 is a drawing showing the structure taken of the multilayer disk record/read apparatus of the embodiment of this invention. In FIG. 3 1, the reference numeral 318 is electric wires and 320 is a metal pin formed on a section of at least one of the substrates to connect through the substrate. The metal pins 320 connect to the concentric electrode 326. The reference numeral 329 is transparent electrodes and 323 is a disk clamp means. In this multilayer record/read apparatus, information is recorded by imparting information beforehand to the record medium in the shape of irregularities, or applying energy such as light to the recording medium. FIG. 44 is a drawing showing an example of a multilayer record medium where information is applied beforehand to the record medium in the shape of irregularities. This apparatus includes: a conducting wire 321 exiting the voltage conveyance apparatus to the rotating shaft 331 from the stationary section of the record/read apparatus below the disk loaded in the disk receiving section (disk loading section) 324, 324′ and routed towards the tip of the rotating shaft; and electrodes 325 in a pin shape or a concentric circle shape or concentric tube shape or a concentric cone shape to correspond to the number of disk electrodes; and a disk clamp 323 secured to the drive apparatus for clamping the disk and rotating along with the disk rotation via the ball bearing 328, and arm 327; and electrodes 322 formed in the disk clamp in a pin shape or a concentric circle shape or concentric tube shape or a concentric cone shape; and metal pin electrodes 319 with internal springs to correspond to the concentric electrodes on the inner circumference of the disk. However either of the electrodes making mutual contact with the rotating shaft top and the disk clamp are not pin shapes but concentric shapes or shapes segmented (subdivided) into the respective circle of the concentric shape, and the multilayer record/read apparatus includes a means for controlling the rotating shaft top and the concentric electrodes of the disk inner circumference so as to make contact when the disk is inserted into the disk drive and the disk clamp moves towards the disk. The drawing might prove difficult to understand if there are a large number of electrodes in the vicinity of the disk so only three electrodes are drawn here. The reference numeral 330 is a section connecting the ball bearing and disk clamp.

Rather than being continuous, each of the multiple concentric circle or concentric tube or concentric cone shaped transparent electrodes, and multiple electrodes may be arrayed on respective circles. The wedge-shaped metallic pieces of the electrode may be driven in to install them. The section drawn-out onto the inner circumference of the transparent electrode may be coated with a material containing metal or carbon particles.

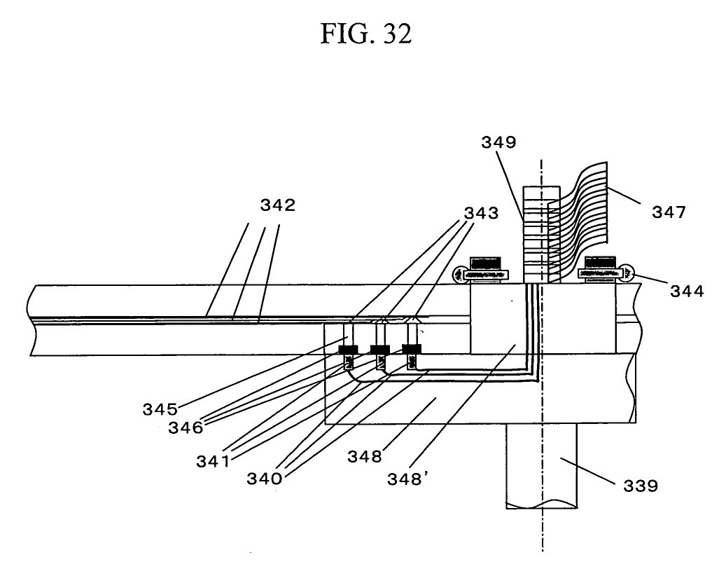

FIG. 32 is a drawing showing the structure taken of the multilayer disk record/read apparatus of another embodiment of this invention. In this multilayer record/read apparatus, information is recorded by imparting information beforehand to the record medium in the shape of irregularities, or applying energy such as light to the recording medium. This multilayer record/read apparatus includes a conducting wire 341 installed from the spring internal pin 341 installed below the disk receiving section (disk loading section) 348, 348′ towards the tip of the rotating shaft; and a means for connecting to the laminated cylindrical electrodes 349 or the cone shape electrodes corresponding to the number of disk electrodes on the tip of the rotating shaft connecting to the conducting wire; and a means for making the multiple electrodes 347 on the apparatus side contact the rotating laminated cylindrical electrodes 349 or the cone shape electrodes corresponding to the number of disk electrodes; and a disk clamp 344 for clamping the disk while the disk is rotating, and rotating along with the rotating shaft. The pin electrode need not be a pin (narrow rod or cylinder) shape, and may for example be a belt shaped electrode comprising an arc. In FIG. 32 drawing multiple electrodes in the vicinity of the disk receiving section might prove difficult to understand so only three electrodes are drawn here. The multiple electrodes on the apparatus side are respectively narrow in width and long, and is configured so that the contact position can be changed if the section contacting the rotating electrodes overall in one long belt shape becomes worn. In FIG. 32, the reference numeral 340 is electric wires and 339 is a rotating shaft. The reference numeral 342 is transparent electrodes, 343 are conductive materials and 347 is a brush set.

The multiple concentric circle or concentric tube or concentric cone shaped transparent electrodes, and multiple electrodes may be arrayed as multiple electrodes on respective circles, rather than being continuously connected.

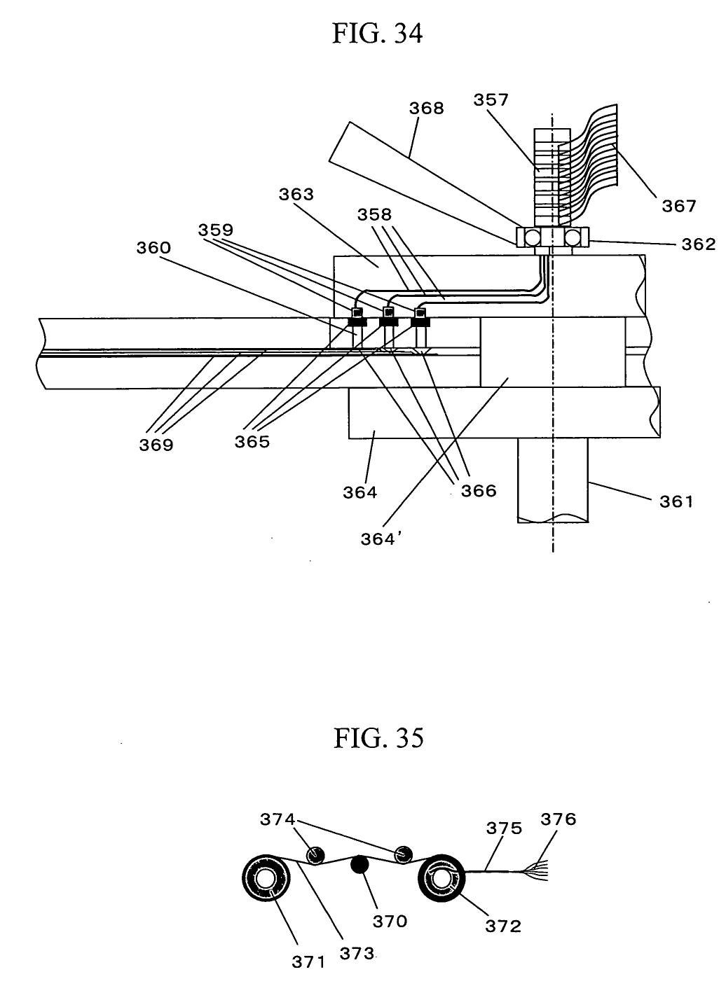

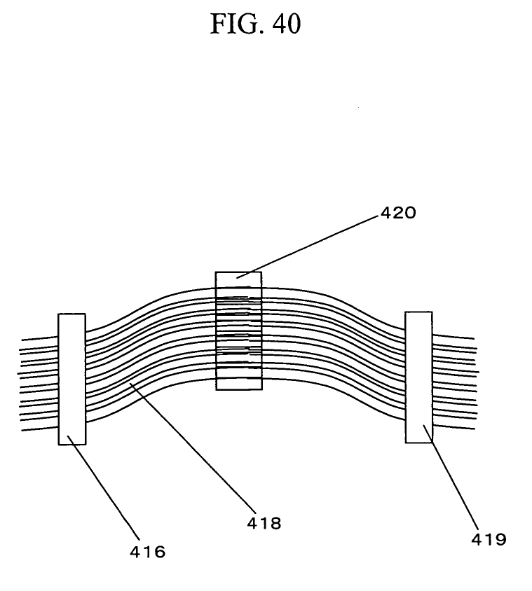

FIG. 34 is a drawing showing the structure taken of the multilayer disk record/read apparatus of the first embodiment of this invention. In this multilayer record/read apparatus, information is recorded by information imparted beforehand to the record medium in the shape of irregularities, or by energy such as light applied to the recording medium. This multilayer record/read apparatus includes a disk clamp means 363 for clamping the disk while the disk is rotating, and rotating along with the rotating shaft, and clamped to the drive apparatus by an arm 368 possessing a spring force via the rotation holding mechanism 362 such as a ball bearing, and the disk clamping means connects electrically to the stationary section of the drive apparatus by way of a rotation holding mechanism such as a ball bearing or a slip ring voltage conveyor mechanism 357, 367, (367 is a belt-shaped brush set) separate from the slip ring voltage conveyor mechanism; and a spring internal pin 359 installed to correspond to the concentric electrode of the disk formed in the clamping means; and a means (wire) 358 for connecting electrically with the electrode corresponding to the rotation holding mechanism such as a ball bearing or each section of the slip ring; and a means for controlling contact with the concentric electrodes of the disk so as to move the disk clamp towards the disk to make contact when the disk is inserted into the disk drive. Each of the concentric electrodes on the disk may further be separated into multiple arcs along the circumference. In FIG. 34, the reference numeral 360 is a metal pin formed on a section of at least one of the substrates to connect through the substrate and 361 is a rotating shaft. The disk is set on the disk receiving section 364, 364′. The reference numeral 366 is conductive materials and 365 is concentric electrodes and 369 is transparent electrodes. In FIG. 34, drawing multiple electrodes in the vicinity of the disk clamp might prove difficult to understand so only three electrodes are drawn here. FIG. 40 is a side view drawing of the slip ring.

The respective concentric electrodes may be subdivided into multiple wedge-shaped metallic electrode pieces driven in to install them. The recording medium (disk) is two disks attached together, and on at least one of the substrates, multiple metallic pins connect through and connect to multiple electrodes formed on the substrate. Also, the inner diameter of one of the disks is smaller than the inner diameter of the other disk, and the concentric electrode may be exposed on the disk with the smaller inner diameter on the section where the difference in inner diameters (appears). However, in this case the conductive material is preferably coated on or attached so as to bolster the electrodes on the substrate.

In this recording medium for recording information by imparting information beforehand to the record medium in the shape of irregularities, or by way of energy such as light applied to the recording medium; the recording medium is two sets or more of laminations of electrochromic material layers between two transparent or semitransparent electrodes. The recording medium is static, and the power supply and the electrode on the recording medium side may be connected by way of a connector possessing multiple internal contact points inside the inner section of an insulated cover.

### Eighth Embodiment

(Composition, Fabrication Method)

Polytheophene material was utilized as the electrochromic material. The layer of polytheophene material specifically contains approximately 80 percent by volume of the product name Baytron P by the H. C. Starck Company, the main chemical in the remaining section was t-butyl alcohol, and other elements include a small quantity of boundary-activated NS210, polyvinyl alcohol, 3-GPTM″ (3-glycidoxypropyltrimethylsilane) liquids that were coated on in a layer, heated and dried. The main ingredients of the solid electrolyte material were PMMA (polymethylmetacrylate) and lithium trifluorosulfate and this electrolyte material also contained in small quantities, prophylene carbonate, ethylene carbonate, acetonitrile, cyclohexanon and the ultraviolet light curing resin H-9 made by Hitachi Kasei. These were applied as a coating, subjected to UV irradiation, heated and dried. The solid electrolyte layer was formed by coating, so the film thickness was thin on the land sections of the substrate, and thick on the group sections. The electrochromic material generates a color when a voltage is applied across the upper and lower electrodes. A polyanyline material (inductive element) was used when utilizing a blue laser at a wavelength in the vicinity of 405 nm.

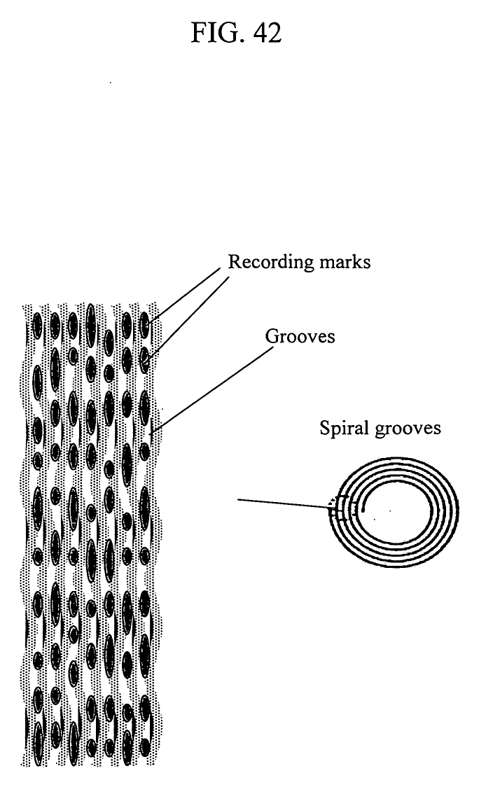

The medium is fabricated as shown next. A polycarbonate substrate was first of all formed with tracking grooves (width 0.615 um) of a depth of approximately 70 nm for land-group recording at a pitch of 0.615 um on the surface with a diameter of 12 cm and thickness of 0.6 mm. One track revolution is subdivided into multiple sectors and the beginning of each sector holds a header section expressing the address and synchronization signal in a pit string, as well as a clock expressing the groove wobble. The substrate is largely the same as the DVD-RAM substrate. Utilizing this substrate will not always prove ideal, and a substrate formatted so it is not so vulnerable to effects even when interlayer crosstalk occurs is even more preferable. One example of such a substrate is the sample servo format substrate. An overall flat view of the groove is shown in FIG. 42.

As shown in FIG. 29, an Ag₉₄Pd₄Cu₂ semitransparent reflective layer 62 with a film thickness of 20 nm was applied to the polycarbonate substrate 301, followed by an ITO transparent electrode 303 of 100 nm, an electrochromic material layer 304 of 100 nm, a solid electrolyte layer 305 of 100 nm, a WO₃ protective layer (spacer layer) 306 of 50 nm, and an ITO transparent electrode 307 of 100 nm; followed repeatedly in the same way in the sequence of an electrochromic material layer, solid electrolyte layer, WO₃ protective layer, ITO transparent electrode; electrochromic material layer, solid electrolyte layer, WO₃ protective layer, ITO transparent electrode; electrochromic material layer, solid electrolyte layer, WO₃ protective layer, ITO transparent electrode, electrochromic material layer, solid electrolyte layer, WO₃ protective layer, ITO transparent electrodes in a total of five recording layers enclosed on both sides by ITO transparent electrodes. During the forming of the films, the inner circumference of the mask was enlarged in the sequence of transparent electrode, each layer between the next transparent electrode, and transparent electrode, so that each transparent electrode was exposed on the disk inner circumference. Each layer on a transparent electrode and the transparent electrode above that layer may be formed in the same mask shape. Moreover, a 0.6 mm thick polycarbonate substrate with an outer diameter of 120 mm and inner diameter of approximately 41 mm on the outer circumferential surface; and with electrodes from front to rear, and an outer diameter of 41 mm and an inner diameter of 15 mm on the inner circumferential surface, was laid over these layers. Light was input from the attached substrate side. The substrates comprised of the inner circumferential substrate and the outer circumferential substrate may be integrated into one polycarbonate substrate.

The ITO transparent electrode was formed by reactive sputtering and the WO₃ protective layer by vacuum deposition. The vacuum deposition protects this lower layer from ion impacts during sputtering if the lower layer is made of organic material and, prevents oxygen from leaching away from the organic film to produce an (unwanted) high resistance layer. The deterioration in characteristics (properties) speeds up when ion impacts are sustained. A WO₃ layer with a thin film (about 30 nm) is preferable for light transmittance. The ITO transparent electrode can be formed by electron beam vapor deposition, laser vapor deposition (method for vapor depositing and film forming by irradiating a high power laser on the target and also called the PLD method). In this case the forming of a WO₃ layer thinner than 50 nm as a protective layer can be omitted. However, the ITO film formed by vacuum deposition becomes slightly lower than the sputtered ITO film in terms of transmittance and conduction. The purpose of this protection is to allow use of a transparent conductive inorganic film that can be formed by vacuum deposition or coating, instead of using WO₃.

The WO₃ protective layer may be utilized not only as a protective layer but also as a light reflective layer for autofocus and/or tracking and/or readout rather than a protective layer. When utilized as a light reflective layer, it need not be added to all recording layers and may be formed every other layer or every two layers etc., or each of a multiple number of layers. This layer is preferably added to layers where irregularities such as grooves were transferred. In this case, the servo signal is acquired from the light reflective layer where the laser beam was focused, and the read signal is acquired from the same or another layer where a beam was focused. These beams may also be a single beam.

The interval from transparent electrode to transparent electrode was approximately 0.4 μm. This interval is required on surfaces in order to protect from changes in the recording state due to heat dispersing to adjacent layers within a range of 0.1 μm or more. A range within 15 μm is necessary in order to prevent optical problems such as aberrations or impact interference onto the lens substrate from occurring. A range of 0.2 μm or more, and 2 μm or less is even more preferable. If the interval is less than 0.4 μm, the laser apparatus gap does not widen, and optical problems will not occur even if a one-chip array laser is used without any changes. Also, steps corresponding to the layer intervals on the disk can be formed in the array laser for each apparatus, to make the laser apparatus completely parallel to the disk.

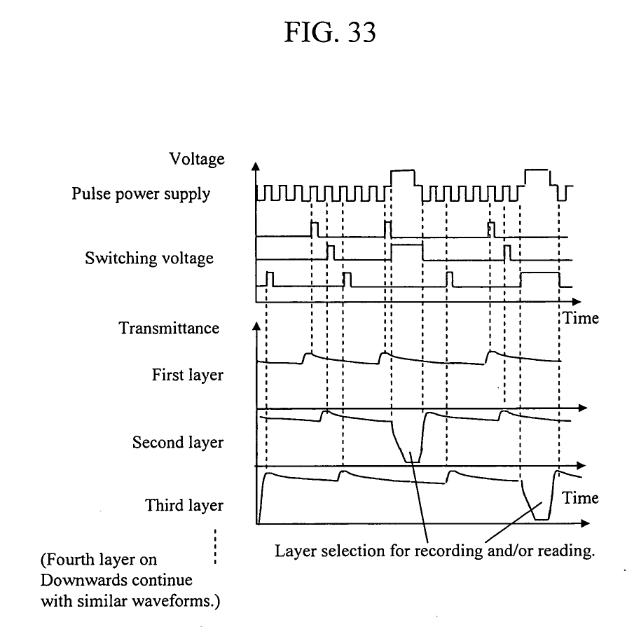

Voltage was also applied to each layer from a separate power supply for each layer however performing as follows, allows reducing the number of power supplies and also lowering the electrical power consumption. In other words, as shown in FIG. 33, the voltage can also be applied by means of pulsed negative voltage (solid electrolyte material side is the minus side) applied at intervals to each layer from a single power supply. When selecting the record/read layer, apply a voltage just as in this sequence, or even if in a different sequence, apply the positive voltage over just the necessary time width for record/read and, then return in sequence to applying a negative voltage at intervals from the next layer after record or read is finished, or from the next layer that is supposed to be applied with a negative voltage. The natural color speed is slow when the voltage is removed so an average high transmittance rate can be maintained even by applying a negative voltage at intervals. FIG. 9 is a timing diagram showing another method for applying a voltage at intervals to each layer from a single power supply per the multilayer disk of this invention. If a layer structure or a material for rapid decoloring within five seconds is utilized, and the voltage on the recording layer was removed, then no application of a periodic negative voltage is necessary.

The recording layers may be formed in a three layer structure comprised of one more layer added on top of the solid electrolyte layer. In the case of a three layer structure, a 150 nm layer of IrOx or NiOx (x is a positive integer less than 1) serving as an oxidant colorant first coloring layer, a 300 nm layer of Ta₂O₅ as the solid electrolyte layer, and a 200 nm layer of WO₃ as the deoxidizer colorant type second coloring layer may for example be utilized as the three layers. In the case of a two layer structure, a two layer structure made up for example of a 200 nm OH ion storage layer made comprised of Cr₂O₃, and a 200 nm coloring material layer comprised of IrOx may be utilized. A metallic electrode such as W—Ti may be utilized instead of the transparent electrode farthest from the light input side. When forming the electrochromic material layer by coating, the grooves are embedded a little at a time by the laminations, and the land section is closer than the groove section in terms of electrode distance on both sides of the record layer. The electrolyte layer is a layer for stable holding of positive ions such as hydrogen, lithium, sodium and magnesium internally and is a shifted layer.

Organic material such as oligomers or polymers of theophene type organic material are preferably used as the material for the electrochromic layer. Conductive organic material is particularly preferable. The laser wavelength was set at 660 nm when using for example, a theophone polymer such as Baytron P(polyethylenedioxytheophene). The theophone polymer (aggregate) is formed by coating or vacuum vapor deposition or electrosynthesis. In electrosynthesis, poly(3-methyltheophene) is utilized as the theophene derivative, LiBF₄ as the supporting electrolyte, and benzonitrile as the solvent. If polyaniline is utilized, then a large read signal can be obtained with a blue (wavelength in vicinity of 400 nm) laser.

The composition of the recording layer of this embodiment is two layers of electron-activating conductive polymer coloring material made up of a mixed material comprised of Li trifluorate (formal name of Li trifluorometanesulfonate: CF₃SO₃Li) in acrylic type curing resin, with a solid electrolyte layer of material mixed with a plasticizer; and a layer of PEDT/PSS or in other words poly(3,4 etylenedioxythiophene) and poly(stylene sulfonate).

Other examples of layer structures include a material described as a coloring control window material in the paper; Electrochromic Window-based on conducting Poly (3,4-ethylenedioxythiophene)-Poly(styrene sulfonate) by Helmut W. Heuer et. Al., in Advanced Function Materials vol. 12, No. 2 pp 89-94 (February 2002); and a three layer structure made up of electron-activating conductive polymer coloring material comprised of a mixed material of an ion storage/dark current block layer made of (CeO₂)₆₇ (TiO₂)₃₃, an electrolyte layer of Li trifluorate (formal name of Li trifluorometanesulfonate: CF₃SO₃Li), and a layer of PEDT/PSS or in other words poly(3,4 etylenedioxythiophene) and poly(stylene sulfonate). More preferable is adding any of a cyano-base (—Nc), thiol-base (—SH), S-acetyl base (—SAc) prior to forming the theophene type polymer layer. The theophene polymer should be arrayed as much as possible longitudinally towards the direction of the film thickness to make the electrical current flow more easily in the direction of film thickness. Polyethylene oxide theocyanate potassium is also preferable as the organic electrolyte layer.

When a polymer theophene type polymer material comprised of Star-branched poly (3,4-ethylenedioxychiophene-didodecyloxybenzene) (abbreviated to SPEB) as described in the paper; Electrochromic Linear and Star-Branched Poly (3,4-ethylenedioxychiophene-didodecyloxybenzene) Polymers by Fei Wang et. al. in Micromolecules vol. 33 pp 2083-2091 (2000), is utilized instead of the PEDT/PSS layer, fast coloring and decoloring, and favorable characteristics can be obtained. The above described electrolyte material is utilized as the electrolyte material.

When an inductive or a semi-conductive layer formed from transparent oxides is installed between a solid electrolyte material and electrochromic material layer, it fulfills the role of Li ions as a barrier layer and, the Li ions are captured by the electrochromic layer and cannot return to the solid electrolyte layer side so that a cause of repeating coloring/decoloring deterioration can be suppressed. A layer for example of chromium oxide in a thickness of about 10 to 50 nm is preferable.

The electrolyte layer and the electron-activating conductive polymer coloring material layer can be formed into one layer by electrosynthesis of a theophene polymer layer and adding a dopant for example of Li trifluorate. The dopant level may be changed between layers to establish a differential in the direction of layer thickness.

The advantage of utilizing the organic material layers described up to now is that they are conductive, and that their electrical conduction becomes higher as the temperature rises. Also, these layers impart photoconductivity so that the photocarriers are accelerated by the electrical field, the coloring is hastened by the rise in temperature so that the recording sensitivity can be improved, and unlike WO₃ does not require the passage of moisture in and out of the material for coloring and decoloring. In the coloring process, positive charge from electrons combining with molecules extinguishes the polaron and the energy differential versus the excited state brings about a state equivalent to the visible light energy. Ions such as Li ions, and hydrogen ions (protons) shift to assist this electron movement. A monomer, or a micromolecular quantity of just a dozen linked molecules may be subjected to high-speed vacuum vapor deposition, and oligomers and polymers formed on the substrate. The molecules are set to an excited state by irradiating them with an electron beam, ions, blue or near-infrared light to form oligomers and polymers on the substrate. Besides the theophene polymer (abbreviated to polytheophene), also usable are metallic phtalocyanine such as Lu-di phtalocyanine, heptylviologent, tungsten oxalic acid complex, styryl compounds of 3,3 dimethyl-2-(P-dimethylamino styryl) indorino[2,1-b]oxazorin (IRPDM) (light source wavelength 5145nm) or 3,3 dimethyl-2-(P-dimethylaminocinnamylidinevinyl) indorino[2,1-b]oxazorin; and laminated film of polyaniline and poli(2-acrylamidemethane-2-propansulfonic acid) (abbreviated to PANPS) for blue laser recording/readout (described in the lecture paper by D. DeLongchamp and P. T. Hammond in Advanced Materials Vol. 3, No. 19, 1455(2001)). Moreover, a layer of TCNQ (7,7,8,8-Tetracyanoquinodimethane) may be formed for a photoconduction effect. Utilization of these organic materials was implemented in the same way as the above embodiment for other sections of the disk.

Other materials capable of being used instead of WO3 as the inorganic electrochromic material include (metal) Prussian blue (KₓFe^{II}yFe^{III}z (CN)₆, as a cyanidated compound, MoO₃, Nb₂O₅, V₂O₅, TiO₂, NiOOH, CoOOH, Rh₂O₃, IrOx (x is a positive integer less than 1), ZrNCl, InN, SnN, (x is a positive integer less than 1), MnOx (x is a positive integer less than 2), and WO₃—MoO₃ composite (mixed) thin films may be used as the electrochromic material. These materials may be utilized instead of the protective layer of WO₃.

When inorganic materials are used in the electrochromic material, then both the organic materials already described in the solid electrolytic material, and the inorganic materials described next can be used. However using inorganic material provides the advantage that all processes can be performed by the dry method (vacuum) process such as sputtering, vacuum deposition and electron beam deposition for forming film for all layers. Sputtering is particularly preferable because of high reproducibility in film forming. Any of the following laminated films for example can be utilized in a structure enclosed by transparent or semitransparent electrodes. These are WO₃—Ta₂O₅—IrOx, WO₃—Cr2O₃, WO₃—MgF₂, WO₃—RbAg₄I₅, WO₃—SiO, WO₃—ZrO₂, WO₃—LiClO₄, WO₃—LiF, WO₃—Na₃Zr₂Si₂PO₁₂ (NASICON) WO₃—NaYSi₄O₁₂, etc. These are described in text “Organic Electrochromic Materials, Current Status—Base Technology & Research Strategies” on pages 85 to 86, first printing-first edition Aug. 30, 1986 by Yoshio Taniguchi Editor, Science Forum Co., Ltd. Among these, material containing Ta₂O₅ was used by was reported in “Electrochromic Displays” 1991 published by the SangyoTosho Corporation and by Noriyoshi Baba, et. al. on pages 168 through 186. A portion or all of these WO₃ may be substituted in the above described inorganic materials with MO₃, etc.

Besides the voltage conveyance path in the structure of this invention, use of all of the laminated films comprised of organic materials may also be applied to multilayer optical disk apparatus that selects layers by voltage.

In the electrochromic material, when positive ions such as metal or hydrogen or Li move from the specified location due to electrical current, and almost all of the electrons in a base state within the light spot are excited, the light absorbance automatically drops and the electrical current does not tend to flow. Therefore the flow of a large electrical current within the overall disk, and excessive electrical current flowing within the light spot irradiation section that makes the recording mark too large is prevented. In other words, as a phenomenon where light is irradiated while a voltage is applied across the first and the second electrodes, the electrical current in the vicinity of the irradiated location increases and a voltage continues to be applied even after light irradiation has stopped, the electrical current then reduces after a fixed amount of time and changes in the state of the recording film (electrochromic layer, etc.) were observed. The electrical current may sometimes drop automatically during light irradiation.

If the electrochromic material is a material whose absorbance or light reflection spectrum is changed by a voltage then it need not be a material referred to currently as electrochromic material. A small disk or recording medium can be fabricated even if a monocrystalline material. However, in a state with little reflectance, the light absorption used is 10 percent or less and more preferably five percent or less.

A mixed material comprised of electroluminescent (EL) material and photochromic material may also be utilized instead of electrochromic material. The light emitted from the EL material changes the color of the photochromic material, and causes light absorbance on the recording or the read light wavelength to occur. Inorganic material such as ZnO or organic material can be utilized as EL material. Among organic materials, the organic EL materials described for example in the commentary in the Toyoda Chuo Research Laboratory R&D Review Vol. 33 No. 2 (June 1998) on pp. 3-22, report material combinations adaptable to light wavelengths at which the color of photochromic material such as fulgide or diarylethane is changed. Layers of these organic materials can be formed by methods such as vacuum vapor deposition, gas phase extension, and coating, etc. In the case of the coating method, the solvent was thoroughly diluted so that the differences in film thickness would not become overly large in sections between grooves and the groove sections. The organic EL material is comprised of an electron or hole carrier material and light emitting layer material and, doping material when improving the efficiency is desired. Star-burst amine (m-MTDATA) film of 60 nm thickness of star-shaped molecules of triphelamine may be utilized as hole carrier material, and benzo-oxazole Zn complex (Zn(BOX)2) with a film thickness of 40 nm may be utilized as the light emitting material for emitting blue light. This emitted light is preferably blocked by transparent or semitransparent electrodes to prevent it from reaching other layers.

Fulgide or diarylethane may be utilized for example as the photochromic material. In the case of fulgide, absorption occurs in the vicinity of a 500 nm wavelength due to irradiation by blue light so recording can be performed with a 514.5 nm wavelength Kr laser can be performed.

An overcoat layer was formed of ultraviolet light curing resin on top of the laminated film and, attached onto another same single disk.

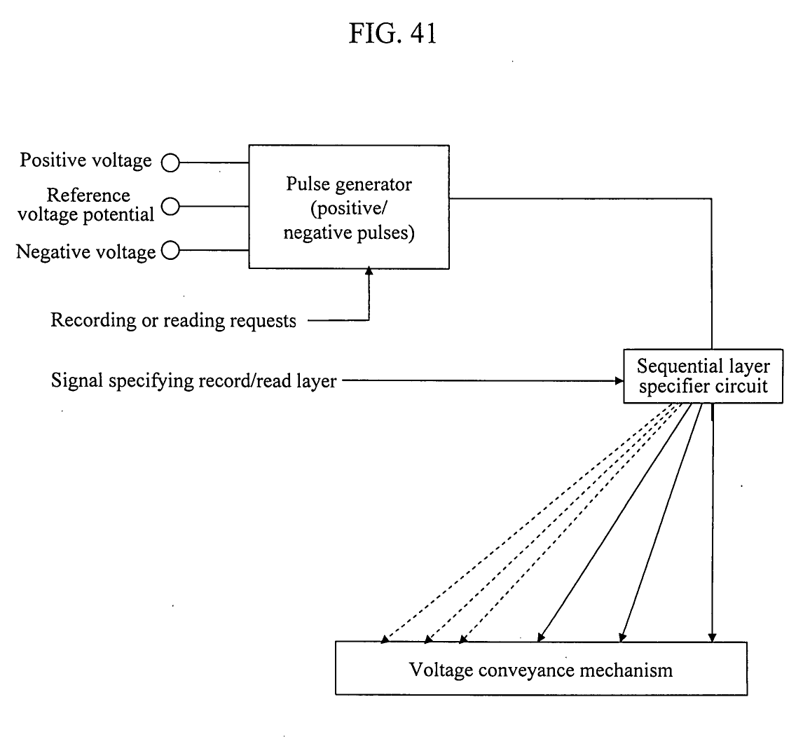

When a voltage is applied to the transparent electrodes on both sides of the recording layer where recording or reading is to performed as shown in FIG. 7, while irradiating a layer with a laser at a 660 nm wavelength, only the layer is colored, the laser light absorbed and reflected so that the information is selectively recorded or read. FIG. 41 is a block diagram of the switching circuit for applying a voltage to the desired recording layer. The voltage is not limited to being applied to only one recording layer, and when simultaneously recording on multiple recording layers with an array laser, a voltage can be applied across multiple pairs of electrodes. When utilizing a four-element array laser for example for simultaneous recording, a data transfer speed increase of nearly four times was achieved. When using the array laser to record simultaneously on multiple record layers, the voltage can be applied simultaneously to across multiple pairs of electrodes or sequentially at intervals in the coloring direction. Also, a finite value can be applied as a voltage across the recording layer electrodes rather than a zero voltage, so that a long or delayed coloring time can be prevented by improving the response speed of the material for coloring and the capacity across the electrodes.

Setting the thickness from the transparent electrode to transparent electrode of a layer, to approximately the thickness at the focal point depth of the focusing electrode, to emit color the more the light coefficient increases the farther into the layers, will prove favorable for high density recording by shifting the focal point position towards the layer thickness. Also, making each layer thinner will prove effective for volume hologram recording, etc. Multi-value recording may also be performed by making the light absorption coefficient approximately the same for each layer and thinning the layers and recording deep into the layers with high powered irradiation, and recording only on layers near the light input side with low powered irradiation.

A reverse voltage was applied when decoloring. Changing the distribution of the light absorbance coefficient of each layer during recording and reading is also a characteristic of this invention. Changing the voltage application time to each layer and the electrochromic material concentration of each layer so that the absorbance rate measured in a single layer will become larger 20%, 30%, 40%, 50%, the farther from the light input side, and so that the rate will be uniform at 20% in any layer during read, will prove favorable since information in each layer will be uniformly contained in the arriving light reflected by the Ag—Pd—Cu reflective layer.

The time required for coloring and decoloring can be shortened if the all the layers are separated into several groups, and for example in this embodiment, separating four layers into two groups each and simultaneously coloring and decoloring the electrochromic layers of the same group. Even more favorable recording characteristics can be obtained by adjusting the voltage or and adjusting the amount of dilution of the acrylic polymers in the electrochromic material so that the light absorbance rate in the same group becomes higher the farther the layer is from the light input side.

Another method effective for preventing the time needed for coloring and decoloring from limiting the record/read speed is to cause coloring sequentially from the inner layers as seen from the light input side, and causing decoloring in sequence from the outer (closer) layers. By using this method, the preparation for coloring can be started by applying a voltage to adjacent layers during coloring of the first layer, so that the process can be speeded up. Also, due to the surface resistance of the transparent electrode, the coloring and decoloring occur sequentially from the drawn-out electrode (in this embodiment, the inner circumferential side) of the disk and by utilizing this sequential coloring/decoloring, or separating the disk radially into multiple zones and subdividing the transparent electrodes into those zones, when for example recording consecutive moving images, the standby (waiting) time can be shortened for example by carrying out the coloring or decoloring in approximate synchronization with the progress of the recording. In this case, an insulating layer between the transparent electrodes of each zone is required.

Recording was performed by utilizing the effect of a laser light, and/or applying an electrical current to make the film lose its electrochromic function, so no coloring occurs even if a voltage is applied, or by making it possess an absorbance spectrum different from that prior to recording. Conversely, recording may be performed by making the coloring stronger. However, when the voltage was set to zero or a reverse voltage was applied, then it becomes optically the same state as the non-recorded section so the recording must be rendered invisible to the eye.

Rewriting may be possible to achieve when recording so as to cause a phase change in the electrochromic layer or the solid electrolyte layer, between the crystallized—amorphous state, or the crystallized—crystallized state. If the coloring or decoloring speed due to the phase can be varied by one digit figure or more, then read out can be achieved, if set to read out just the colored region of whichever phase after applying the voltage. If an inorganic material such as WO₃ is utilized, the amorphous state will prove better for making the positive ions easier to move, and the speed will be faster.

In another method, recording is performed by causing a physical change (phase change, etc.) by heat or electrical current, or a chemical change (for example, a reaction with Li ions) to cause a change in at least one of either the refraction or the extinction coefficient of an organic or an inorganic film laminated with other layers, so that recording may be performed due to the layer change. For example utilizing a film comprised of In₅₀Se₄₅TI₅ as the phase-change recording film yields a high transmittance rate for light at wavelengths of 780 nm or 660 nm and particularly at wavelengths of 780 nm. The electrochromic material layer is heated indirectly by light absorbance during recording. Though differing somewhat according to the material, the electrochromic layer possesses photoconductance so that a heating effect occurs due to the electrical current from the photocarriers. If phase-change recording film was formed, then a phase change to crystallization or an amorphous state occurs in the phase-change recording film. The phase-change recording film possesses a high refraction rate so that a transparent electrode layer film thickness rendering a reflection prevention effect may be selected to prevent reflections at the surface boundaries. By utilizing an optical design that makes changes in the refraction rate due to a phase change during coloring of the electrochromic layer easy to see in particular as a difference in reflection rates, each of the recording films in the multiple layers can be read out separately.

In yet another method, recording may be performed by placing a magnetic material whose magnetic orientation is changed by heat or electrical current and a magnetic field, as the recording layer in contact with adjacent electrochromic material or solid electrolyte material. A transparent opto-magnetic material such as garnet may for example be utilized in a design, so that the differential in the Carr rotation angle becomes larger as the temperature rises.

The optical film thickness from a transparent electrode to a transparent electrode is preferably set for one wavelength or an integer multiple of the read out light wavelength, since the optical value will then be equivalent on any recording layer.

(Another Example of a Transparent Electrode)

Already known transparent electrode material for example possessing a composition of (In₂O₃)×(SnO₂)₁₋ₓ, in material where x is in a range from 5 percent to 99 percent, or more preferably material where x is in a range from 90 percent to 98 percent in view of the surface resistance value, and SiO₂ is added at mole % within 50 percent to this material, or other oxides such as Sb₂O₃ are added at mole % from 2 to 5 percent to SnO₂ may be utilized.

Moreover, the transparent electrode between recording layers may be separated into two layers and a heat blocking layer formed between those two layers. A heat blocking layer of organic material is optically preferably for the same reasons as above. The heat blocking layer may be photoconductive but this is not preferable. Many materials can be used such as acrylic type polymers, oligomers, metal phtalocyanine as vacuum vapor deposition films. Inorganic material such as ZnS—SiO2 may also be used. Besides these, a conductive organic material film whose absorption edge changes due to a rise in heat from electrical current or a preheating laser beam may also be utilized.

In small recording media where a large sheet resistance is not a significant problem, the transparent electrode may be formed from a conductive polymer such as polyacetylene or polytheophene. In that case, the refraction rate differential with the electrochromic layer is small compared to the inorganic transparent electrode, and is preferable from the point of view of avoiding adverse effects such as from light reflecting from boundaries. A thin layer of copper-based elements (Cu, Ag, Au) averaging 0.5 to 3 nm or a hydrophobic surface processing agent or silane coupling solvent may be formed as the under layer.

(Other Examples of Substrates)

The present embodiment utilizes a polycarbonate substrate 77 including a tracking groove formed directly on the surface. However, a substrate possessing a tracking groove, is a substrate possessing a groove with a depth of λ/15n (n is the refraction rate of the substrate material) or more, when λ is the recording and reading wavelength on a section or the entire surface of the substrate. The groove may be formed consecutively on the circumference or may be subdivided along the circumference. One can see that in view of the tracking and noise balance, the groove depth is preferably set to approximately λ/12n. That groove depth may also be changed according to the location. Even on substrates using a format that records-reads on both the grooves and the lands, a sample servo format substrate formed at intervals with tracking servo marks may be utilized even for substrates formatted for recording on both or either the lands or grooves. On the type that records only on grooves, and on which the track pitch possesses an NA for the wavelength/focusing lens in the vicinity of 0.7 times, then the groove width is preferably set in the vicinity of one-half of that groove width.

Spacers layers with a thickness from 1 to 40 μm may enclose a certain number of layers within the multilayer information (recording) layers (For example, these spacer layers that match the number of beams, or number of beams minus the number of spare irradiation beams, at every five layers are particularly preferable.). Irregularity patterns containing at least one of either the tracking grooves or pits may be transferred to the spacer layer from a nickel stamper, and may be utilized in detecting tracking signals and addresses, clock and synchronization signals, etc.

When record-read light is to be irradiated from the side where the substrate was attached, then that attached substrate may be thinned to approximately 0.1 mm, and the focusing lens enlarged to an NA of 0.85. These dimensions will allow reducing the track pitch to approximately three-fourths its original size.

When forming a separate photoconductive layer, if this photoconductive layer (metal layer or transparent electrode layer) is formed as an extremely thin layer, then reliability during repetitive rewriting can be increased since the mutual diffusion-reaction between the recording layer and photoconductive layer is suppressed. However an average (uniform) film thickness of 1 nm or more and 10 nm or less is required to allow photocarriers in the photoconductive layer to escape. Even striped or net shaped non-consecutive film may be utilized. An electrode layer for example of Al or W₈₀Ti₂₀ with a thickness of 5 nm for example may be installed between the recording film and the photoconductive layer. Forming the Al layer by vacuum vapor deposition after forming the recording film and before forming the transparent electrode by sputtering, will prove effective for protecting the organic material from ion impacts.

The transparent electrodes on the recording region may be separated into one electrode or multiple fan-shaped electrode across the entire disk or separated into a concentric shape across the disk, or both methods may be used. The voltage can then be applied within the surface across these electrodes to cause the coloring. The capacitance across the electrodes is smaller when separated, so separation is preferable in view of the quick rise and fall of the voltage. A capacitance of 0.1 F or less across the electrodes is particularly preferable so that the electrical current and time needed for coloring and decoloring are in a practical range, however the component characteristics are satisfactory so that a structure with a capacitance of 0.01F or more may be utilized. One transparent electrode of the electrode pair may be separated, and the other transparent electrode not separated into multiple electrodes. Also, both electrodes may be separated above and below. In this case, the positions dividing the electrode above and below may match, but non-matching positions are also allowed. When forming the transparent electrodes on each layer, the inner circumferential masks were made slightly larger each time, so that each electrode was exposed concentrically on the inner circumference.

The inner diameter of each transparent electrode becomes slightly larger the farther it is from the substrate, and for example when the transparent electrode nearest the substrate is exposed in a ring shape on the inner side, and the voltage can be applied from that section. The transparent electrode above that section is exposed in a ring shape with a slightly larger diameter than that section. Forming a ring shaped metal section with a width slightly narrower (for example 90%) than the radius of that exposed section to improve the conductivity and mechanical strength will increase the manufacturing costs somewhat but will prove preferable particularly in terms of performance. In another method, drawn-out electrodes in a radiating shape are respectively installed on the innermost circumference, in a reflective layer/electrode and transparent electrode, and these drawn-out electrodes extend to the innermost circumference of the disk, and may be connected to multiple electrodes on the edge of the disk center holes, in order to connect to each of the separate electrodes on the disk rotating shaft in the record/read apparatus. A metal layer is preferably formed overlapped on this drawn out electrode, and transparent electrode on the inner circumference in a width of one to 5 mm radially on the immediate outer side (of that drawn out electrode) in order to lower the surface resistance. When the disk is loaded, each electrode on the disk receiving section on the rotating shaft makes contact with the drawn-out electrode on the disk side, or an electrode connected to that drawn-out electrode. When making contact with the electrode on the edge of the center hole, positioning along the disk rotation direction by combinations of concavities and protrusions is necessary for matching the corresponding electrodes for connection. A method for connecting to concentric metal electrodes formed on the surface of a substrate attached via electrodes formed through an attached substrate from concentric transparent electrodes is preferable because no positioning is required. However, even in the case of transparent electrodes in a radiating shape, if the position of the radiating shape electrodes, is aligned with the positioning and attachment (of a substrate) with electrodes passing through the attached substrate, and if the electrodes on the surface side (side facing external field after attachment) of the attached substrate are in a concentric shape, then there is no need for positioning when the disk is set in the drive apparatus.

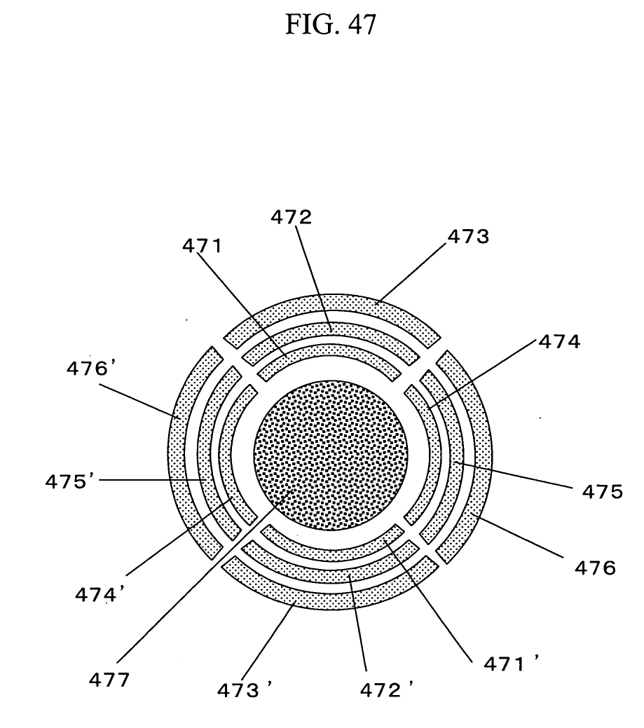

As shown in FIG. 30, metal pins (narrow metal cylinders, or metallic lines) 27 are formed through the inner circumferential surface of the attached substrate as with a printed circuit board, and concentric metal layers corresponding to the number of transparent electrodes are formed on both surfaces. The metal pins are connected to the corresponding electrodes on the front and rear side. On a conventional printed circuit board, plating (foil) for the metal wiring pattern, attached to the substrate side possessing a recording layer. In this case however, a conductive adhesive tape layer or a low melting point metal such as In, or a layer formed from an alloy is formed, and the conductive adhesive tape is a mixture of conductive material such as at least one from among metallic particles, carbon particles, or metal mesh with an adhesive solution. The In or low melting point alloy is soft and has a low melting point since it is used for compressing the faceplate of the imaging tube, and when pressed against a substrate containing a recording layer, it deforms and adheres to the transparent electrode. If compressed and the temperature is in the vicinity of 100 degrees, this alloy becomes softer and easily compresses. This type of disk structure allows making the electrical connections securely and with high reproducibility, reliability and uniformity. The concentric sections of the transparent electrodes drawn out from the disk inner circumference and the circumferential electrodes on the surface of the attached substrate need not always be in a circular (ring) shape, and may be subdivided into multiple electrodes towards the circumference. In this case, two electrodes corresponding to the pair of electrodes sandwiching the recording layer should be installed in positions along the inner/outer directions as shown in FIG. 47, so that a specified voltage will always be applied regardless of how the disk is installed onto the rotating shaft.

This disk is loaded into a disk drive the same as optical disk drives of the related art such as for a DVD-RAM, etc. However, a mechanism for conveying voltage to the disk however has been added. In the present embodiment, the mechanism for conveying the voltage was a ball bearing or a slip ring. A slip ring is a combination of short pieces of metal called a brush for the stationary side and a metal ring for the rotating shaft side. A conducting grease is used to convey electricity to the ball bearing. The voltage conveyor mechanism is installed on the side opposite the disk of the disk rotating motor, or outer side of the disk rotation motor (circumference), or the opposite side of the disk of the disk rotation motor.

As shown in FIG. 31, a conducting wire 331 installed from the voltage conveyor mechanism on the surface or interior of the disk rotating axis 331 towards the tip of the rotating shaft, is connected via the inner side, from the inner diameter near side of the tip of the rotating shaft to an electrode 325 corresponding to multiple disk electrodes on the tip of the rotating shaft. This electrode 325 is formed on the side of the flat or tubular or cone-shaped rotating shaft tip to intersect the center wire of the rotating shaft tip in the drawing, and may be a pin shape or a concentric circle shape or concentric tube shape or a concentric cone shape. A disk clamp 323 is clamped to the drive apparatus by a spring via a ball bearing, and clamps the disk and rotates along with the disk rotation. The disk clamp is made up of a small round plate and a ring on the outside of that plate. The small circular plate and ring are connected by a separate spring member at three locations separated by 120 degrees each. A pin electrode or a concentric electrode corresponding to a concentric electrode or a pin electrode for the rotating shaft top section are formed within the small circular plate. A pin electrode corresponding to the concentric circle shaped electrode on the surface of the substrate of the disk inner circumference is formed on the ring. The small circular plate and the ring may be one piece. If the small circular plate and ring are separate pieces then any one of the springs at the three locations every 120 degrees is connected to the conductive wire.

Power was supplied from the circuit board of the recording apparatus from a voltage conveyance mechanism made up of a combination of rings and multiple brush (named a slip ring), to each of the wires on the disk rotating shaft. The brush (simply oblong metal strips or a cluster of a large number of such strips) and ring section rotating shaft diameter (outer diameter of ring) was 13 mm. Wires from each ring extend upwards within the rotating shaft towards the disk receiving section. Six separate wires corresponding to up to five layers on the multilayer disk connect to the electrodes on the disk receiving section, by way of the vicinity of the rotating shaft surface of the disk rotation motor. When the disk is inserted into the disk drive, the disk clamp lowers from above (to clamp) the disk mounted in the disk loading section 324. First of all, the ring section depresses the disk inner circumference, and the corresponding electrodes make contact at this time. Next, the small circular plate raised slightly by the springs at three locations every 120 degrees, is pressed onto the top section of the rotating shaft and the corresponding electrodes make contact. The stationary electrodes within the drive and each electrode on the disk in this way make contact by way of the disk clamp. The small circular plate may also include a hole in the center section in a ring shape.

In the case of the brush and ring, the rotating shaft for that section is preferably made as narrow as possible and if the diameter is made 5 mm or less, and more preferably 3 mm or less and the line speed reduced to a small amount, then wear can be reduced and a long service life obtained. A diameter of 0.5 mm or more and 5 mm or less is preferable and, still more preferable is a diameter of 1 mm or more and 3 mm or less. If too thin, the mechanical strength is insufficient and the wear on the brush becomes even faster. If too thick, then the service life is less than one year due to wear. In this case, preferably a structure for supporting that section above and below (or left and right if installed horizontally) with a bearing is provided. A separate brush may be installed for each one electrode, here however, six pieces were grouped together with one spring plate. In this kind of grouping method, even a large number of electrodes such as approximately 50 electrodes may operate stably without mutual interference.

Ball bearings may be utilized instead of the brush and ring combination. However, miniaturizing them is difficult. The electrical conduction was improved by filling the ball bearings with a conductive grease as a mixture of metal particles such as carbon or Au, or Ag, etc. In the case of the brush and ring (slip ring) these are continually sliding during rotation of the disk rotating shaft during operation of the record and/or read apparatus so that a large quantity of powder is generated due to wear, and therefore the service life is poor. Therefore the ring and brush may be separated at all times except when sliding for the required recording or reading. Some coloring is possible even at a voltage of zero so that the ring and brush can be kept separated for at least part of the time during recording or reading. When the disk is inserted in the drive apparatus, the brush or brush group (thin tape state) may be positioned longitudinally in parallel with and separated slightly from the disk movement direction; and with the disk clamped in the specified position when recording/reading is necessary, at least one of either the brush group and the ring group may be made to move to make contact with the (other mating) group. Making the brush group and ring group come in contact is performed in the same way when coloring or decoloring is required. In the case that a pullout (tray) type disk drive section containing a motor and optical head such as in CD-ROM apparatus for notebook type personal computers has been drawn out, the brush group may be made to push on the ring to make contact when the tray is pressed inwards.

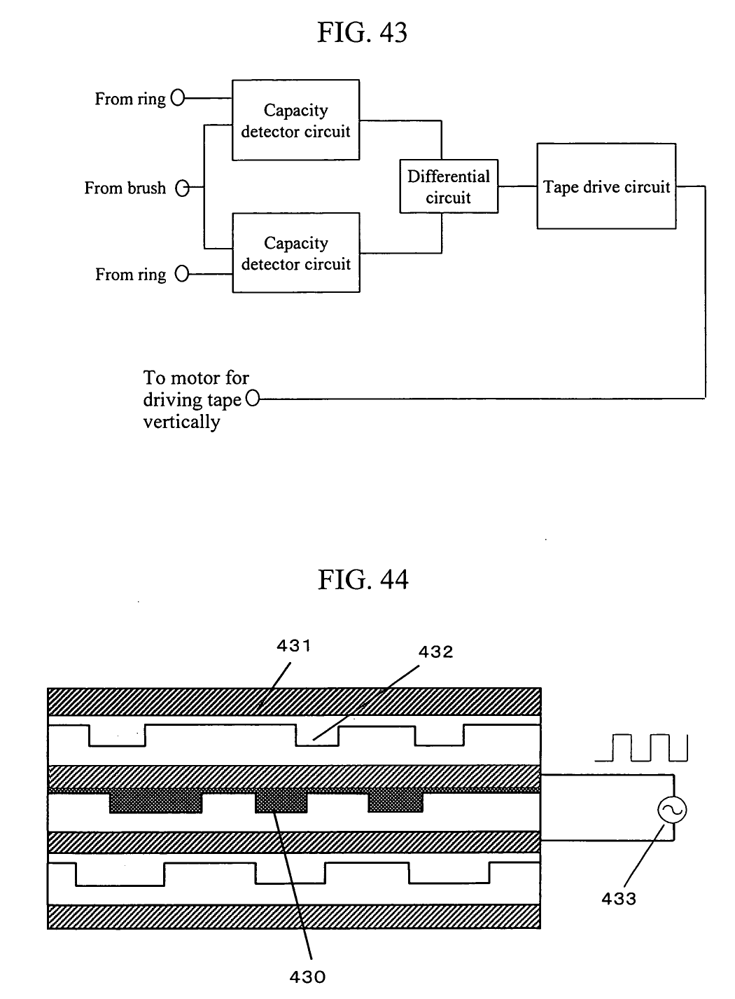

One or two rings at the end sections may preferably be utilized as position detectors for precisely aligning each ring position and corresponding flange when the brush group and ring group are meeting and separating in this way. As shown here in the block diagram of FIG. 43, a method was used fro sensing the static capacitance between the brush and ring and then applying a servo however other detection (sensing) methods of the known art may be utilized. When a position deviation is detected, a servo may be applied to move the brush perpendicular to the disk surface to correct the relative positions.

A long service life can be obtained by installing a control mechanism to change the contact position with the ring so that the brush pulls in or thrusts out a little at a time over the passage of time. As shown in FIG. 35, the brush group 373 is in a tape shape (or belt shape), and the service life can be further extended when the contact position with the ring 370 at a position equivalent to the magnetic head of a tape recorder is changed while the brush group is wound from one shaft 371 to another shaft 372 extremely slowly, or intermittently similar to the tape of a tape recorder. The reference numeral 374 is a capstan (roller) for depressing the tape-shaped brush group on the tubular-shaped laminated ring. When changing the contact position with the ring on the brush side in this way, the ring is preferably formed from wear-resistant metal such as tungsten or a wear-resistant metal of the known art, and the brush is preferably made from soft or easily worn metal or material such as silver, copper, or aluminum, etc. Also, the base material surface of the tape can be provided with adhesive properties, to suppress the spreading of powder from wear (parts wear) within the record-read apparatus when such particles might adhere to other surfaces. The tape need not utilize a base material, and narrow electrodes and narrow insulation material mutually bonded and laminated may be utilized. The other (take-up) shaft 372 contains a separate slip ring, and is supplied with voltage by way of the brush group 375. The brush group 373 may make contact with one of the capstans 374 rather than the (take-up) shaft. In this case, the electrodes are exposed on both sides of the tape as with the above laminated type and a laminated tubular electrode is installed on the capstan. In order to avoid the adverse effects from abrasive powder (powder from wear) on the rotating shaft from contact with the capstan, a capstan positioned to the rear of the tape feed may be utilized. A wire 376 is connected to each brush (oblong shaped electrode) to supply voltage from the pulse power supply. At least either the ring or the brush may contain a lubricant inside the tiny holes.

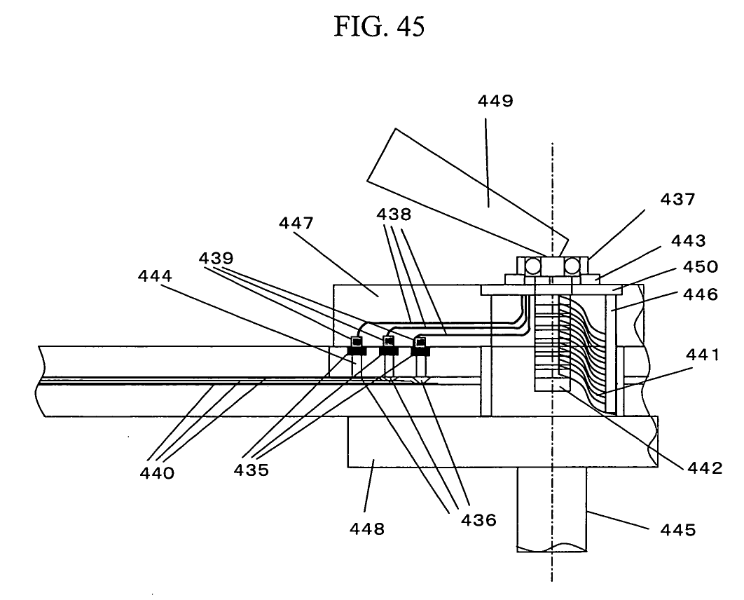

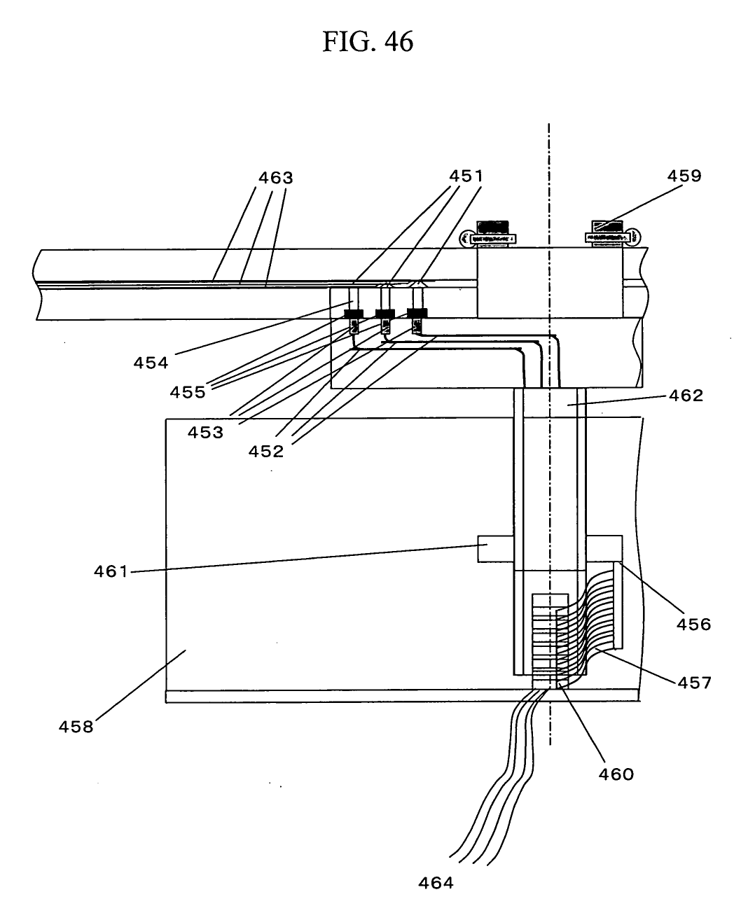

Combinations of brushes and rings as shown above, are effective in obtaining a long service life when utilizing other voltage-application optical disks, or when a voltage conveyor mechanism is installed on a position opposite the disk per the rotation motor structured as in FIG. 31, when installing it between the motor and disk receiving section, when utilizing a apparatus for conveying a voltage to for example, a brush/flange combination—rotating shaft—disk receiving section—disk in other record/read apparatus configurations. In other words, the voltage conveyor mechanism may be on the disk side of the rotating motor, or on the opposite side, or the arrangement as shown in FIG. 45. When on the opposite side as shown in FIG. 46, then it must be installed in the space below the motor.

In FIG. 45, the reference numeral 436 is conductive materials and 455 is concentric electrodes. The reference numeral 437 is a rotation holding mechanism such as a ball bearing. The reference numeral 438 is electric wires and 439 is metal pins with spring. The reference numeral 444 is a metal pin formed on a section of at least one of the substrates to connect through the substrate. The apparatus may be comprised of: a disk clamp means 447 for clamping the disk while the disk is rotating, and rotating along with the rotating shaft, and clamped to the drive apparatus by a spring 449 by way of a rotation holding mechanism 437 such as a ball bearing. The reference numeral 442 is a group of static cylindrical rings, 441 is a group of brush and 445 is a rotating shaft. The reference numeral 443 is a disk clamp means and 448 is a disk receiving section. The reference numeral 440 is transparent electrodes. The reference numeral 450 is ring shaped means for clamping a disk and conducting. The reference numeral 446 is pole shaped means for holding a group of brush and conducting. In FIG. 46, the reference numeral 451 is conductive materials and 435 is concentric electrodes. The reference numeral 452 is electric wires and 453 is metal pins with spring. The reference numeral 454 is a metal pin formed on a section of at least one of the substrates to connect through the substrate. The reference numeral 459 is a disk clamp means. The reference numeral 460 is a group of cylindrical rings, 457 is a group of brush and 462 is a rotating shaft. The reference numeral 463 is transparent electrodes. The reference numeral 456 is means for holding a group of brush and conducting. The reference numeral 458 is a cover of a motor. The reference numeral 461 is ring shaped means for holding and conducting. The reference numeral 464 is a group of wires for supplying electricity.

In summarizing the essential points of the recording medium sections; the recording medium is a medium for recording information by the irradiation of light, and a lamination of two or more layers is formed into a single structure of transparent or semitransparent electrodes sandwiching a layer (single or multiple layers) of material whose reflection spectrum or light absorbance changes at least by an application of a voltage, and the edge of an electrode drawn out from a transparent electrode, or transparent electrodes within the disk inner circumference is formed in a concentric shaper or a radiating shape, and moreover is characterized in that a separate substrate is attached over that structure. Multiple pins may be installed on a section of at least one of the substrates, turning around in the vicinity of the center hole of the substrate or connecting through the substrate and extending to the surface on the opposite side, and concentric shaped electrodes may be installed on the surface side of the applicable substrate. The respective concentric electrodes need not be continuously connected, and the multiple electrodes may be arrayed in respective circles. These multiple electrodes need not have the same voltage potential, and may be made to correspond to other transparent electrodes on the respective recording regions. Even more desirable is that the electrode material contains metal or carbon particles that may be coated or attached to the section in contact with electrodes on the drive apparatus side or electrodes for the mating (attached) substrate.

In an information recording apparatus as an adaptation of the first embodiment as shown in FIG. 32, information is recorded on the medium by imparting information beforehand to the record medium in the shape of irregularities, or applying energy such as light to the recording medium; and this apparatus may be comprised of: a conducting wire 340 connecting to the tip of the rotating shaft from the internal spring pin electrode 341 formed on the concentric circle of the disk receiving section, a means for connecting the conductive wire connecting to the tip of the rotating shaft, to the corresponding concentric shape or concentric tube shape or truncated conic tube shaped electrodes 349 corresponding to the number of electrodes on the disk, a means for making the multiple electrodes 347 on the apparatus side contact the rotating concentric tube or concentric truncated conic tube shaped electrodes corresponding to the number of disk electrodes, a disk clamping means 344 for clamping the disk during disk rotation and rotating along with the rotating shaft. The methods such as coloring control method and record method are the same as in the above examples. In this case, the voltage is conveyed to the stationary section of the drive to the vicinity of the disk clamp to the disk lower surface.

Six separate wires 340 (of which only three are shown) corresponding to a multilayer disk of up to five layers connecting through the internal section of the disk receiving section, are connected to the disk receiving section electrodes. Each wire is connected to a pin electrode positioned on the circumference of the concentric circle. Power was supplied from the circuit board of the recording apparatus from a voltage conveyance mechanism made up of a combination of rings and multiple brush (named a slip ring), to each of the wires on the disk rotating shaft. The brush (simply oblong metal strips or a cluster of a large number of such strips) and ring section rotating shaft diameter (outer diameter of ring) was 13 mm. The wires from each ring lowers within the rotating shaft towards the disk receiving section. The detailed information on the brush and the ring are the same as described above, and the method for winding the brush may be utilized. The multiple concentric on the disk electrodes may be arrayed on the respective circles and not continuously connected. These electrodes may be coated or attached with material containing metal or carbon particles.

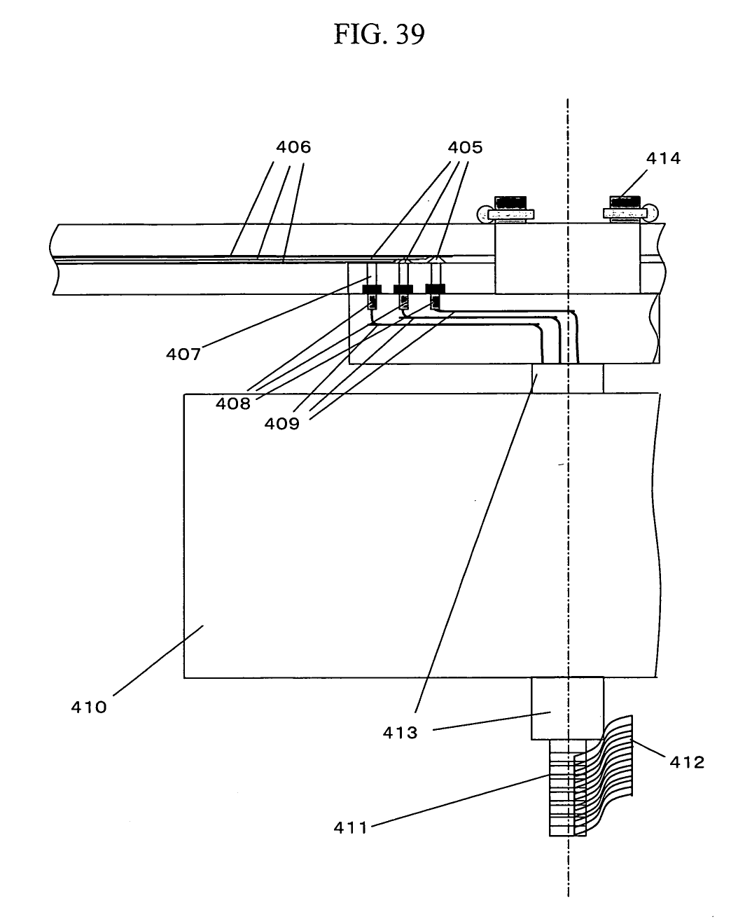

As shown in FIG. 39, in an adaptation of this embodiment, a voltage conveyor mechanism combining multiple brushes 412 and rings 411 is formed on the lower section of the motor 410 for driving the rotating shaft 413 and power may be supplied from circuit board of the recording apparatus. In FIG. 39, the reference numeral 409 is electric wires. The reference numeral 406 is transparent electrodes and 405 are conductive materials. The reference numeral 407 is a metal pin formed on a section of at least one of the substrates to connect through the substrate and 414 is a disk clamp means.

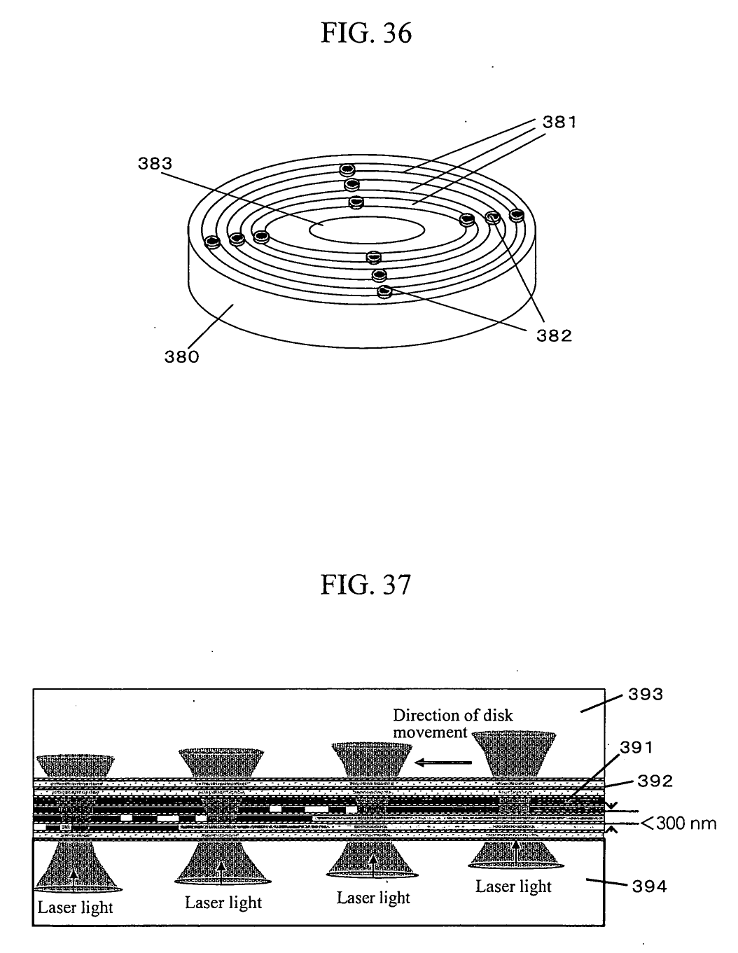

The example of the disk receiving section structure as shown in FIG. 36, includes a multiple internal spring pin electrodes installed on the concentric circles 381 installed on the disk receiving section 380, and a wire (or cable) made up of four conducting wires from each of the concentric shaped pin electrodes on the disk receiving section and connecting to rotating shaft tip 383. There may be four or fewer pin electrodes on one concentric circle and for example even one pin electrode is acceptable.

In an information recording apparatus as an adaptation of a separate embodiment as shown in FIG. 34, information is recorded on by imparting information beforehand to the record medium in the shape of irregularities, or applying energy such as light to the recording medium; and this apparatus may be comprised of: a disk clamp means 363 for clamping the disk while the disk is rotating, and rotating along with the rotating shaft, and clamped to the drive apparatus by a spring 368 by way of a rotation holding mechanism 362 such as a ball bearing; and the disk clamping means is electrically connected to the stationary section of the drive apparatus by way of a rotation holding mechanism 362 such as a ball bearing, and a concentric internal spring pin electrode 359 corresponding to the concentric electrode 365 of the disk set in the disk clamping means; and a means (conducting wire) 358 for electrically connecting to the concentric electrodes corresponding to each section on the rotation holding mechanism such as ball bearings; and a means for controlling contact with the concentric electrodes of the disk so as to move the disk clamp towards the disk to make contact when the disk is inserted into the disk drive. The methods such as coloring control method and record method are the same as in the above examples. The respective concentric electrodes may be subdivided into multiple wedge-shaped metallic electrode pieces driven in to install them. These electrodes may be coated or attached with material containing metal or carbon particles.

In this case, the voltage is conveyed from the stationary section of the drive to the disk damper to the upper side of the disk (in other words, the side opposite the disk rotation motor). Therefore the substrate for film forming is the disk side, in other words, the disk receiving side, and usually the optical head is positioned on the same side as the disk rotation motor so that in this case, recording and reading are performed directly through the substrate rather and not via the bonded layer. When forming all layers by sputtering or vacuum vapor deposition, the transferring of the groove shape to the upper layer is preferable since there is less effect from non-uniformities in the thickness of the adhesive or bonding agent.

When using inorganic material, the pattern of irregularities on the substrate is buried when a coating is applied so film is formed on the substrate on the disk clamping side and, rather than making the metallic pins (connecting through substrate) make contact with the transparent electrodes on the mating substrate, or their extended electrodes; those transparent electrodes, or their extended electrodes must be installed near the metallic pins (connecting through substrate), and the pin electrodes joined to the electrodes on the disk with electrical conducting paste, etc.

When the electrode placement in concentric circles shown in FIG. 47 is further subdivided into arcs, then preferably, the resistance value from the length of the drawn-out transparent electrodes or the static capacitance or the difference in focus error signals is detected on the drive apparatus side in order to determine which electrode of the disk loading section or disk clamping section was installed to correspond to electrodes in which layer on the disk. In FIG. 47, the reference numerals 471, 472, 473, 474, 475, 476, 471′, 472′, 473′, 474′, 475′ and 476 are the concentric electrodes subdivided.

Besides the position in FIG. 34 for the brush group and the ring group, the position shown in FIG. 35 placed inside the rotating shaft may be used. In this case, the cylinder of the ring group is clamped to the arm and static, and the brush group rotates with the rotating shaft. The voltage is conveyed from the stationary section of the drive to the ring group on one section of the disk damper to the flange group to the disk lower surface. Even when the voltage conveyor mechanism is in the lower section of the motor as shown in FIG. 39 and FIG. 46 a structure where the ring group is installed on the stationary side, and the flange group is installed on the rotating side.

The internal circumference of the disk may be a single plate structure and in this case, the disk clamp, or electrodes for the disk receiver may be made to directly contact the transparent electrode layer on the disk, or objects supporting it. When utilizing a substrate with a thickness from 1.0 mm to 1.2 mm as in the case of the Bluray disk, there is no problem with strength even if there is no 0.1 mm thick cover layer on the internal circumference section. The other substrate can be viewed as fulfilling the function of the 0.1 mm cover layer.

Besides the above described method for contact to make the electrical connection from the stationary section of the drive apparatus to the rotating section, a combination of light emitting diode and light sensor, or even a coil combination may be utilized. However, if the electrical current cannot be adequately supplied then multiple combinations must be installed, that will occupy a fixed amount of space within the drive apparatus.

In this invention, the concave sections on the substrate that are groove sections are referred to as grooves. The sections between grooves are called lands. When irradiating light onto film via the substrate, the grooves appears to be protrusions when viewed from the light input side. Therefore even in methods that irradiate light from the side opposite the substrate, the side with the protrusions as viewed in the same way from the light input side are also sometimes referred to as grooves. This section with protrusions when focusing only on the substrate, is a land section between one groove and another groove so this name is opposite the definition for this invention. When recording on either just lands or grooves, in the case of so-called in-groove recording, recording on protrusions as seen from the light input side in most cases provides good recording characteristics even when irradiating light from the substrate side or also from the side opposite the substrate side. However there is no significant difference so recording on concave sections as viewed from the light input side is also satisfactory.

Irradiating the record-read light from the attached substrate side is the standard method. The metallic reflective layer need not be installed on the substrate surface, rather a transfer layer of irregularities such as grooves may be formed on the uppermost surface, and if necessary a metallic reflective layer may be formed, and the laser light may be irradiated from the substrate side.

All the examples of the embodiments utilized disks, however a stationary recording medium that does not rotate may be used. In that case, the position of the laser light is changed. The electrode exposure at the concentric state stage, is the exposure at the linear stage state.

An information recording apparatus utilizing a static record medium is a apparatus for recording information on the medium by imparting information beforehand to the record medium in the shape of irregularities, or applying energy such as light to the recording medium; and this recording medium is two laminations or more between two electrodes for making the electrochromic material layer transparent or semitransparent. The recording medium is static, and the information recording apparatus may be characterized in that the power supply and the electrode on the record medium side are connected by a connector containing multiple metal contact points internally within the insulated cover.

(Recording-Erasure-Read)

Recording and reading of information was performed on the above recording medium. The operation for recording and reading this information is described next. The motor control method for record/read is first of all described utilizing the ZCLV (Zoned Constant Linear Velocity) method for changing the rotation speed (rpm) of the disk in a zone for carrying out recording. The ZCLV method was the optional method, since the effect from preheating, preliminary irradiation was uniform when utilizing the multi-laser beam described later. In this recording, the original digital signal is subjected to 8-16 modulation, and recording performed on a multi-pulse record waveform made up of pulses that become more numerous the longer the length of one recording mark.

(Multi-Beam Recording)

In this embodiment, on each light spot where the multi-beam is focused, the light ray including the laser installation angle is tilted, or the laser light emission positions are effectively differentiated to provide a focal point on each separate layer. Normal recording can in this way be performed on each recording medium. The light source of the multi-beam may be a separate (individual) laser or an array laser but an array laser with four or more beams is particularly preferable. Preferably, the focal point of any or one beam is aligned with the group or pit shapes arrayed on a layer, and the relative position is established versus another beam.

When utilizing a conventional phase-change slaved type four layer recording medium for four beam simultaneous recording, problems occur such as large gaps between layers in order to prevent crosstalk so that the light ray must contain a large tilt, focusing the light becomes difficult due to aberrations and the lens strikes the disk. For example, when the beam gap is 100 um in the case of a laser array, if the interlayer gap is 20 um then angle slope becomes ⅕. Also, making the thickness of the spacer layer that determines the interlayer gap at a uniform precision within 100 nm is extremely difficult and is a cause of focus deviations. Providing a step on the emission surface of each chip that corresponds to the interlayer gap is in general effective for making the disk surface and laser beam at right angles to each other, however forming a large step and obtaining high precision is impossible. Delays in recording speed might also occur with insufficient power or low recording sensitivity due to the light absorbance in each layer.

However the above problems with the phase-change recording medium can be resolved by using the voltage selection type multilayer record medium. First of all, if the interlayer gap is 0.1 um (100 nm) or less then the angle tilt will be sufficiently small for an irradiation beam gap (or spacing) of approximately 10 um. The layer interval here however was made 300 nm.

In this embodiment a conventional one chip array laser was utilized however each laser chip of the array laser may be detached and preferably a gap separated between the chips on the silicon substrate and bonded. The light spot gap or spacing (irradiation beam gap or spacing) is approximately ⅛th of the beam gap or spacing due to by the NA ratio of the collimator lens (NA of approximately 0.1) and focus lens, so that widening the laser element spacing is better for widening the spot spacing on the disk, the light beam input tilt can be reduced, and so that time can be saved for the preliminary heat coloring by means of the following described mechanism. However, when the gap (or spacing) is too wide and focusing with one lens, then problems occur such as aberrations in the beam on both ends. When the number of beam input to one lens is five beams, then at an NA of 0.85 the output beam gap is preferably 50 um or less, in order to sufficiently reduce aberration on the beam at both ends. In the vicinity of NA 0.6, a beam gap of 70 um or less is even more preferable. If aberrations appear from the effect of the tilted light input due to closing the beam gap (or spacing) then glass or quartz with steps may be installed at the laser beam output section to cause a difference in the optical path. In this invention, the step was approximately 40 um at about 100 times the thickness of a one layer portion, and the precision machining was easily accomplished.

On the voltage selection type multilayer record medium, recording can be achieved at least by light absorbance so that recording by coloring of layers matching the number of beams can be achieved. However for even higher speed recording, the control described next can be performed as shown in FIG. 37. In FIG. 37, the reference numeral 391 is an electrochromic material layer, the numeral 392 is a transparent electrode, and 394 is a substrate. First of all, applying a voltage to cause a thin coloring state on the innermost layer corresponding to the first beam on the disk allows auto focus and tracking, and sets a state where the recording status will not change even if irradiated with a laser beam. If setting a state where the recording does not change is difficult, then a dummy layer may be utilized. The first applied beam is this case is solely for continuous heating and there is no power modulation. The layers counting from this layer up to the number of beams are not completely within the focal point position however this is a range within a high power density so that a pulse voltage higher than during normal coloring can be applied, or application of a low voltage can start simultaneously with the first beam or slightly delayed, to cause a slight coloring from preliminary irradiation by the first (preceding beam). Preliminary irradiation speeds up the coloring on the recording medium and causes a sudden increase in the light absorption so that there is adequate light absorption when the layer second farthest from the inside is irradiated by the second beam. The recording track is in a spiral shape so if the second beam is positioned to strike the same position on the disk after a certain number of disk rotations after the first beam has been irradiated then the second beam can be irradiated in an adequately colored state, even when the recording medium requires some milliseconds of time to become sufficiently colored after the preliminary irradiation. After three rotations, there is a 0.1 second waiting period (More accurately, this is the inverse ×3 for the number of rotations within a 1 second period expressed in rps) so that if the material is colored in one second just by applying a voltage, then a layer will be sufficiently colored by preliminary irradiation that speeds up the coloring by one digit. In other words, a large effect is obtained if the direction along the outer circumference is set as the plus direction and the light spot position of the next beam versus the light spot position of the second beam is within plus-or-minus 3 tracks × the number of beams.

If there is too long of a wait for a large number of rotations, then the effect of the preliminary irradiation is lost, the beam spot gap becomes too large, the number of lasers striking the wafer decreases and the laser cost increases. However, if using a laser array with a pitch of 100 um, then a spot gap up to 20 um is possible. For example, if the track pitch is set to approximately 0.6 um, then a 33 track separation, or in words a 33 rotation wait is allowed. The same is true for the third and the fourth beams. Recording and reading is in this way performed to sufficiently color just the target layer. Recording is performed by causing a loss of the coloring function by heating a location through irradiation with a high powered laser.

Aside from using the effect from preliminary irradiation, the delay in coloring and decoloring from the inner circumference to the outer circumference due to surface resistance on the transparent electrode can be utilized. In this case, about one second is required for the coloring or decoloring front to move from the innermost circumference to the outermost circumference on a 120 mm diameter disk. Therefore, if the rotation speed for example is 30 rps, then the coloring or decoloring front will progress approximately mm in the period required for one rotation. A coloring voltage may be applied at intervals of every 1/50 th of a second in order to establish a differential between coloring and transparency among adjacent layers at a maximum light spot gap of 20 um at a point along the radius. When the number of layers is larger than the number of beams, then recording may be performed by jumping a number of layers proportional to the number of beams, to record or read on other layers.

The mechanism for accelerating the coloring by preliminary heating and/or preliminary irradiation is next described in slightly more detail. Explaining this mechanism requires a further description of coloring. Each recording layer is basically made up of two layers or three layers, and as shown in FIG. 8 the solid electrolyte layer and the electrochromic material fulfill the largest role in this mechanism. The solid electrolyte layer was initially an electrolyte fluid that was solidified and its functions are easier to consider if thought of as a liquid electrolytic material.

Polyethylenedioxytheophene molecules within the electrochromic layer of the polytheophene material are in a state attached to macromolecular aggregates of PSS (polystyrene sulfonate) in some locations. Though the Li within the electrolyte fluid are ionized to a positive charge, the polystyrene sulfonate molecules rob the polyethylenedioxytheophene molecules of their electrons and become negatively charged. A positive charge then occurs in the polyethylenedioxytheophene that forms polaron and biopolaron. The molecules formed by the polaron and biopolaron are almost completely lost through visible light absorption. When a voltage is applied that makes the electrode on the electrolyte fluid side positive, and the electrode on the electrochromic layer negative, the Li ions within the electrolyte fluid move to the electrchromic layer side and gather on the surface layer. A portion of the Li ions are supplied into the electrochromic layer. Electrons are injected from the electrode on the electrochromic layer side so that the electron concentration becomes high within the electrochromic layer, and the electrons bond with the positively charged polyethylenedioxytheophene molecules. Coloring is in this way made to occur. A portion of the electrons captured in the PSS are attracted by the Li ions towards the electrolyte liquid.

In this coloring process, light is irradiated and photocarriers generated. Moreover, the conductivity rate for hopping conduction increases when the temperature in the electrochromic layer rises. The electron injection then speeds up drastically, and electrons are also generated as photocarriers so that the coloring is greatly accelerated. Preliminary irradiation by means of an advance beam utilizes this phenomenon. If a material possesses hopping conductivity, or semiconducting type conduction, or photoconduction characteristics then the same effects can be obtained with materials other than used in this embodiment. Most inorganic electrochromic materials are the semiconducting type and are also photoconductive.

Even in cases where the rise in color changing speed is inadequate due to a rise in conductivity caused by photocarriers and a rise in temperature, the change in absorption edge due to a rise in temperature can be utilized as another effect of preliminary irradiation. Both of these effects may be utilized. Usually when the temperature rises, the organic macromolecules cannot maintain their planarity, and three-dimensional deformations occur averaged over time, so that the light absorption edge (limit) shifts in many cases. Even with this effect, the coloring or the decoloring accelerates due to the pre-heating effect. The change in absorption edge (limit) due to the rise in temperature often shifts towards the increase in transmittance in the visible range. The probability of being present within the base state decreases, and absorption declines as the planarity of the polymer molecules is lost, and molecules whose absorption has declined due to the discharge of electrons become more numerous than in the reverse case. When the effect from an increase in transmittance while the temperature is rising, is greater than other effects, then the preliminary irradiation beam may be positioned on the first (nearest) light input side, and the focal point of the following beams aligned on the inner layers in sequence. This type of positioning also allows utilizing the effect that the transmittance on the recording mark section rises due to the recording, and the average amount of light transmitting through the inner layers increases. The difference in speed in the above processes is an entire digit figure faster than when compared to Li ion movement so that a vast increase in coloring and decoloring speed can be achieved. Other than preheating, photochemical or physical effects may also be utilized to achieve this high speed coloring.

Conversely when utilizing a recording medium with properties where the decoloring due to heating becomes faster, the focal point of the first beam is aligned on the nearest (outer) layer, and the decoloring of the first inner layer starts. Even when decoloring starts, the coloring is still dark when the second beam strikes, so that recording and reading are easily performed. However when the third beam strikes, decoloring is performed so as not to interfere with recording or reading of the second inner layer. For example, a phenomenon where absorption weakens due to absorption saturation may be utilized.

In order to obtain the pre-heating effect, an array laser is used to generate multiple largely parallel laser beams from multiple light emitting sources (lasers) arrayed in approximately a straight line. However, other methods for placement in a straight line such as utilizing the silicon-monocrystalline cleavage surface, or even separating the laser apparatuss, and widening the spacing (gap) may be utilized.

A first laser beam is irradiated onto a first spot on the first layer and, after irradiating the first light spot on the first layer, a light spot is positioned so that a second light spot is illuminated on the second layer on the light input side adjacent to the first layer, and information is recorded or read. When the light spot formed on each layer of the multi-information layer from the multiple laser beams is controlled or positioned so that adjacent beams are on the same track along the radius of the substrate, or within plus-or-minus the number of beams ×3 tracks, then the preliminary irradiation effect is obtained. However, when the position deviated outside this range, then the preliminary irradiation effect was insufficient for recording or reading without affecting other layers. If the position is within plus-or-minus one track, then this method has the merit that writing can begin simultaneously from the outermost circumferential track or the innermost circumferential track.

Arraying many laser beams spots circumferentially along the same track or adjacent tracks is preferable because confirming the address is simple, and also because none of the beams will deviate from the track outermost or innermost circumference. A means must be provided for detecting position deviations by detecting tracking error signals or track address signals of at least two laser beams near both ends from among the multiple laser beams.

To prevent damage to the recording status from occurring on layer where a preheated spot is irradiated, the multi-information layer medium preferably includes a dedicated layer for focusing-tracking of the preheating-preliminary beam that is capable of coloring and raising the reflectivity rate by applying a voltage, and yet does not record information within a specified period (or interval).

A semiconductor laser array on a light wavelength of 660 nm is utilized as the laser beam for recording information in the optical head housed inside this recording apparatus. Recording of information was performed by focusing the laser light through an objective lens of NA 0.65 onto the disk to irradiate the recording layers. Rather than a laser array, beams from two or more separate lasers may be applied to the specified position.

Accelerating the coloring and decoloring by a preceding beam in this way is not limited to the case of parallel high-speed record-read, and is also effective when starting to record or read a short time after selecting the layer. Using two beams comprised of the preceding (advance) beam and a record-read beam; or using one beam to pre-irradiate at one to three rotations of the disk, and then recording or reading at the next one rotation can also be performed. Then, the decoloring can be accelerated by reversing the voltage and irradiating one time with DC light.

The recording medium of this embodiment yielded a light reflectivity contrast rate of approximately 2:1 between the recording mark and the other sections. If the contrast rate falls any lower than 2:1, then the jitter or flutter due to noise from the read signal exceeds 9 percent of the upper threshold value, deviating from the range of effective read signal quality. When made to contain SiO₂, the transparent electrode content then became (SiO₂)₄₀ (In₂O₃)₅₅ (SnO₂)₅, the refraction rate then decreased, superior optical results were obtained, and a contrast rate of 2.5:1 was achieved.

When recording was performed on electrochromic material layer or a separately formed chalcogenide layer of amorphous material, then erasure was performed by lowering the applied voltage, and crystallizing the amorphous material by continuous irradiation by laser. Erasure may also be performed by irradiation with a pulse laser and generating repetitive erase pulses wider than any recording pulse.

Reading of the recorded information was also performed by utilizing the optical head. The layer to be read was colored by preheating the same as during recording, and the laser beam irradiated onto the recorded marks, and a read signal obtained by detecting the reflected light from the mark and sections other than the mark.

In the case of multiple beams, the focal point position of each beam not always be on separate layers, and for example, recording and reading may be performed on the same layer with two beams each. The method for utilizing multiple beams in this embodiment is also effective on voltage selection type optical disk apparatuss other than the apparatus structures of this invention.

In the case of multiple beams, the read signal of each beam that was subjected to a multiplexing means (synthesizing means) can be restored into one time-based signal.

If each of the multiple read beams is irradiated as a time-based high speed pulse then arraying it along a time base is simple. The amplitude of this read signal is increased in a preamplifier circuit and converted at each 16 bits to 8 bits of information in the 8-16 demodulator. The reading of the recorded marks is completed by means of this operation. When performing mark edge recording under the above conditions, the mark length of the 3T mark which is the shortest mark is approximately 0.4 um. The recording signal includes a start edge for the information signal, and repetitive dummy data of 4T marks and 4T spaces in the end edge. The start edge includes a VFO. Other signal modulation methods other than 8-16 can of course also be utilized.

### Ninth Embodiment

In the ninth embodiment, the relation between the applied voltage and reflectivity rate and record-read signal is described.

(Structure of the Medium)

The specific structure of the information medium of this invention is described next. A first electrode layer, an electrochromic layer, an electrolyte layer, and a second transparent electrode films are formed in that sequence on a substrate possessing a tracking groove; and if necessary is optically or thermally laminated into two sets of layers enclosed by spacers between two sets of transparent electrodes. The electrochromic layer and electrolyte layer may be laminated in reverse order.

(Recording-Erasure-Read)

Utilizing the recording medium of this invention allows performing both tracking and auto-focus on any layer so that multilayer recording and reading can be performed with an optical head utilizing one laser. Recording or reading is performed with just the target layer adequately colored in this way. Recording was performed by irradiating a section with a high powered laser to make just that section lose its coloring function due to heat, or to delay the coloring.

In recording, a laser light and/or electrical current is applied to make the film lose its electrochromic function, and no coloring occurs even if a voltage is applied, or the film is made to possess an absorption spectrum different from the spectrum prior to recording. Conversely, recording may also be performed by intensifying the coloring, however when the voltage was set to zero or a reverse voltage was applied, the state (of the film) becomes optically the same state as the non-recorded section so the recording must be rendered invisible to the eye.

(Reflectivity Characteristics)

The reflectivity of the record section and the reflectivity of the colored and decolored state during application of a voltage were investigated utilizing this medium.

On a recording medium including an information surface, the light input side of the information surface is defined as the Lx layer, and the farthest inward information surface is defined as the L0 layer. Here, interlayer cross talk is greatest when coloring and reading the L0 layer in a state where a signal is recorded on the Lx layer. Unlike the multilayer medium of the related art possessing a large distance between layers as disclosed in the patent document 3, on a layer selective type multilayer medium, multiple layers are present within the focal point depth of the focusing lens, the transmittance per one information surface layer is large, so that reducing interlayer crosstalk is important.

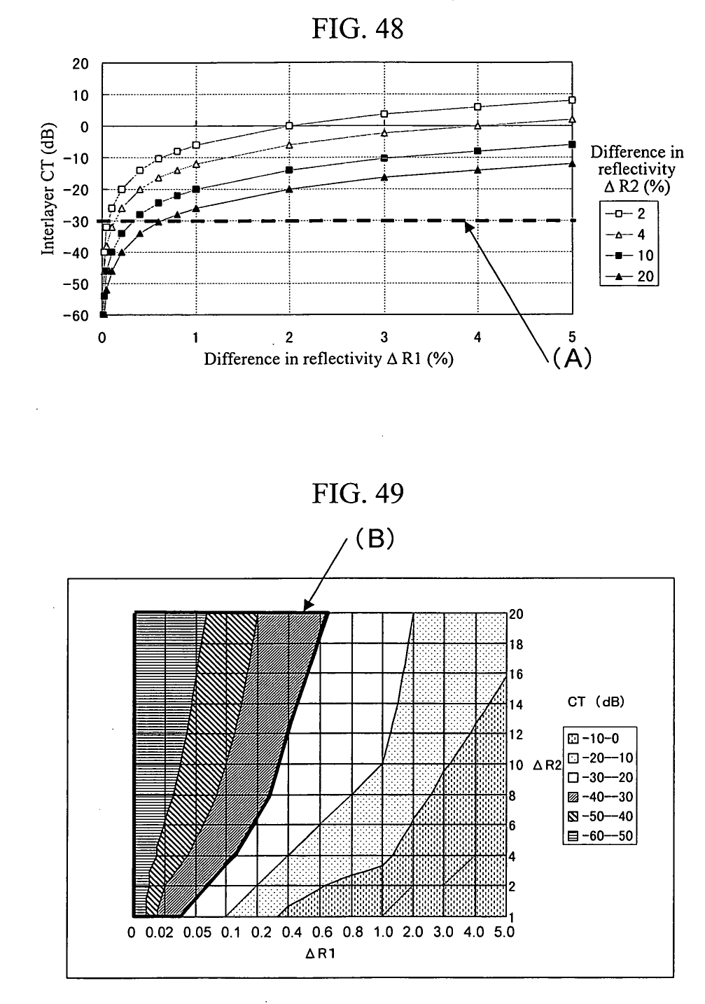

When the crosstalk was investigated while varying the colored state reflectivity Rc and the decoloring state reflectivity Re, and the recording section reflectivity Rm and utilizing a medium where the information surface is five layers, the results as shown in FIG. 48 and FIG. 49 were obtained. The same results were obtained even in mediums with other than five layers. In a range where signal leakage in the Lx layer was sufficiently small, the region where the crosstalk was below −30 dB was in the section lower than (A) in FIG. 48, and in the region enclosed by (B) in FIG. 49. In other words, if the reflectivity conditions shown in Formula 1 were satisfied then the effect of interlayer crosstalk was not at a level causing any actual problems.

When the crosstalk was greater than −30 dB, the effect of interlayer crosstalk caused the jitter to become worse, increasing one percent or more.
(Re−Rm)/(Rc−Rm)<0.03 (1)

However, the formulas (2) and (3) must be satisfied in order to achieve stable focus on the information surface.
Re<Rc (2)
Rm<Rc (3)

Here, a voltage may be applied so that the colored state Rc, or the decolored state Re satisfies the above formulas (1), (2), and (3), and recording performed at a recording power to achieve a reflectivity rate Rm in the recording section.

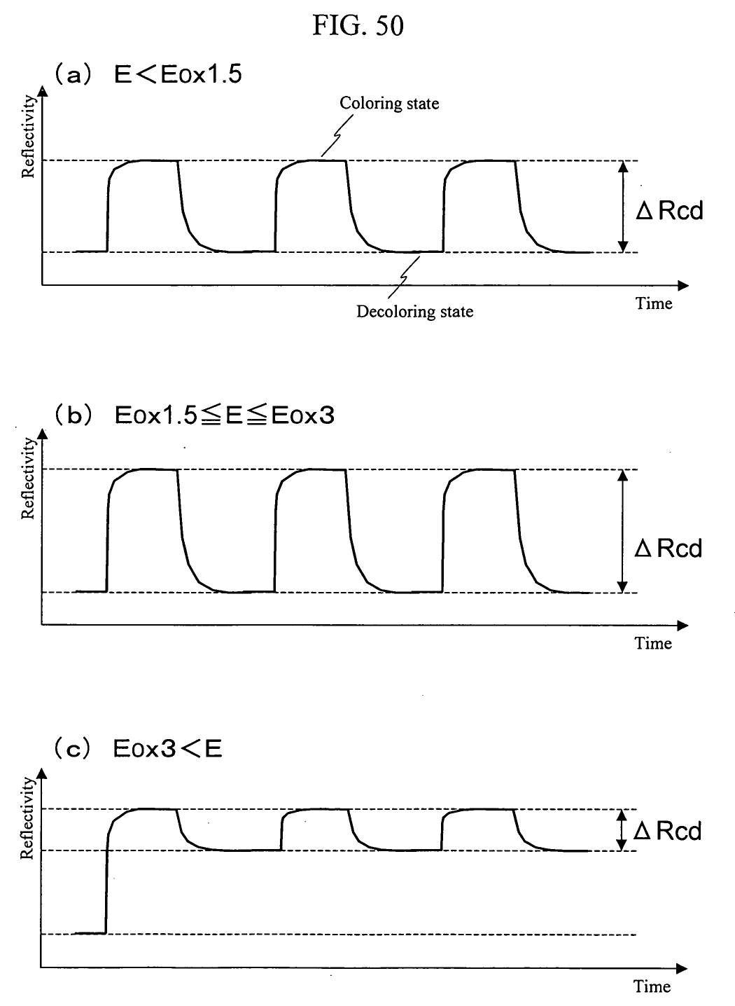

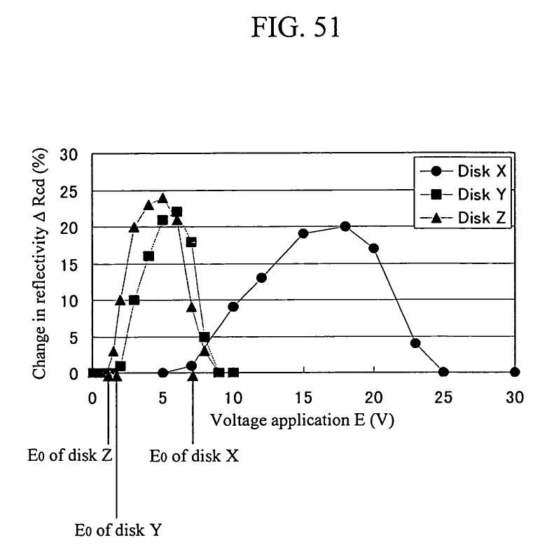

Results from investigating changes in the applied voltage and the reflectivity are shown in FIG. 50 and FIG. 51. When the applied voltage E shown in (a) of FIG. 50 is low, then the reflectivity Rcd of the coloring state and decoloring state is small. However when the applied voltage E is an appropriate value as shown in (b), then the reflectivity Rcd is sufficiently large. When the applied voltage E is too large, then a complete decoloring state cannot be returned to from a coloring state as shown in (c) so that the reflectivity Rcd becomes too small. Results from investigating changes in the applied voltage and the reflectivity for three types of mediums (Disks X, Y, Z) are shown in Tables 1 through 3 in FIG. 51. The Es is a voltage value where a change in the reflectivity starts to occur. On disk X, an 80 nm layer of WO₃ in electrochromic material, and a 420 nm layer of Ta₂O₅ in the electrolyte material was formed. On disk Y, the two layers made up of an 80 nm layer of WO₃ in electrochromic material at 80 nm, and a 50 nm layer of IrOx in electrochromic material were formed on both sides of the 140 nm thick electrolyte material Ta₂O₅. Disk Z was the same material as Disk X, but was different in that the thickness of the electrolytic material was 140 nm.

TABLE 1

| Applied voltage E (V) | Change in reflectivity Rcd (%) |
|---|---|
| 0 | 0 |
| 5 | 0 |
| 7 | 1 |
| 10 | 9 |
| 12 | 13 |
| 15 | 19 |
| 18 | 20 |
| 20 | 17 |
| 23 | 4 |
| 25 | 0 |
| 30 | 0 |

TABLE 2

| Applied voltage E (V) | Change in reflectivity Rcd (%) |
|---|---|
| 0 | 0 |
| 0.5 | 0 |
| 1 | 0 |
| 1.5 | 3 |
| 2 | 10 |
| 3 | 20 |
| 4 | 23 |
| 5 | 24 |
| 6 | 21 |
| 7 | 9 |
| 8 | 3 |
| 9 | 0 |
| 10 | 0 |

TABLE 3

| Applied voltage E (V) | Change in reflectivity Rcd (%) |
|---|---|
| 0 | 0 |
| 0.5 | 0 |
| 1 | 0 |
| 1.5 | 0 |
| 2 | 1 |
| 3 | 10 |
| 4 | 16 |
| 5 | 21 |
| 6 | 22 |
| 7 | 18 |
| 8 | 5 |
| 9 | 0 |
| 10 | 0 |

Results from investigating the film structure for the three types of disk (Disk X, Disk Y, Disk Z) showed that if the voltage is applied within a range of:
Ex×1.5≦E≦Ex×3.0 (4)

then, the differential in reflectivity becomes larger, and a large repetitive change can be made to occur. Therefore, satisfying the above Formula 4 is sufficient when selecting layers by applying a voltage. Information on zero (0) and/or the preferred voltage range is preferably recorded on the medium or the record/read drive, however the information may also be found when inserting the medium in the drive.

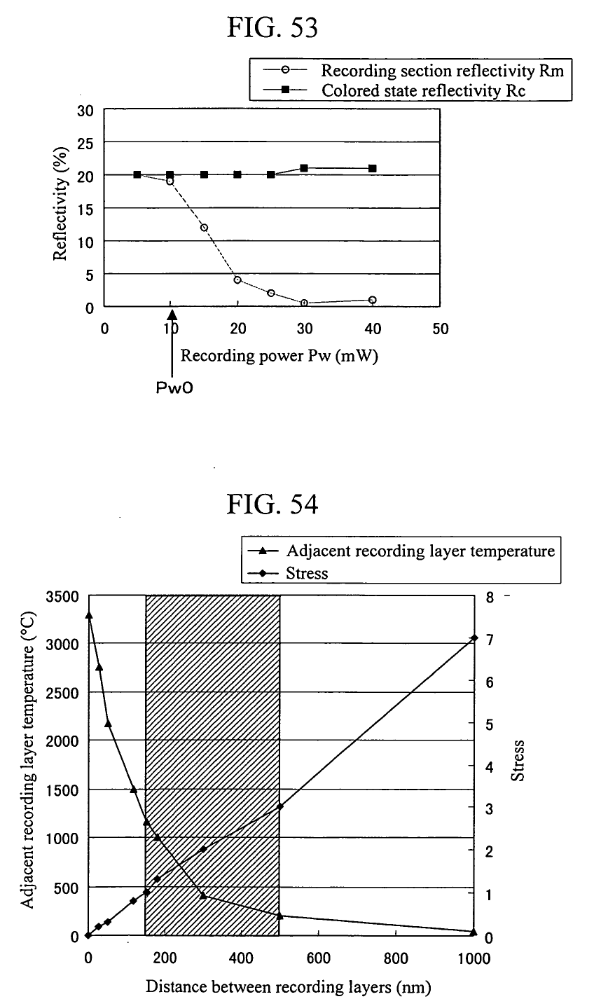

Results from investigating the change in the reflectivity and the record power Pw during recording are shown in Table 4 in FIG. 53. The contrast rate Mod was calculated according to Formula (4). Here, Rm is the record section reflectivity, and Rc is the reflectivity in the colored state.
Mod=(Rc—Rm)/Rc×100(%) (5)

TABLE 4

| | Record section | Colored state | |
|---|---|---|---|
| Record power | reflectivity | reflectivity | Contrast rate |
| (mW) | (%) | (%) | (%) |
| 5 | 20 | 20 | 0 |
| 10 | 19 | 20 | 5 |
| 15 | 12 | 20 | 40 |
| 20 | 4 | 20 | 80 |
| 25 | 2 | 20 | 90 |
| 30 | 0.5 | 21 | 98 |
| 40 | 1 | 21 | 95 |

When the record power Pw was low the reflectivity in the record section was inadequate, the differential in reflectivity (rates) was small, and the signal amplitude was also small. When the record power was appropriate, the reflectivity was sufficiently large, and a satisfactory signal amplitude could be obtained.

It was found that preferably the Pw is Pw 0×2 or more, and the contrast rate is 75%. Even more preferably the Pw is Pw0×2.5 or higher for a contrast rate of 90%.
PwO×2.0≦Pw (6)

Here, the PwO is 10 mW.

Information on the PwO and/or the preferred recording power range is preferably recorded on the medium or on the record/read drive, however the information may also be found when inserting the medium in the drive.

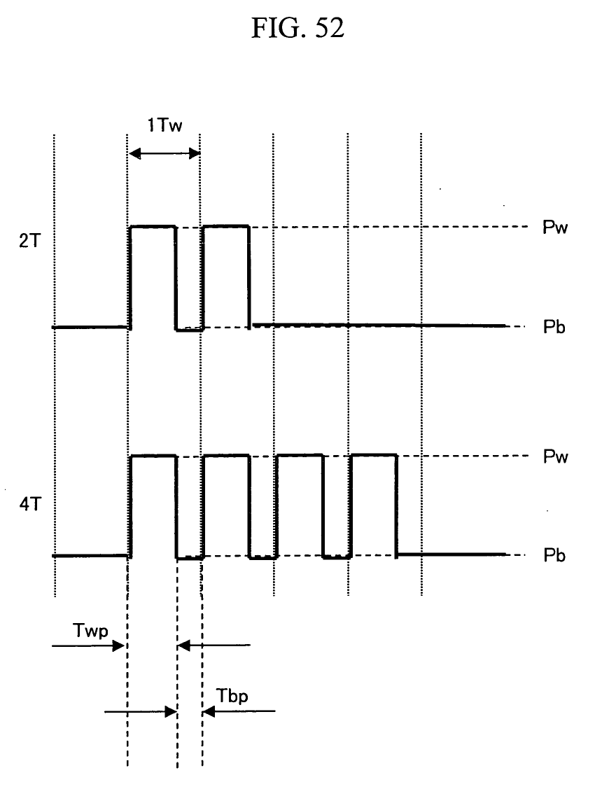

A binary recording waveform as shown in FIG. 52 was utilized here. The level of the bottom Pb was the same or higher than the read light level. The pulse width Twp of the Pw level is preferably higher than the pulse width Tbp of the bottom level from the point of view of recording sensitivity. The pulse width ratio is adjusted along with the record mark shape but the Tbp may be zero (0) if the line speed during recording is fast. The medium structure, material, manufacturing method, recording method, read method and apparatuss not described for this embodiment, are the same as in the first through eighth embodiments, and the tenth through fourteenth embodiments.

### Tenth Embodiment

(Method for Forming the Medium)

The medium is fabricated as shown next. A polycarbonate substrate with a diameter of 12 cm and thickness of 0.6 mm was first of all formed with tracking grooves (width 0.615 um) at a depth of approximately 70 nm for land-group recording at a tracking pitch of 0.615 um on the surface of that substrate. One track revolution was subdivided into multiple sectors and the beginning of each sector holds a header section expressing the address and synchronization signal in a pit string, as well as a clock expressing the groove wobble. The substrate is largely the same as the DVD-RAM substrate. Utilizing this substrate will not always prove ideal and a DVD+RW substrate or a HD-DVD substrate or a sample servo format substrate may be utilized.

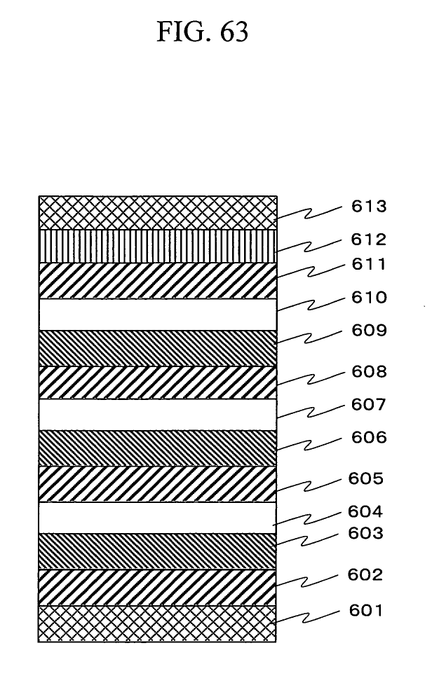

As shown in FIG. 63, first of all an ITO (In—Sn—O) electrode layer 602 was formed in a film thickness of 100 nm on a polycarbonate substrate 601, followed by an ITO transparent electrode 603 of 80 nm made from WO₃, s solid electrolyte layer 604 of 140 nm thickness made from Ta₂O₅, an ITO (In—Sn—O) transparent electrode 605 of 100 nm thickness. These were followed repeatedly in the same way in the sequence of an electrochromic material layer 606, solid electrolyte layer 607, an electrode layer 608, an electrochromic material layer 609, an electrolyte layer 610, an electrode layer 611, in a total of three recording layers enclosed on both sides by ITO transparent electrodes. The recording layers made by two layers or three layers or more, however for the purposes of simplicity, a three layer medium is described here. The electrochromic layer may be one layer or even multiple layers. The electrode layer may be one layer for each recording layer, or the electrode layer may be combined with adjoining recording layers. Here, this joint (electrode-recording layer) structure is described. Moreover, a 0.6 mm thick polycarbonate substrate 613 with an outer diameter of 120 mm and inner diameter of approximately 41 mm on the outer circumferential surface; and with electrodes from front to rear, and an outer diameter of 41 mm and an inner diameter of 15 mm on the inner circumferential surface, was laid (attached) over these layers, by way of a bonding layer 612 of ultraviolet light curing resin. Light was input from the side where the protective substrate was attached.

All of the layers were formed by sputtering however forming the layers by vacuum vapour deposition or ion plating, laser vapor deposition is also acceptable. The film was formed here by sputtering because a uniform film can be formed with precise control of the film thickness.

The interlayer gap (gap between layers) is small in the information recording medium of this invention, so the effect that the heat during recording exerts on other layers was investigated. Results from a heat simulation during recording and results from measuring the stress on the film material are shown in FIG. 54 and Table 5. The distance between recording layers, is the distance from the edge of the recording layer information surface where recording is being performed, to the edge of the adjacent recording layer information surfaces. The adjacent recording film temperature (or temperature on adjacent recording layers) is shown as the maximum temperature for adjacent recording layer information surfaces. The stress was compared versus 1 for the case of 150 nm.

TABLE 5

| Distance between | Temperature on adjacent | |
|---|---|---|
| recording layers (nm) | recording layers (° C.) | Stress |
| 0 | 3300 | 0 |
| 25 | 2760 | 0.2 |
| 50 | 2160 | 0.3 |
| 115 | 1500 | 0.8 |
| 150 | 1160 | 1.0 |
| 180 | 1000 | 1.3 |
| 300 | 400 | 2 |
| 500 | 200 | 3 |
| 1000 | 50 | 7 |

As can be seen from the above results, the larger the distance between recording layers, the smaller the effect from heat, however there is an increase in stress. When the record start temperature is 1000° C., the noise rises to 2 dB or higher on the adjacent information surfaces after recording so it can be understood that a distance of less than 115 nm between layers is required. A distance of 500 nm or less is preferable so that the stress is not too large. Therefore in view of the stress and the temperature on adjacent recording layers, the distance between recording layers is preferably 180 nm or more and 500 nm or less. The range is shown by the slanted line in the figure. A distance of 180 nm or more and 300 nm or less is even more preferable. No increase in noise was observed on the adjacent information surfaces after recording one time in a range of 115 nm or more and smaller than 180 nm, however after recording approximately 10 times, an increase in noise of approximately 2 dB occurred, and the stress on the film was kept within less than double.

The medium structure, material, manufacturing method, recording method, read method and apparatuss not described for this embodiment, are the same as in the first through ninth embodiments, and the eleventh through fourteenth embodiments.

### Eleventh Embodiment

In the eleventh embodiment, an example showing improved read (reproduction) characteristics and improved productivity, due to a manufacturing method for changing the shape of the electrochromic layer and the electrolyte layer.

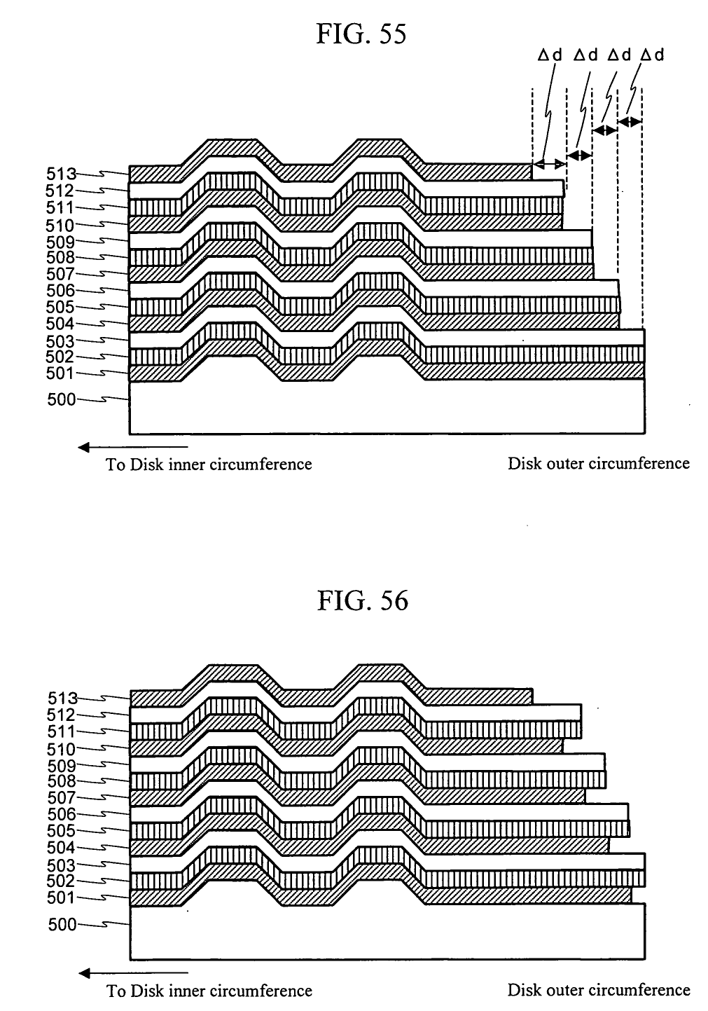

To form the film as shown in FIG. 55, the mask was replaced or the shape was changed after forming the electrolyte layers 503, 506, 509, 512 on the substrate 500, and then the shape was changed so that the edge of the electrode layers 504, 507, 510, 513 formed next were more towards the inner circumference than the edge of the electrochromic layer and electrolyte layer and this method is valid even on the external circumference of the information recording mediums described in the fourth through seventh embodiments. Changing the shape of the electrochromic layer and at least one layer of the electrode layers eliminated coloring errors due to conduction between the upper and lower electrodes such as between the electrode 501 and electrode 504, and the electrode 504 and the electrode 507. An increase in productivity was also achieved.

In the figure, the reference numeral 500 denotes the substrate, 501, 504, 507, 510, 513 denote the electrode layers, 502, 505, 508, 511 denote the electrochromic layers, and 503, 506, 509, 512 denote the electrolyte layers.

After forming the electrode layers as shown in FIG. 56, replacing the mask or changing the shape, and forming the electrochromic layers 502, 505, 508, 511 and/or the electrode layers 503, 506, 509, 512 to completely cover the electrode layers 501, 504, 507, 510, the step was halved to increase the reliability, and increase the surface area available for recording, and increase the capacitance. The step required on the film edge also depends on the mask precision but must at least be thicker than the distance between electrodes, or in other words, thicker than the total thickness of the electrochromic layers and electrode layers.

Rather than just adding a step, an insulation layer can be formed as described next. Though forming this layer increased the manufacturing method by one process, the percentage of conduction errors decreased.

This medium was fabricated as described next. A polycarbonate substrate with a diameter of 12 cm and thickness of 0.6 mm was first of all formed with tracking grooves (width 0.615 um) at a depth of approximately 70 nm for land-group recording at a tracking pitch of 0.615 um on the surface of that substrate. One track revolution was subdivided into multiple sectors and the beginning of each sector holds a header section expressing the address and synchronization signal in a pit string, as well as a clock expressing the groove wobble. The substrate is largely the same as the DVD-RAM substrate.

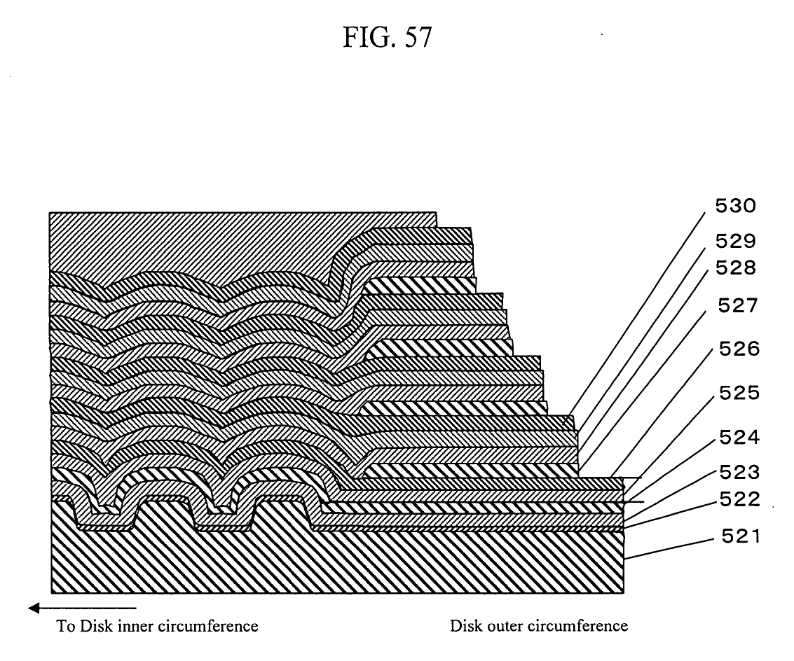

As shown in FIG. 57, a mask with a diameter of 16 mm was attached to the inner circumference on the polycarbonate substrate 301 and a Ag₉₄Pd₄Cu₂ semitransparent reflective layer 522 with a film thickness of 20 nm was formed on top.

Rather than the Ag₉₄Pd₄Cu₂ layer, a laminated film of two layers or more of Ta₂O₅ and SiO₂ may be utilized as a transparent reflective layer with boosted reflectivity due to light interference. When this transparent reflective layer is utilized, the light can reach the recording layer without attenuation even if the light was input from the substrate side. This reflective layer is a servo layer for focusing the servo laser beam. The ratio of horizontal to vertical dimensions in this figure, as well as the ratio of dimensions of the recording region containing grooves with the region on its inner circumferential side, are not accurate. The dummy layers for stabilizing the irregularities and comprised of a Ta₂O₅ layer 53, ZnS.SiO₂ layer 523, and Ta₂O₅ layer 524 were then formed. Next an ITO transparent electrode 525 was formed to 100 nm, the diameter of the internal circumferential mask widened 4 mm, moreover an external circumferential mask with an inner diameter of 40 mm and outer diameter of 120 mm was attached and a ZnS.SiO₂ insulation protection layer 527 formed to a 100 nm thickness with a diameter in a range from 20 mm to 40 mm, the diameter of the inner circumferential mask was enlarged 1 mm, the external circumferential mask removed and a WO₃ electrochromic layer 528 formed to 100 nm and a Ta₂O₅ solid electrolyte layer 529 formed to 100 nm, and an ITO transparent electrode 530 formed to 100 nm. These layers were then followed repetitively in sequence by a protective layer, an electrochromic layer, solid electrolyte layer, ITO transparent electrode, protective layer, electrochromic layer, solid electrolyte layer, ITO transparent electrode to form a total of four recording layers enclosed on both sides by ITO transparent electrodes. The ZnS.SiO₂ insulation protection layer may be inserted in between the upper ITO layer and the solid electrolyte layer. The forming of the protective layer may be omitted if the film forming apparatus is capable of preventing pinholes in the electrochromic layer and the solid electrolyte layer.

In the figure, the reference numeral 521 denotes the substrate, 522 denotes the semi-transparent metal electrode layer, 523 through 525 denote the dummy layers, 526 is the transparent electrode layer, 528 is the electrochromic layer, 529 is the solid electrolyte layer, and 530 is the transparent electrode layer.

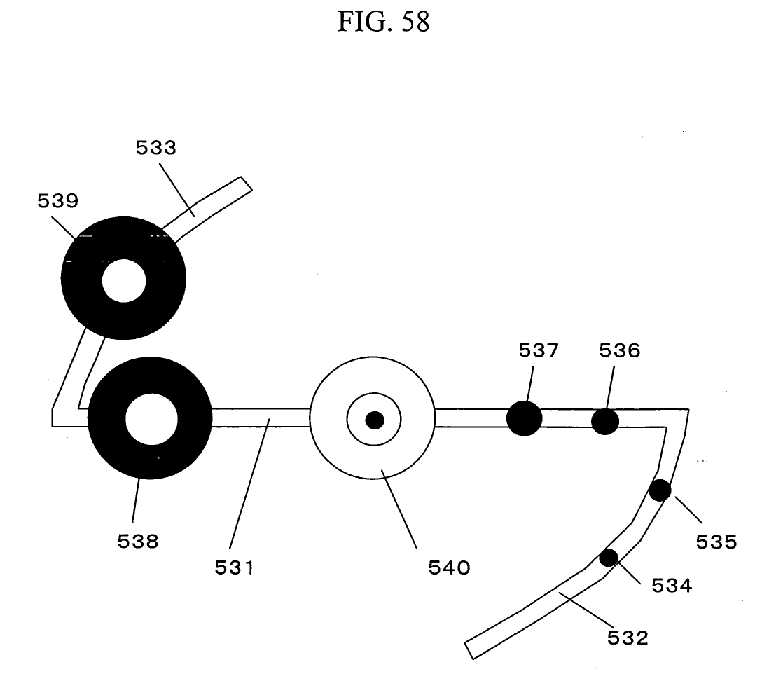

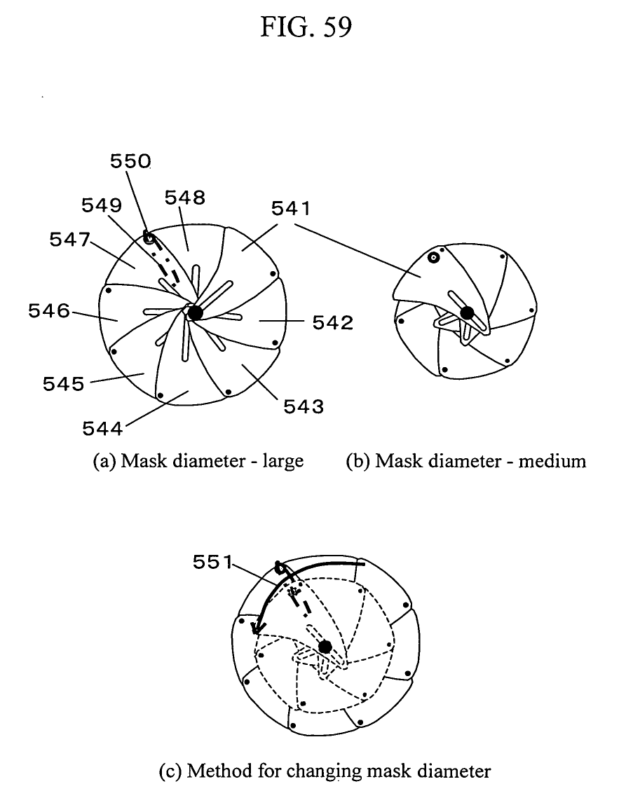

One method for sequentially widening the radius of the internal circumferential mask as shown in FIG. 58, is to linearly feed the different diameter masks into the sputter apparatus to position them on the inner circumference of the disk substrate. Another method that may be utilized as shown in FIG. 59, is to install a mask with a variable external diameter comprised of pieces of many linked changeable fan shapes forming a drop-lid of the same time used for cooking, onto the inner circumferential section of the disk substrate, and move a pin installed on one of the sections near the outer circumference of the piece near both of the linked ends, just along a slit, driving it towards the other arrow, to change the outer diameter. These shape-changing fan mask contain slits, and a bolt passing jointly through the slit is clamped to the disk center position. These are driven by an arm and a wire from outside the vacuum to within the vacuum. In the basic usage method, the mask in FIG. 59, is conveyed along with the substrate installed on each disk substrate, from the sputter chamber to sputter chamber. When an external circumferential mask is required, a mask is utilized so that a lever from the outer frame of a mechanism identical to the lens focusing mechanism on a camera, is moved towards the inner circumference, in an operation that changes the inner diameter. The mask of FIG. 59 can also be used as the internal circumferential mask for the method of FIG. 58. The method as shown in FIG. 58 is a method suited for sputter apparatuss such as used in research laboratories and containing multiple targets in one sputter chamber. In the method in FIG. 58, the bridge installed to cross the center of the sputter chamber, and pass immediately near the disk substrate is not sufficiently long so the bent sections 532 and 533 are installed along the side walls on both sides of the vacuum chamber. The shape of the arms installed on the external circumferential masks 538, 539 (spare), and the internal circumferential masks 534 through 537 (only 4 are drawn in the diagram) are different (Installed from the top side of the drawing and from the bottom side of the drawing.), and can intersect, passing above the disk 540 without striking each other. Therefore a film can be fabricated by using masks on both the internal circumference and outer circumference. In FIG. 58, the reference numeral 531 is mask shift bridge, 532 is a bent section of the mask shift bridge, 533 is a bent section of the mask shift bridge, 534, 535, 536, 537, 538, 539 are external circumferential sections of the mask, 540 is the mask. In FIG. 59, the reference numerals 541 through 548 are the mask blades, 549 is the pin shift slit, 550 is the pin 556 is the substrate, 557 is the electrode layer, 558 is the electrochromic layer, and 559 is the electrolyte layer.

As shown in these results, errors in coloring due to conductance between electrodes can be reduced and productivity improved by altering the planar shape of the film, even on these external circumferential sections.

Though the recording layers may be 2 to 3 layers, or 5 layers or more, a four layer medium is described here for the purposes of simplicity. Also, the electrochromic layer may be one layer or even multiple layers. One layer is used in the description here. The electrode layers may be combined in the adjacent recording layers. Here the case of the combined structure is described.

The medium structure, material, manufacturing method, recording method, read method and apparatuss not described for this embodiment, are the same as in the first through tenth embodiments, and the twelfth through fourteenth embodiments.

### Twelfth Embodiment

In the twelfth embodiment, example where the transparent electrode layer was changed are described.

Preferably the material for the transparent electrode layer possesses a high transmittance at the read wavelength.

Already known transparent electrode material for example possessing a composition of (In₂O₃)×(SnO₂)₁₋ₓ, in material where x is in a range from 5 percent to 99 percent, or more preferably material where x is in a range from 90 percent to 98 percent in view of the surface resistance value, and SiO₂ is added at mole% within 50 percent to this material, or other oxides such as Sb₂O₃ are added at mole% from 2 to 5 percent to SnO₂ may be utilized.

A material mixed with ZnO possessing a somewhat high resistance and a short wavelength is preferred for reading a medium with short wavelength laser such as at 405 nm. The ZnO mole ratio and transmittance at a light wavelength of 400 nm, and the sheet resistance values in a transparent electrode layer mixed with In₂O₃ and ZnO, are shown in FIG. 6. The sheet resistance values are given with the (In₂O₃) 90 (SnO₂) film set as 1.

TABLE 6

| Transparent electrode | | |
|---|---|---|
| layer ZnO mole ratio (%) | Transmittance (%) | Sheet resistance |
| 0 | 76 | 1 |
| 10 | 79 | 1.5 |
| 20 | 80 | 2.1 |
| 30 | 82 | 2.3 |
| 50 | 83 | 3.0 |
| 70 | 86 | 3.5 |
| 80 | 88 | 4.1 |
| 90 | 90 | 4.9 |
| 100 | 90 | 10 |

As can be seen from the above, the ZnO is preferably within a range of 10 mole % or more, and 90 mole % or less, to achieve the effect of a large transmittance and the effect of a small resistance. A range within 20% mole or more, and 80% mole or less is even more preferable since the transmittance becomes large, and the resistance also becomes small.

The medium structure, material, manufacturing method, recording method, read method and apparatuss not described for this embodiment, are the same as in the first through eleventh embodiments, and the thirteenth through fourteenth embodiments.

### Thirteenth Embodiment

The electrode layer film thickness and characteristics when a voltage is applied are described in the thirteenth embodiment.

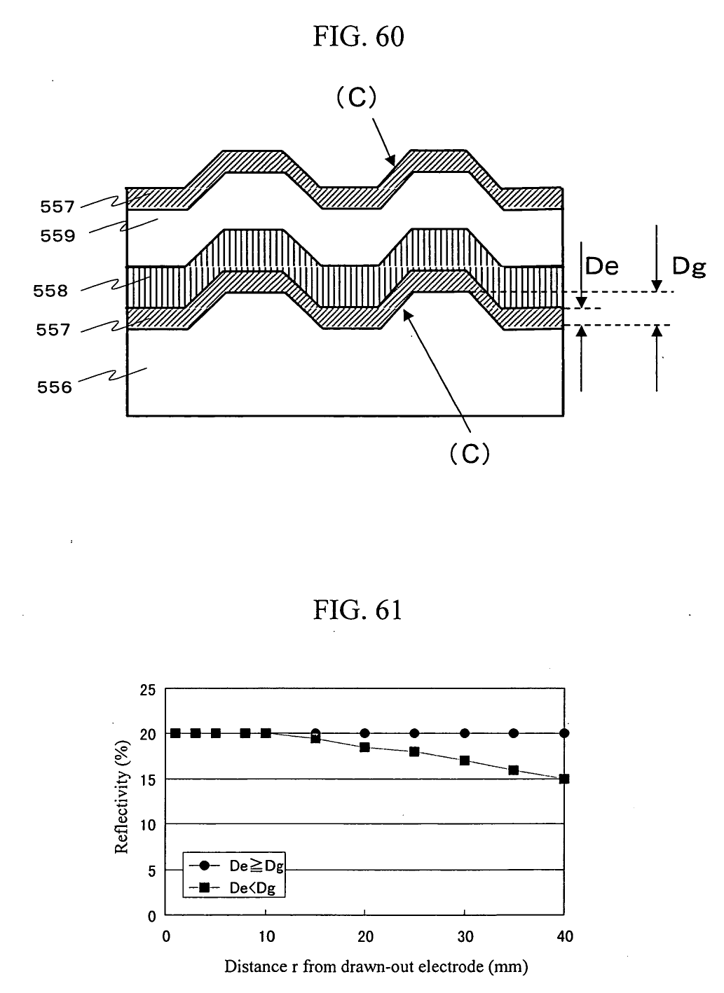

The voltage application speed and the coloring rate are affected by the distance from the electrode and the electrode layer film thickness. This effect is caused by the irregularity grooves formed for tracking, in the film formed on the substrate. As shown in FIG. 60, a film formed along the substrate irregularities is made, when an electrode layer 557, electrochromic layer 558, an electrolyte layer 559 and an electrode layer 557 are laminated in sequence on the substrate 556. Then, color non-uniformities were found to occur since the film thickness of the electrode layer is thin in the section shown in (c) in the figure. When the electrode film thickness De and the substrate irregularity height Dg were changed to investigate these color non-uniformities, it was found that no color non-uniformities could be observed even on the external circumference a long distance from the drawn-out electrode, when the electrode layer film was thick or in other words when De was greater than or equal to Dg. However, color non-uniformities did occur at a low reflectivity on the external circumference, when the electrode layer was thick, or in other words when De was less than Dg. These color non-uniformities can therefore be prevented by setting the relationship between the electrode layer and the substrate irregularity height so that De was greater than or equal to Dg, and a stable servo can be applied over a wide range from the internal circumference to the external circumference.

The medium structure, material, manufacturing method, recording method, read method and apparatuss not described- for this embodiment, are the same as in the first through twelfth embodiments, and the fourteenth embodiment.

### Fourteenth Embodiment

In the fourteenth embodiment, an example is described of changing the position of the voltage supply electrode surface and the laser input surface for performing recording and reading.

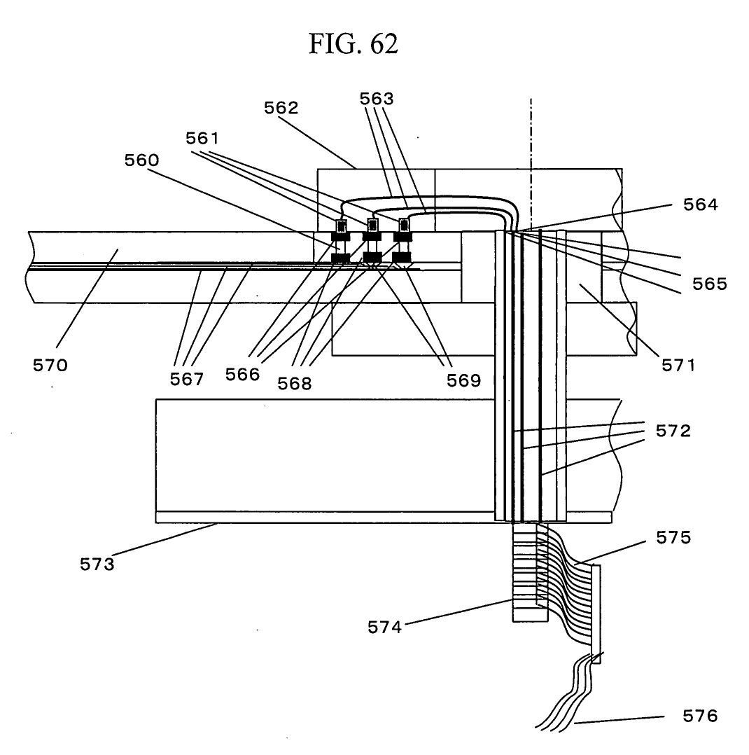

The effect from changing the position of the voltage supply electrode surface and the laser input surface for performing recording and reading was investigated utilizing the recording medium and apparatus of the eighth embodiment. Six separate wires corresponding to up to five layers on the multilayer disk connect to the electrodes on the disk receiving section, installed by way of the vicinity of the surface of the rotating shaft of the disk rotation motor connected to the disk receiving section (circular plate). Each wire is connected to three concentric-shaped pin electrodes. Power was supplied from the circuit board of the recording apparatus from a voltage conveyance mechanism made up of a combination of rings and multiple brushes as shown in FIG. 62, to each of the wires on the disk rotating shaft. Wires from each ring extend upwards within the rotating shaft towards the disk receiving section. In the case of the brush and ring, the rotating shaft for that section is preferably made as narrow as possible and if the diameter is made 5 mm or less, and more preferably 3 mm or less and the line speed reduced to a small amount, then wear can be reduced and a long service life obtained. A diameter of 0.5 mm or more and 5 mm or less is preferable and, still more preferable is a diameter of 1 mm or more and 3 mm or less. In this case, In this case, a structure for supporting that section from above and below (or left and right if installed horizontally) with a bearing is provided so than no force other than in the rotation direction is applied to that section. A separate brush may be installed for each one electrode, here however, six pieces were grouped together with one spring plate. In this kind of grouping method, even a large number of electrodes such as approximately 50 electrodes may operate stably without mutual interference. Ball bearings may be utilized instead of the brush and ring combination. The electrical conduction was improved by filling the ball bearings with a conductive grease as a mixture of carbon particles. The voltage conveyance mechanism (electrical power supply method) may be combined with a non-contact method by utilizing a combination of lasers or LED or solar cells, or other methods may be utilized. The voltage conveyance mechanism may be installed on the disk side of the rotating motor, or may be on the opposite side. Installing it on the opposite side provides the advantage that the shaft can be made narrower since no torque is required, however a space must be provided in the section below the motor. In FIG. 62, the reference numeral 560 denotes the substrate (thru-connection) metal pin, 561 is the spring insert metal pin electrode 561, 563 is the conducting wire, 564 and 565 are the spring insert electrodes for the tip of the rotating shaft, 567 is the disk concentric circular electrode, 571 is the disk receiving section, 572 is the clamp ring/conducting wire path, 573 is the base of the motor, 574 is the cylindrical ring group, 575 is the brush group, 576 is the electrical power wire, 601 is the substrate, 602, 605, 608, 611 are the electrode layers, 603, 606, 609 are the electrochromic layers, 604, 607, 610 are the electrolyte layers, 612 is the bonding solution (adhesive) layer, and 613 is the protective substrate.

The record-read laser light was input from the substrate side on which the films were formed. A transparent reflective layer made up of multiple films as previously described is preferable when irradiating the laser light from the substrate side. Rather than forming a metal semi-reflective layer on the substrate surface, a transfer layer for irregularities such as grooves may be formed on the uppermost layer, and if necessary a metal reflective layer may be formed. When using two laser beams on different wavelengths, a design is preferably employed utilizing a transparent reflective layer for reflecting the laser light (for example, a 660 nm wavelength) from one beam used as the servo beam, and allowing the light from the other laser to transmit through (the transparent reflective layer).

The medium structure, material, manufacturing method, recording method, read method and apparatus not described for this embodiment, are the same as in the first through thirteenth embodiments.

Other aspects of the present invention will be described below.

According to a first aspect of the present invention, there is provided a method for manufacturing a multi-information-layer medium which comprising: a first step for forming a first recording film on the substrate by way of the mask so that the region covered by the mask becomes the first open section, a second step for changing at least either one of the mask size or the relative positions of the mask and the substrate, and a third step for forming a second recording film on the substrate where the first recording film was formed, by way of the mask so that the region covered by the mask becomes the second open section, in which the size or the shape of the second open section is different than the first open section.

According to a second aspect of the present invention, there is provided a method for manufacturing a multi-information-layer medium according to the first aspect, in which the first step includes a first average diameter and, the third step includes a second average diameter different from the first average diameter.

According to a third aspect of the present invention, there is provided a method for manufacturing a multi-information-layer medium according to the first aspect, in which the first step and the third step are steps for forming film by sputtering or vacuum deposition.

According to a fourth aspect of the present invention, there is provided a method for manufacturing a multi-information-layer medium according to the first aspect, in which after the third step at least any of the mask size or the positional relation of the mask with the substrate is changed, and a step is included for forming a third recording film by way of the mask.

According to a fifth aspect of the present invention, there is provided a method for manufacturing a multi-information-layer medium according to the first aspect, in which the mask is an approximate disk shape formed to include a recess section, and the positional relation of the recess section with the substrate is changed in the first step and the third step.

According to a sixth aspect of the present invention, there is provided a method for manufacturing a multi-information-layer medium according to the first aspect, in which the first step and the third step are performed inside one apparatus.

According to a seventh aspect of the present invention, there is provided a medium manufacturing apparatus which comprises: a mount for installing the substrate, a target made of material for forming the film on the substrate, a means for sputtering the target, and forming a film on the substrate, and a mask set between the mount and the target, in which the size of the mask is variable.

According to a eighth aspect of the present invention, there is provided a medium manufacturing apparatus according to the seventh aspect, in which the mask includes multiple blades, and the size of the mask can be changed by the state that the multiple blades are stacked.

According to a ninth aspect of the present invention, there is provided a multi-information-layer medium which comprises: a substrate including a hole in the center, a first recording film formed on the substrate so that the first open section is above the hole on the substrate, and a second recording film formed on the first recording film so that the second open section is over the first open section, in which the shape of the first open section is different from the second open section.

According to a tenth aspect of the present invention, there is provided a multi-information-layer medium according to the ninth aspect, in which the first and the second open sections include a protrusion facing the center section of the substrate, and the protrusion position of the first open section is offset from the protrusion position of the second open section.

According to a eleventh aspect of the present invention, there is provided a multi-information-layer medium according to the tenth aspect, in which the protrusions of the first and the second open sections are multiple protrusions.

According to a twelfth aspect of the present invention, there is provided a multi-information-layer medium according to the tenth aspect, in which the first open section and the second open section are equivalent to the average diameter not including the protrusion.

According to a thirteenth aspect of the present invention, there is provided a multi-information-layer medium according to the tenth aspect, in which a third recording film is formed on the second recording film so that the upper section of second open section becomes the third open section, and the average diameter of the third open section is different from the average diameter of the second open section not including the protrusion.

According to a fourteenth aspect of the present invention, there is provided a multi-information-layer medium according to the ninth aspect, in which applying a voltage changes the reflectivity or the transmittance of the first and the second recording films, and an electrode film is formed between the first and the second recording films, for applying a voltage to the first and the second recording films.

According to a fifteenth aspect of the present invention, there is provided a multi-information-layer medium according to the ninth aspect, in which the electrode film is exposed inside the first and the second open sections.

According to a sixteenth aspect of the present invention, there is provided a multi-information-layer medium which comprises: a substrate including a hole in the center, a first recording film formed on the substrate so that the first open section is above the hole on the substrate, a second recording film formed on the first recording film so that the second open section is on the first open section, and a third recording film formed on the second recording film so that a third open section is on the second open section, in which the difference in the average diameter of the first open section and the average diameter of the second open section, is larger than the difference in the average diameter of the second open section and the average diameter of the third open section.

According to a seventeenth aspect of the present invention, there is provided an information recording apparatus which comprises: a rotating shaft, a disk loading section clamped to the rotating shaft,

a disk clamping section for clamping the disk recording medium loaded in a disk loading section, and rotating along with the disk recording medium, multiple contact electrodes exposed on the disk contact surface of the disk loading section and, making contact with electrodes sandwiching the recording layer of the disk recording medium loaded in the disk loading section, a power supply, and a conductive circuit connected to the power supply, for supplying electrical power to the multiple contact electrodes.

According to a eighteenth aspect of the present invention, there is provided an information recording apparatus which comprises: a rotating shaft, a disk loading section clamped to the rotating shaft,

a disk clamping section for clamping the disk recording medium loaded in a disk loading section, and rotating along with the disk recording medium, multiple contact electrodes exposed on the disk contact surface of the disk clamping section and, making contact with electrodes sandwiching the recording layer of the disk recording medium loaded in the disk loading section, a power supply, and a conductive circuit connected to the power supply, for supplying electrical power to the multiple contact electrodes.

According to a nineteenth aspect of the present invention, there is provided an information recording apparatus according to the seventeenth or eighteenth aspect, in which the multiple contact electrodes are forced to protrude from the disk contact surface.

According to a twentieth aspect of the present invention, there is provided an information recording apparatus according to the seventeenth or eighteenth aspect, in which the conductive circuit is installed within the rotating shaft or on the surface of the rotating shaft.

According to a twenty-first aspect of the present invention, there is provided an information recording apparatus according to the seventeenth or eighteenth aspect, in which the conductive circuit is installed within the disk clamping section.

According to a twenty-second aspect of the present invention, there is provided an information recording apparatus according to the twenty-first, in which a contact position making contact with the rotating shaft is a long and narrow conductive piece capable of moving longitudinally, and the conductive piece forms a section of the conductive circuit.

According to a twenty-third aspect of the present invention, there is provided an information recording apparatus according to the seventeenth or eighteenth aspect, in which the contact electrodes are pin-shaped or belt-shaped electrodes and, make contact directly or by way of other conductive material with the electrodes sandwiching the recording layer of the disk recording medium loaded in the disk loading section.

According to a twenty-fourth aspect of the present invention, there is provided an information recording method which comprises:

a step for loading a disk-shaped recording medium containing multiple recording layers respectively enclosed by a pair of electrodes and colored by way of an applied voltage, into a disk loading section clamped to a rotating shaft, a step for clamping the disk recording medium loaded in the disk loading section with a disk clamping section that rotates along with that disk-shaped recording medium as one piece, a step for applying a voltage for coloring a recording layer enclosed between a pair of electrodes from among multiple recording layers, from multiple contact electrodes formed on a disk contact surface of the disk loading section or the disk contact section of the disk clamping section, and a step for irradiating light onto the disk-shaped recording medium to selectively recording information on a recording layer enclosed by a pair of electrodes to which a voltage is applied.

According to a twenty-fifth aspect of the present invention, there is provided an information recording method according to the twenty-fourth aspect, in which the recording layer colored by way of an applied voltage, contains electrochromic material.

According to a twenty-sixth aspect of the present invention, there is provided an information recording method according to the twenty-fourth aspect, in which a voltage is applied to increase the transmittance of a recording layer enclosed by an electrode pair sandwiching a recording layer other than the recording layer for selectively recording information.

According to a twenty-seventh aspect of the present invention, there is provided an information recording method according to the twenty-sixth aspect, in which voltages are applied by time sharing to multiple pairs of electrodes.

According to a twenty-eighth aspect of the present invention, there is provided an information recording method according to the twenty-fourth aspect, wherein the contact electrodes are pin-shaped or belt-shaped electrodes and, make contact directly or by way of other conductive material with the electrodes sandwiching the recording layer of the disk recording medium loaded in the disk loading section.

According to a twenty-ninth aspect of the present invention, an information recording medium includes a pair of transparent electrodes and multiple sets of electrochromic material layers and solid electrolyte layers, and two substrates for sandwiching those sets and, a conductive circuit including pin-shaped or belt-shaped conductive material passing through or detouring through the vicinity of a center hole in one of these two substrates, and these conductive circuits are each electrically connected directly or by way of other conductive material to any of the transparent electrodes.

According to a thirtieth aspect of the present invention, there is provided a multi-information-layer optical disk as an information recording medium in which information is recorded by irradiation of energy, and which includes a substrate, multiple recording layers made up of sets of electrode layers, electrochromic layers and electrolyte layers formed on a substrate, and in which the relation of the coloring state reflectivity Rc, decoloring state reflectivity Re, and reflectivity Rm of sections recorded on the recording layer of one layer, satisfies the formulas (1), (2), and (3).
(Re−Rm)/(Rc−Rm)<0.03 (1)
Re<Rc (2)
Rm<Rc (3)

According to a thirty-first aspect of the present invention, there is provided an information recording method for recording information on an information recording medium where information is recorded by irradiation of energy, and including multiple recording layers made up of sets of electrode layers, electrochromic layers and electrolyte layers formed on a substrate, and the relation of the coloring state reflectivity Rc, decoloring state reflectivity Re, and reflectivity Rm of sections recorded on the recording layer of one layer, satisfies the formulas (1), (2), and (3).
(Re−Rm)/(Rc−Rm)<0.03 (1)
Re<Rc (2)
Rm<Rc (3)

According to a thirty-second aspect of the present invention, there is provided an information recording method according to the thirty-first aspect, for applying a voltage for the coloring state reflectivity Rc to satisfy the formulas (1), (2), and (3), and record the information.

According to a thirty-third aspect of the present invention, there is provided an information recording method according to the thirty-first aspect, for applying a voltage for the decoloring state reflectivity Re to satisfy the formulas (1), (2), and (3), and record the information.

According to a thirty-fourth aspect of the present invention, there is provided an information recording method according to the thirty-first aspect, in which the recording power is the reflectivity Rm of sections recorded on the recording layer to satisfy the formulas (1) (2) and (3), and record the information.

According to a thirty-fifth aspect of the present invention, there is provided a record-read method for recording information on an information recording medium where information is recorded and read out by irradiation of energy, and including a substrate and multiple recording layers made up of sets of electrode layers, electrochromic layers and electrolyte layers formed on a substrate, in which when selecting the recording layers by applying a voltage, the applied voltage is 1.5 times or more and less than 3 times the reflectivity change start voltage Es.

According to a thirty-sixth aspect of the present invention, there is provided an information recording method according to the thirty-first aspect, wherein recording is performed at more than double the recording start power when recording on a recording layer among multiple recording layers.

According to a thirty-seventh aspect of the present invention, there is provided an information recording method according to the first aspect, in which the distance between recording films among multiple recording layers is 180 nm or more and 500 nanometer or less.

According to a thirty-eighth aspect of the present invention, there is provided an information recording method according to the ninth aspect, in which the distance between recording films among multiple recording layers is 180 nm or more and 500 nm or less.

According to a thirty-ninth aspect of the present invention, there is provided an information recording method according to the twenty-ninth aspect, in which the distance between recording films among multiple recording layers is 180 nm or more and 500 nm or less.

According to a fortieth aspect of the present invention, there is provided an information recording medium according to the ninth aspect, including a first recording layer containing an electrode layer, and an electrolyte layer, and an electrochromic layer, a second recording layer containing an electrode layer, and an electrolyte layer, and an electrochromic layer, and the end of the electrolyte layer of the second recording layer is formed more on the inner circumferential side than the electrode layer, electrolyte layer, and electrochromic layer of the first recording layer.

According to a forty-first aspect of the present invention, there is provided an information recording medium according to the ninth aspect, including a first recording layer containing an electrode layer, and an electrolyte layer, and an electrochromic layer, wherein at least any of the electrolyte layer or electrochromic layer protrude more toward the external circumference than the electrode layer.

According to a forty-second aspect of the present invention, there is provided an information recording medium according to the ninth aspect, in which an insulation layer is formed on the outer circumferential side of the recording medium, between the first recording film and the second recording film.

According to a forty-third aspect of the present invention, there is provided an information recording medium according to the twenty-ninth aspect, in which the ZnO content of the electrode is 10 percent mole or more and 90 percent mole or less.

According to a forty-fourth aspect of the present invention, there is provided an information recording medium according to the twenty-ninth aspect, in which the substrate contains an irregularity shape and, the film thickness of the transparent electrode is thicker than the step difference of the irregularity shape.

1. An information recording medium including: a substrate formed with repetitive sloped irregularities, and multiple recording layers, wherein the recording layers separated away from the substrate are in repetitive arc shapes or repetitive triangular shapes with no bases or similar to repetitive arc shapes or similar repetitive triangular shapes.

2. An information recording medium according to claim 1, wherein recording marks are formed on one section of the recording layer.

3. An information recording medium according to claim 1, wherein the height of the irregularities on the recording layer separated away from the substrate is in a range from 0.5 to 0.9 times higher than the height of the irregularities on the substrate.

4. A method for manufacturing a recording medium comprising the steps of:
forming a dummy layer by sputtering while applying a bias voltage to shift the voltage potential of the substrate in the negative direction on a substrate containing irregularities, and
forming a recording layer on the dummy layer.

5. A method for manufacturing a recording medium according to claim 4 wherein the step for forming the recording layer is multiple steps.

6. A method for manufacturing a recording medium and comprising the steps of:
coating a first film on a substrate containing irregularities,
irradiating energy onto a coated first film, and
forming a recording film on the first film.

7. A method for manufacturing a recording medium according to claim 6, wherein the step for forming a recording film is multiple steps.

8. A method for manufacturing a recording medium according to claim 6, wherein the step for applying energy, is a step for forming a first film of a concave shaper on the concave region on the substrate.

9. A method for manufacturing a recording medium according to claim 6, wherein the step for applying energy, is a step for irradiating a beam of light onto a first film corresponding to the concave regions on the substrate.

10. A method for manufacturing a recording medium according to claim 6, wherein there is a step for applying energy to the first film corresponding to concave regions on the substrate even after the step for forming the recording layer.

11. A method for manufacturing a recording medium according to claim 6, wherein the first film is a dummy layer.

12. A method for manufacturing a recording medium according to claim 6, wherein the first film is an organic film.
